(19) United States
(12) Patent Application Publication
(10) Pub. No.: US 2010/0048750 A1
(43) Pub. Date: Feb. 25, 2010

(54) VESICULATED POLYMER PARTICLES

(75) Inventors: Annabelle Christina Mary Blom, Adamstown (AU); Michelle Jocelyn Carey, Glen Huntly (AU); Brian Stanley Hawkett, Mona Vale (AU); Duc Ngoc Nguyen, Wiley Park (AU); Thi Thuy Binh Pham, Rydalmere (AU); Christopher Henry Such, Mount Eliza (AU); Gregory Goodman Warr, Earlwood (AU)

Correspondence Address: ARENT FOX LLP, 1050 CONNECTICUT AVENUE, N.W., SUITE 400, WASHINGTON, DC, 20036, US

(73) Assignee: The University of Sydney, Sydney ,New South Wales (AU)

(21) Appl. No.: 12/446,389

(22) PCT Filed: Oct. 19, 2007
(86) PCT No.: PCT/AU2007/001594

§ 371 Date: Oct. 5, 2009

(30) Foreign Application Priority Data
Oct. 20, 2006 (AU) 2006905860

(51) Int. Cl. C08J 9/00

(52) U.S. Cl. 521/121; 521/142

(57) ABSTRACT

The invention provides a method of preparing an aqueous dispersion of vesiculated polymer particles, the method comprising: preparing a dispersion of polymerisable particles within a continuous aqueous phase, the polymerisable particles having a structure that is defined by an outer organic phase that comprises one or more ethylenically unsaturated monomers and surrounds an inner aqueous phase, said inner aqueous phase defining a single void within the polymerisable particle, wherein a RAFT agent functions as a stabiliser for the outer organic phase within the continuous aqueous phase, and wherein a RAFT agent functions as a stabiliser for the inner aqueous phase within the outer organic phase; and polymerising the one or more ethylenically unsaturated monomers under the control of a RAFT agent functioning as said stabiliser to form the aqueous dispersion of vesiculated polymer particles.

### FIELD OF THE INVENTION

The present invention relates to a method of preparing an aqueous dispersion of vesiculated polymer particles, to vesiculated polymer particles and to products comprising the vesiculated polymer particles. The vesiculated polymer particles are particularly suited for use in coating formulations, and it will therefore be convenient to describe the invention with an emphasis towards this application. However, it is to be understood that the vesiculated polymer particles may be used in various other applications.

### BACKGROUND OF THE INVENTION

Polymer particles formed with an internal void are known. Such particles are often referred to as “vesiculated polymer particles” and have been employed in a diverse array of applications. For example, they may be used in pharmaceutical, cosmetic, herbicide, pesticide, diagnostic and coating applications, where the voids of the particles may contain a material (e.g. therapeutic, prophylactic, or diagnostic agent, cosmetic agent, fragrance, dye, pigment, photoactive compound, chemical reagent, or other compounds or materials with industrial significance) to be delivered or released.

Vesiculated polymer particles have also been employed as opacifiers in coating compositions such as paints. Opacifiers are important components of paints, having the primary function of scattering light incident on the paint film. How well a paint is able to visually obliterate a surface over which it is applied is referred to as its opacity. Titanium dioxide pigment is traditionally used as the main opacifier in paint formulations and it, together with the polymeric binder of the formulation, are the two main contributors to paint formulation cost. In the formulation of low sheen and flat paints, mineral extender pigments such as calcite, clay or talc are often incorporated in paint formulations to reduce specula reflection down to the desired level.

With the aim of reducing cost, mineral extenders may be added to a paint formulation at such a level that there is insufficient polymeric binder to bind (space fill) all the pigment present. The term “critical pigment volume concentration” (CPVC) is often used to describe the point where complete space filling can no longer occur. The addition of mineral extender beyond the CPVC can therefore lead to the formation of air voids in the paint film as drying occurs. These voids scatter light in their own right and contribute to paint film opacity thereby allowing an opportunity to reduce the level of titanium dioxide and still achieve acceptable opacity or coverage. The accompanying formula cost saving, however, is at the expense of other paint film properties such as scrub resistance and stain resistance. In the case of stain resistance, the problem is that of stains penetrating into the voids in the film (film porosity).

Vesiculated polymer particles have been used in paint formulations to great effect by providing voids of air in paint films without the disadvantage of film porosity.

Vesiculated polymer particles can be prepared in the form of an aqueous dispersion using suspension and emulsion polymerisation techniques. When in the form of an aqueous dispersion, the voids of the particles are typically filled with water. When such a dispersion is dried, for example as part of a paint formulation applied as a film, the voids of the particles should become filled with air and thus enhance the opacifying properties of the particles.

Despite the advantages vesiculated polymer particles may provide, methods used to prepare them are often complex. A particular challenge in preparing these particles has been to gain sufficient control over the polymerisation process to consistently afford polymer particles having uniform morphology. Vesiculated polymer particles having a substantially uniform polymer layer surrounding a single void have proven difficult to prepare.

Attempts have been made to use conventional free radical polymerisation processes to form polymerised vesicles. However, such processes are typically prone to forming polymer particles having a non-uniform distribution of polymer surrounding the vesicle (i.e. so called “parachute” structures). Furthermore, many techniques used to prepare vesiculated polymer particles often give rise to particles in which the layer or shell of polymer surrounding the void has ruptured.

For the efficiency and reliability of products comprising vesiculated polymer particles, it is generally desirable that the particles are produced with a substantially uniform structure in a relatively controlled and reproducible manner.

Accordingly, there remains scope for improving on the prior art techniques for preparing vesiculated polymer particles, or at the very least to provide an alternative method for preparing such particles.

### SUMMARY OF THE INVENTION

The present invention provides a method of preparing an aqueous dispersion of vesiculated polymer particles, the method comprising:

preparing a dispersion of polymerisable particles within a continuous aqueous phase, the polymerisable particles having a structure that is defined by an outer organic phase that comprises one or more ethylenically unsaturated monomers and surrounds an inner aqueous phase, said inner aqueous phase defining a single void within the polymerisable particle, wherein a RAFT agent functions as a stabiliser for the outer organic phase within the continuous aqueous phase, and wherein a RAFT agent functions as a stabiliser for the inner aqueous phase within the outer organic phase; and
polymerising the one or more ethylenically unsaturated monomers under the control of a RAFT agent functioning as said stabiliser to form the aqueous dispersion of vesiculated polymer particles.

The method of the invention is believed to provide a unique polymerisation technique that enables vesiculated polymer particles to be formed in an aqueous medium, with the particles having a substantially uniform and continuous polymer layer around a single aqueous filled void. The method can advantageously be performed in a substantially controllable and reproducible manner and may be performed using a diverse array of ethylenically unsaturated monomers.

As the presence of organic solvent may be undesirable in some applications employing vesiculated polymer particles, preparing the particles in an aqueous medium has many commercial advantages.

Through the control afforded by the method, the structure and polymer composition of the vesiculated polymer particles can advantageously be tailored for a given application. The method of the invention is well suited to producing vesiculated polymer particles that are relatively small in size.

Thus, the present invention also provides a vesiculated polymer particle that is 100 microns or less in size, the particle being defined by a substantially uniform and continuous polymer layer around a single aqueous or air filled void, wherein the polymer layer has at least in part been formed under the control of a RAFT agent.

The method in accordance with the invention comprises preparing an aqueous dispersion of polymerisable particles having the aforementioned structural attributes. This dispersion may be prepared by any suitable technique.

For example, the aqueous dispersion of polymerisable particles may be prepared by (a) dispersing a selected RAFT agent in an aqueous medium such that it assembles to form an aqueous dispersion of vesicles, and (b) introducing an organic medium comprising the one or more ethylenically unsaturated monomers to the aqueous medium such that it combines with the vesicles to form the dispersion of polymerisable particles.

Alternatively, the aqueous dispersion of polymerisable particles may be prepared by (a) forming a dispersion comprising a continuous aqueous phase, a selected RAFT agent and a dispersed organic phase comprising the one or more ethylenically unsaturated monomers, and (b) polymerising at least a portion of the one or more ethylenically unsaturated monomers under the control of the RAFT agent such that the resulting polymerised RAFT agent assembles to form the dispersion of polymerisable particles.

Further aspects of the invention appear below in the detailed description of the invention.

### BRIEF DESCRIPTION OF THE DRAWINGS

Preferred embodiments of the invention will now be illustrated by way of example only with reference to the accompanying drawings in which:

FIG. 1 illustrates vesiculated polymer particles prepared in accordance with the invention.

FIG. 2 illustrates vesiculated polymer particles prepared in accordance with the invention that contain titanium dioxide within the void of the particles.

FIG. 3 illustrates vesiculated polymer particles prepared in accordance with the invention.

### DETAILED DESCRIPTION OF THE INVENTION

As used in the context of the present invention, the expression “vesiculated polymer particle(s)” is intended to mean a polymer particle having a substantially uniform and continuous polymer layer around a single void, hollow or pocket. On preparing the vesiculated polymer particles, the void will initially be aqueous filled. However, if the vesiculated polymer particles are dried the aqueous component of the void may be replaced with air. The vesiculated polymer particles can be of any shape but will generally have a spherical or spheroidal shape.

The vesiculated polymer particles may also be viewed as having a “core/shell” type structure where the core represents the void that may be aqueous filled, and the shell represents the substantially uniform and continuous polymer layer around the core. The size of the void can vary, but it will generally represent at least 10% of the volume occupied by the entire particle. The size of the void is likely to vary depending on the intended application of the vesiculated polymer particles. For some applications it may be preferable that the void represents at least 20%, 30% or 50% of the volume occupied by the entire particle.

By the vesiculated polymer particles having a “substantially uniform and continuous polymer layer” around a single void is meant that the polymer layer does not present in an irregular manner around the void and that the layer is substantially free of holes or tares. To achieve these properties, the thickness of the polymer layer surrounding the void will generally be relatively constant. However, it may be that the thickness of the polymer layer can vary gradually around the perimeter of the void. For example, the void may not be located at the precise centre of a spherical particle. An assessment of the uniformity and continuity of the polymer layer can generally be made visually, for example by Transmission Electron Microscopy (TEM).

The thickness of the polymer layer around the single void is preferably at least 10 nm, more preferably at least 20 nm, most preferably at least 30 mu, still more preferably at least 40 nm. There is no particular limit as to the thickness of the polymer layer, with the ultimate thickness generally being dictated by the intended application for the vesiculated polymer particles.

By the vesiculated polymer particles having a substantially uniform and continuous polymer layer around a “single void” is meant that such particles each have only one void.

The method of the invention is well suited to producing vesiculated polymer particles that are relatively small in size. For example, particles that are 100 microns or less in size.

Preferably, such novel vesiculated polymer particles are 70 microns or less, more preferably 40 microns or less, most preferably 5 microns or less in size. The size of the vesiculated polymer particles may also be in the sub-micron range, for example, from 0.01 to 1 micron. For the avoidance of any doubt, reference to the “size” of the vesiculated polymer particles is intended to be that of the largest dimension provided by a cross-section of a particle. Thus, in the case of spherical vesiculated polymer particles the size is the diameter of the sphere, as measured to the outer perimeter of the sphere.

The polymerisable particles prepared as part of the method of the invention have a specific structure that is defined by an outer organic phase that comprises one or more ethylenically unsaturated monomers and surrounds an inner aqueous phase, the inner aqueous phase defining a single void within the polymerisable particle. Thus, the polymerisable particles are in effect a precursor to the structure of the vesiculated particles and may also be viewed as having a “core/shell” type structure where the core represents the void defined by the inner aqueous phase, and the shell represents the outer organic phase that comprises one or more ethylenically unsaturated monomers and surrounds the core.

To afford vesiculated polymer particles having a “substantially uniform and continuous polymer layer” around a single void, the outer organic phase of the polymerisable particles will typically also be present as a substantially uniform and continuous layer around the inner aqueous phase. An assessment of the structural features of the polymerisable particles can also generally be made visually, for example by Transmission Electron Microscopy (TEM).

In accordance with certain aspects of the invention, a RAFT agent functions as a stabiliser for the outer organic phase within the continuous aqueous phase, and a RAFT agent functions as a stabiliser for the inner aqueous phase within the outer organic phase. Thus, it will be appreciated that in accordance with the method of the invention a RAFT agent functions as a stabiliser at two interfaces associated with the polymerisable particle, namely the interface between the continuous aqueous phase and the outer organic phase and the interface between the outer organic phase and the inner aqueous phase. Without wishing to be limited by theory, it is believed that separate RAFT agents function to stabilise each of the aforementioned two interfaces associated with the polymerisable particles.

A mixture of different RAFT agents may be used in the method of the invention, but generally only one type of agent will be employed.

By functioning as “a stabiliser”, the RAFT agents serve to maintain the “shell/core” type structure of the polymerisable particles within the continuous aqueous phase. From a practical point of view, a RAFT agent at each interface in combination therefore serves to prevent, or at least minimise, coalescence or aggregation of the dispersed outer organic phase and the dispersed inner aqueous phase that together form the structure of the polymerisable particles.

As a stabiliser, the RAFT agent may prevent, or at least minimise, coalescence or aggregation through well known pathways such as steric and/or electrostatic repulsion. To provide the ability to function as a stabiliser, the RAFT agent comprises a moiety that can provide for the requisite steric and/or electrostatic repulsion.

By functioning as a stabiliser in the manner described above, RAFT agent used in accordance with the invention can also advantageously stabilise the resulting aqueous dispersion of vesiculated polymer particles and thereby prevent, or at least minimise, coalescence or aggregation of these particles. Thus, when monomer in the outer organic phase of the polymerisable particles is polymerised to form polymer, RAFT agent stabilising the outer organic phase in the continuous aqueous phase inherently begins stabilising the “growing” vesiculated polymer particles within the continuous aqueous phase. Accordingly, the dispersion of vesiculated polymer particles can advantageously be prepared without using conventional surfactant.

Having said this, it is still possible to use in the preparation of the vesiculated polymer particles at least some auxiliary stabiliser such as a conventional surfactant or any other surface active agent. Those skilled in the art will appreciate the range of surfactants suitable for this purpose. If auxiliary stabilisers are used, the type and amount employed should not adversely interfere with performing the method of the invention. Thus, if low molecular weight anionic, non-ionic or cationic auxiliary surfactants are used, they should be employed at a concentration below their Critical Micelle Concentration (CMC) in order to minimise solid polymer particles being formed during the polymerisation process.

Auxiliary stabilisers may also include a class of polymeric materials often referred to as protective colloids. Examples of protective colloids include, but are not limited to, cellulosics and polyvinyl alcohols. Those skilled in the art will appreciate that protective colloids do not typically form micelles and therefore will have a reduced tendency to adversely interfere with performing the method of the invention.

Where an auxiliary stabiliser is employed, it is preferably used in an amount of less than 30 wt. %, more preferably less than 20 wt. %, most preferably less than 15 wt. %, relative to the total amount of stabiliser present (i.e. inclusive of the RAFT agent which functions as the sole or primary stabiliser).

The continuous aqueous phase may include a water miscible solvent. Examples of water miscible solvents include, but are not limited to, dioxane, acetone and liquid polyoxyalkylene compounds (e.g. polyethylene glycol). The presence of a water miscible solvent in the aqueous phase may facilitate the formation of vesicles and/or the polymerisable particles.

Although the organic phase comprising the one or more ethylenically unsaturated monomers may include an organic phase miscible solvent, such solvent will generally not be included in the organic phase.

Dispersions used in performing the invention may be prepared with the assistance of any methods of emulsification such as stirring and/or sonication.

An important feature of certain aspect of the invention is that the one or more ethylenically unsaturated monomers are polymerised under the control of a RAFT agent functioning as the stabiliser. By being polymerised “under the control of a RAFT agent” is meant that the monomers are polymerised via a Reversible Addition-Fragmentation Chain Transfer (RAFT) mechanism to form polymer. By “a RAFT agent functioning as the stabiliser” is meant a RAFT agent used in accordance with the method that stabilises the interface between the continuous aqueous phase and the outer organic phase or the interface between the outer organic phase and the inner aqueous phase that define the structure of the polymerisable particle.

RAFT polymerisation of ethylenically unsaturated monomers is described in WO 98/01478, and in effect is a radical polymerisation technique that enables polymers to be prepared having a well defined molecular architecture and low polydispersity. The technique employs a RAFT agent of the general formula (1):

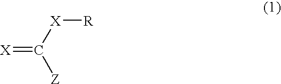

which has been proposed to react with a propagating radical (Pₙ*) in accordance with Scheme 1.

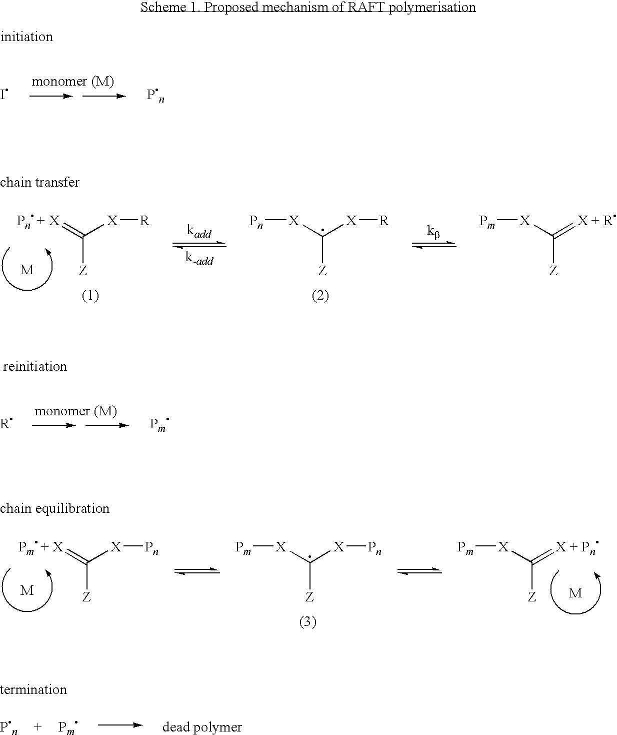

The effectiveness of the RAFT agent (1) is believed to depend on a complex array of rate constants. In particular, the formation of polymer according to Scheme 1 is believed to be reliant upon equilibria that require high rate constants for the addition of propagating radicals to agent (1) and the fragmentation of intermediate radicals (2) and (3), relative to the rate constant for propagation.

The rate constants associated with RAFT polymerisation are believed to be influenced by a complex interplay between stability, steric and polarity effects in the substrate, the radicals and the products formed. The polymerisation of specific monomers and combinations of monomers will introduce different factors and structural preferences for the agent (1). The interplay of factors for a particular system have been largely rationalized on the basis of the results obtained. A clear definition of all factors that influence polymerisation for any particular system is yet to be fully understood

RAFT agents used in accordance with the invention therefore not only function as a stabiliser but also play an active role in polymerising the one or more ethylenically unsaturated monomers. By virtue of this polymerisation role, the RAFT agents are inherently covalently bound to the polymer layer that is formed around the inner aqueous phase of the polymerisable particle. By being covalently bound to the polymer layer, the RAFT agents can still function as a stabiliser but are not prone to the migration problems associated with conventional surfactants. It will be appreciated that upon formation of a layer of polymer around the inner aqueous phase of a given polymerisable particle, only RAFT agent stabilising the outer organic phase/polymer layer within the continuous aqueous phase will have any practical stabilising effect.

To function as a stabiliser in accordance with the method of the invention, the RAFT agents used will be physically associated in some way with the interface between the continuous aqueous phase and the outer organic phase and with the interface between the outer organic phase and the inner aqueous phase. By having an ability to associate with the interfaces in this way, the RAFT agents will exhibit surface activity, or in other words they will be surface active.

RAFT agents suitable for use in accordance with the invention include those of general formula (4):

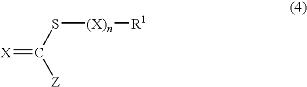

where each X is independently a polymerised residue of an ethylenically unsaturated monomer, n is an integer ranging from 6 to 2000, preferably from 8 to 1200, more preferably from 10 to 600, most preferably from 10 to 500, R¹ and Z are groups independently selected such that the agent can function as a RAFT agent in the polymerisation of the one or more ethylenically unsaturated monomers.

In order to function as a RAFT agent in the polymerisation of the one or more ethylenically unsaturated monomers, those skilled in the art will appreciate that R¹1 will typically be an organic group and in combination with the —(X)ₙ— group (i.e. as R¹—(X)ₙ—) will function as a free radical leaving group under the polymerisation conditions employed and yet, as a free radical leaving group, retain the ability to reinitiate polymerisation. Similarly, those skilled in the art will appreciate that Z will typically be an organic group which functions to give a suitably high reactivity of the C═S moiety in the RAFT agent towards free radical addition without slowing the rate of fragmentation of the RAFT-adduct radical to the extent that polymerisation is unduly retarded.

In accordance with certain aspects of the invention, the RAFT agent is in effect selected such that it can form the polymerisable particles. This will typically involve selecting suitable R¹, Z and —(X)ₙ— groups of RAFT agents of general formula (4). The nature of the R¹, Z and —(X)ₙ— groups may vary depending on the way in which the polymerisable particles are prepared.

For example, the aqueous dispersion of polymerisable particles may be prepared by (a) dispersing the selected RAFT agent in an aqueous medium such that it assembles to form an aqueous dispersion of vesicles, and (b) introducing an organic medium comprising the one or more ethylenically unsaturated monomers to the aqueous medium such that it combines with the vesicles to form the dispersion of polymerisable particles (for convenience hereinafter referred to as the “pre-formed vesicle” approach).

By the pre-formed vesicle approach, the RAFT agent will be selected such that it is capable of assembling to form an aqueous dispersion of vesicles. As used herein, the term “vesicle(s)” is intended to mean an aggregate of RAFT agents that assemble to form a structure generally of spherical or spheroidal shape with an inner void. By being formed in an aqueous medium, the inner void of the vesicles will be defined by an inner aqueous phase. In a similar fashion to vesicles formed in an aqueous medium from conventional surfactants, vesicles formed from the RAFT agents here are believed to have a bi-layer type structure. Accordingly, the vesicles might be described as having a structure defined by a spherical or spheroidal bi-layer of assembled RAFT agents surrounding an inner aqueous core.

RAFT agents for the pre-formed vesicle approach will generally be selected to have a relatively low molecular weight, particularly in terms of the —(X)ₙ— moiety of general formula (4). Thus, n in general formula (4) will typically range from about 6 to about 100, preferably from about 8 to about 50, more preferably from about 10 to about 40.

RAFT agents of general formula (4) for use in the pre-formed vesicle approach will also generally be selected to have groups, sections or regions (hereinafter simply referred to as “sections”) with hydrophilic and hydrophobic properties (i.e. they will have amphipathic character). These sections will be provided collectively by the Z, (X)ₙ and R¹ groups of the agent and will typically be arranged such that the agent has well defined and discrete sections with hydrophobic and hydrophilic properties. Those skilled in the art may therefore also refer to the agent as having hydrophobic and hydrophilic sections arranged in a block-type structure. It will be appreciated this is intended to be distinguished from agents that may derive their amphipathic character by having hydrophobic and hydrophilic sections arranged in a random-, tapered- or alternating-type structure.

In addition to having well defined and discrete sections with hydrophobic and hydrophilic properties, the agent will also generally be selected to be overall sufficiently hydrophilic in character such that it is soluble in the aqueous medium in which the vesicles are to be formed.

The block-type structure of the RAFT agent may be provided through different arrangements of hydrophilic and hydrophobic sections of the agent. For example, with reference to general formula (4) the amphipathic character provided from either:
1) a combination of a hydrophobic end and a hydrophilic end; wherein the Z group provides hydrophobic properties to one end, and R¹ and —(X)ₙ— provide hydrophilic properties to the other end. In this case, —(X)ₙ— will typically be the polymerised residue of hydrophilic monomer; or
2) a combination of a hydrophobic end and a hydrophilic end; wherein the Z group and —(X)ₙ— provide hydrophobic properties to one end, and R¹ provides hydrophilic properties to the other end; or
3) a combination of a hydrophobic end and a hydrophilic end; wherein the Z group provides hydrophobic properties to one end, —(X)ₙ— provides hydrophilic properties to the other end, and R¹ is hydrophobic such that the net effect of —(X)ₙ— and R¹ is to provide hydrophilic character to that end; or
4) a combination of hydrophilic ends and a hydrophobic middle section, wherein Z=−S—(X)ₙ—R¹, wherein each R¹ may be the same or different and provides hydrophilic properties to each end, and wherein —(X)ₙ— provides hydrophobic properties to the middle section; or
5) a combination of a hydrophobic end and a hydrophilic end; wherein each X is a polymerised residue of a hydrophilic or hydrophobic ethylenically unsaturated monomer such that —(X)ₙ— represents a block copolymer where the portion of the block copolymer closest to the R¹ group is the polymerised residue of hydrophilic monomer and the portion of the block copolymer closest to the thiocarbonylthio group is the polymerised residue of hydrophobic monomer; the Z group provides hydrophobic properties; the R¹ group provides hydrophilic properties; and n ranges from 6 to 100; or
6) a combination of hydrophobic and hydrophilic properties; wherein —(X)ₙ— of formula (4) is represented as -(A)ₘ-(B)ₒ— to provide for general formula (5):

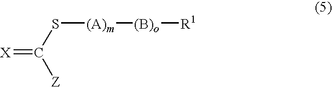

where each A and B is independently a polymerised residue of an ethylenically unsaturated monomer such that -(A)ₘ- provides hydrophobic properties (i.e. is the polymerised residue of hydrophobic monomer), -(B)ₒ— provides hydrophilic properties (i.e. is the polymerised residue of hydrophilic monomer) and overall -(A)ₘ-(B)ₒ— represents a block copolymer; m and o each independently range from 3 to 50, preferably from 4 to 25, more preferably from 5 to 20. Generally, m and o will be selected such that they are similar in magnitude (see further comments below). Z may also be chosen such that its polarity combines with that of -(A)ₘ- to enhance the overall hydrophobic character to that end of the RAFT agent (i.e. Z provides hydrophobic properties). In addition to the hydrophilic character provided by -(B)ₒ—, R¹ may also be hydrophilic and enhance the overall hydrophilic character to that end of the RAFT agent, or R¹ may be hydrophobic provided that the net effect of -(B)ₒ— and R¹ results in an overall hydrophilic character to that end of the RAFT agent. Generally R¹ will provide hydrophilic properties.

Preferred RAFT agents that may be used to prepare the aqueous dispersion of vesicles include, but are not limited to, those described directly above in points 5 and 6.

As indicated above, the overall hydrophilic/hydrophobic character of the RAFT agent will be provided collectively by the Z, (X)ₙ and R¹ groups. Each group will itself have hydrophilic/hydrophobic character. Those skilled in the art will appreciate that the terms “hydrophilic” and “hydrophobic” are typically used as an indicator of favourable or unfavourable interactions of one substance relative to another (i.e. attractive or repulsive interactions) and not to define absolute qualities of a particular substance. In other words, the terms “hydrophilic” and “hydrophobic” are used as primary relative indicators to define characteristics such as like attracting like and unlike repelling unlike. Such terms are well understood by those skilled in the art.

In the context of the present invention, those skilled in the art will also appreciate that the terms “hydrophilic” and “hydrophobic” are primarily used as a means to describe features of the RAFT agent that render it suitable to (a) function as a surface active agent in the aqueous phase or medium, and (b) ultimately form the polymerisable particles in that phase or medium. Thus, as a non-limiting point of reference only, a person skilled in the art might consider a hydrophilic group, section or agent as one that can be solvated by or is soluble in the aqueous phase or medium (i.e. an attractive interaction), and a hydrophobic group, section or agent as one that can not be solvated by or is not soluble in the aqueous phase or medium (i.e. an repulsive interaction).

As a non-limiting point of reference only, a person skilled in the art might also consider a hydrophilic ethylenically unsaturated monomer as one that when polymerised forms a polymer that can be solvated by or is soluble in the aqueous phase or medium, and a hydrophobic ethylenically unsaturated monomer as one that when polymerised forms a polymer that can not be solvated by or is not soluble in the aqueous phase or medium.

Those skilled in the art will appreciate that the phrases “can be solvated by or is soluble in” and “can not be solvated by or is not soluble in” are used herein in a practical sense in that they are to be taken in the context of performing the invention as described herein. For example, RAFT agents used in the pre-formed vesicle approach will generally be selected to be overall sufficiently hydrophilic in character such that are soluble in the aqueous medium in which the vesicles are to be formed. Thus, the agent will be soluble in the aqueous medium to a degree that the invention may be performed. Conversely, an agent that is not soluble in the aqueous medium may have a degree of solubility in the medium but this will be insufficient to enable the invention to be performed. To this end, solubility will typically be assessed under the conditions (e.g. temperature and pH etc of the aqueous phase or medium) employed when performing the invention.

When preparing the aqueous dispersion of vesicles, it is preferable that the RAFT agents used have a structure of general formula (4) where R¹ is an organic group substituted with one or more hydrophilic groups, or in other words it is preferred that R¹ adds hydrophilic character to the RAFT agent. The substituent R¹ in this case is therefore preferably not hydrophobic in character, for example as would be the case if it were a phenyl or benzyl substituent.

When employing the pre-formed vesicle approach, it may be desirable to ensure that the molecular volumes presented by the hydrophilic and hydrophobic sections of the agent are similar. For example, in point (5) above where —(X)ₙ— of formula (4) is further represented as -(A)ₘ-(B)ₒ—, it may be desirable that m and n are similar integer values, for example about 5 and 5, respectively. On the basis that Z contributes a similar molecular volume to R¹, or that their respective molecular volumes are negligible compared with that afforded by A and B, then the resulting agent may exhibit similar hydrophilic and hydrophobic molecular volumes.

However, those skilled in the art will appreciate that a molecular volume provided by a given hydrophilic or hydrophobic section might be affected by solvent factors and/or whether or not the hydrophilic section comprises an ionised moiety. For example, the effective hydrophobic molecular volume of an agent in an aqueous environment might be increased through the addition of a hydrophobic solvent (i.e. via swelling). Similarly, the effective hydrophilic molecular volume of an agent in an aqueous environment might be increased through that section comprising an ionised moiety (e.g. via charge effects). These factors may therefore be used to fine tune attaining similar hydrophilic and hydrophobic molecular volumes for a given agent in a given environment.

Without wishing to be limited by theory, it is believed that the ordering or packing of the RAFT agents and their subsequent formation into vesicle structures can be facilitated by providing the agents with hydrophilic and hydrophobic sections having similar molecular volumes.

Thus, to prepare the aqueous dispersion of vesicles via the pre-formed vesicle approach, the RAFT agents may simply self-assemble into vesicle structures when added to an aqueous medium, or this process may be facilitated or promoted by the addition of a reagent to the aqueous medium that assists the aggregation and assembly of the RAFT agents. The nature of such a reagent may vary depending upon the type of RAFT agent used, but solvent (e.g. water miscible solvent hereinbefore defined) and/or organic medium comprising ethylenically unsaturated monomer has been found to be a useful reagent in this regard. The assembly of the vesicles may also be facilitated or promoted by the adjusting the pH of the aqueous phase (i.e. by adjusting the degree of ionisation of ionizable moieties that make up the structure of the RAFT agent).

The aqueous dispersion of vesicles may therefore be formed by introducing a suitable RAFT agent to an aqueous medium and allowing sufficient time, optionally in conjunction with stirring and/or sonication, for the RAFT agents to self-assemble into vesicles. Alternatively or in addition to, a suitable agent may be introduced in the aqueous medium to facilitate the formation of the vesicles.

As indicated above, the RAFT agent will typically be soluble in the aqueous medium in which the vesicles are to be formed. The aqueous medium may include a water miscible solvent to assist with solubilising the RAFT agent. Examples of water miscible solvents include, but are not limited to, those defined above. Adjusting the pH of the aqueous medium can also facilitate solubilising a RAFT agent that comprises one or more ionizable moieties.

The vesicles may be formed having a distribution of particle sizes. The size distribution of the vesicle dispersion may be modified using techniques known in the art. For example, the size distribution of the vesicles can be selected or modified by passing the vesicle dispersion through one or more membranes or filters having a defined pore size.

The aqueous dispersion of vesicles may contain other RAFT agent aggregates such as micelles. The presence of these other aggregates can result in polymer particles other than the vesiculated polymer particles being formed in the aqueous phase. Depending on the intended application of the vesiculated polymer particles, this may or may not be of concern.

Having formed the aqueous dispersion of vesicles, according to the pre-formed vesicle approach the dispersion of polymerisable particles is prepared by (b) introducing an organic medium comprising the one or more ethylenically unsaturated monomers to the aqueous medium. If organic medium comprising the monomer has been previously introduced in step (a) to assist with the formation of the vesicles, then the aqueous medium may already comprise polymerisable particles. In other words, the process of forming the vesicles in step (a) may occur simultaneously with the process of introducing the organic medium in step (b). In this case, it may nevertheless still be required to add further organic medium/monomer.

The organic medium is introduced to the aqueous medium in an amount and at a suitable rate that (1) leads to the formation of the polymerisable particles, and/or (2) minimises or avoids rupture of the vesicles and/or formation of organic phase in the aqueous medium that is separate from the vesicles.

By the organic phase being introduced such that it “combines” with the vesicles to form the polymerisable particles in meant that the organic phase is absorbed by the vesicle such that it surrounds the inner aqueous phase of the vesicle. Without wishing to be limited by theory, it is believed that the organic phase is preferentially absorbed within the bi-layer wall structure of the vesicle to give rise to the aforementioned structure of the polymerisable particles.

Having formed the aqueous dispersion of polymerisable particles by this pre-formed vesicle approach, the ethylenically unsaturated monomers may be polymerised under the control of the RAFT agent to form the aqueous dispersion of vesiculated polymer particles.

Further organic phase comprising ethylenically unsaturated monomer may be introduced so as to continue the polymerisation and build the polymer layer thickness of the vesiculated particles. Where further organic phase is introduced beyond that which is required to form the vesiculated polymer particles, it may be preferable that this further addition of organic phase is minimised until, or occurs after, the structure of the polymerisable particles has undergone a degree of polymerisation. This “initial” polymerisation tends to enhance the stability of the particles and will render the RAFT agent substantially insoluble in the aqueous phase/medium. By adopting this approach, RAFT agent is less likely to migrate from the polymerisable particles into the continuous aqueous phase and associate with or stabilise the further organic phase as it is introduced. Organic phase that is stabilised by RAFT agent not associated with the vesicles (i.e. “free RAFT agent”) can result in the formation of non-vesiculated polymer particles within the dispersion.

The aqueous dispersion of polymerisable particles might also be prepared by (a) forming a dispersion comprising a continuous aqueous phase, a selected RAFT agent and a dispersed organic phase comprising the one or more ethylenically unsaturated monomers, and (b) polymerising at least a portion of the one or more ethylenically unsaturated monomers under the control of the RAFT agent such that the resulting polymerised RAFT agent assembles to form the dispersion of polymerisable particles (for convenience hereinafter referred to as the “polymerisation” approach).

As part of the polymerisation approach, the dispersion comprising a continuous aqueous phase, the selected RAFT agent and a dispersed organic phase comprising the one or more ethylenically unsaturated monomers may be formed by any suitable means. For example, the dispersion may be formed by first combining the selected RAFT agent with an aqueous medium and then combing this composition with the organic phase comprising the one or more ethylenically unsaturated monomers. Alternatively, the dispersion may be formed by first combining the selected RAFT agent with the organic phase comprising the one or more ethylenically unsaturated monomers and then combining this composition with an aqueous medium. Regardless of how the dispersion is formed, the selected RAFT agent will typically at least be soluble in the aqueous medium employed. The aqueous medium may include a water miscible solvent to assist with solubilising the RAFT agent. Examples of water miscible solvents include those defined above. Adjusting the pH of the aqueous medium can also facilitate solubilising a RAFT agent that comprises one or more ionizable moieties.

In contrast with the aforementioned pre-formed vesicle approach, RAFT agents selected for use in the polymerisation approach will typically not be capable of self assembling in the aqueous medium to form vesicle structures. In particular, the RAFT agents will generally be selected such that they can first mediate polymerisation of at least a portion of the one or more ethylenically unsaturated monomers to thereby form polymerised RAFT agent which in turn assembles to form the dispersion of polymerisable particles.

By “polymerised RAFT agent” is meant a RAFT agent used in accordance with the invention that has controlled the polymerisation of ethylenically unsaturated monomer.

The ability to form polymerised RAFT agent that assembles to form the dispersion of polymerisable particles is believed to be influenced by at least the nature of the monomer polymerised to form the polymerised RAFT agent, the ratio of components present in the dispersion formed in step (a), and the nature of the RAFT agent employed.

With regard to the nature of the monomer polymerised to form the polymerised RAFT agent, they will generally be hydrophobic in character.

With regard to the ratio of components present in the dispersion formed in step (a), it is believed that the weight percentage of the dispersed organic phase in the continuous aqueous phase should range from about 15 to about 45 wt. %, preferably from about 20 to about 40 wt. %, more preferably from about 25 to about 35 wt. %, relative to the total combined mass of the dispersed organic phase and the continuous aqueous phase. It is also believed that the mole ratio of RAFT agent to monomer present in the dispersion should range from about 1:50 to about 1:4000, preferably from about 1:200 to about 1:3000, more preferably from about 1:300 to about 1:2000. Where two or more RAFT agents or monomer types are present, the mole ratio is based on the sum of moles for each agent and monomer, respectively.

As for the nature of the RAFT agents, they will generally be selected to have a relatively high molecular weight, particularly in terms of the —(X)ₙ— moiety of general formula (4). Thus, n in general formula (4) will typically range from about 10 to about 2000, preferably from about 40 to about 1200, more preferably from about 70 to about 600, most preferably from about 120 to about 500.

RAFT agents of general formula (4) suitable for use in the polymerisation approach will also generally be selected to have groups, sections or regions (hereinafter simply referred to as “sections”) with hydrophilic and hydrophobic properties (i.e. they will have amphipathic character as discussed above). These sections will be provided collectively by the Z, (X)ₙ and R¹ groups of the agent and, unlike agents suitable for use in the pre-formed vesicle approach, will typically be selected such that the agent has less well defined sections with hydrophobic and hydrophilic properties. Those skilled in the art may therefore refer to these agents as having hydrophobic and hydrophilic sections arranged in a random-, tapered- or alternating-type structure. It will be appreciated this is intended to be distinguished from agents that may derive their amphipathic character by having hydrophobic and hydrophilic sections arranged in a block-type structure.

In addition to having less well defined sections with hydrophobic and hydrophilic properties, the agent will also generally be selected to be overall sufficiently hydrophilic in character such that it is soluble in the aqueous phase in which the polymerisable particles are to be formed.

The random-, tapered- or alternating-type structure of the RAFT agent may be provided through different arrangements of hydrophilic and hydrophobic sections of the agent. For example, with reference to formula (4) the amphipathic character provided by either:
1) a combination of hydrophobic and hydrophilic properties; wherein the Z and R¹ groups provide either hydrophobic or hydrophilic properties to their respective ends; each X is a polymerised residue of a hydrophilic or hydrophobic ethylenically unsaturated monomer such that —(X)ₙ— represents a random, alternating or tapered copolymer comprising the polymerised residue of hydrophilic and hydrophobic monomer; and n ranges from 10 to 2000; or.
2) a combination of hydrophobic and hydrophilic properties; wherein the Z and R¹ groups provide either hydrophobic or hydrophilic properties to their respective ends; —(X)ₙ— of formula (4) is represented as -(A)_{f}-[RAT]ₚ-(A)_{g}- such that formula (4) has general formula (5a):

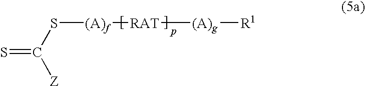

where each A is independently a polymerised residue of an ethylenically unsaturated monomer such that A provides hydrophobic properties (i.e. is the polymerised residue of hydrophobic monomer); f and g independently range from 0 to 100 (e.g. 1 to 100); RAT is the polymerised residue of a mixture of hydrophilic and hydrophobic ethylenically unsaturated monomers that represents a random, alternating or tapered copolymer comprising the polymerised residue of hydrophilic and hydrophobic monomer; p ranges from 10 to 2000 and represents the number of monomer repeat units that make up RAT; with the proviso that the sum of f, p and g is no greater than about 2000; or
3) a variation on general formula (5a) wherein the Z and R¹ groups provide either hydrophobic or hydrophilic properties to their respective ends; —(X)ₙ— of formula (4) is represented as -(A)_{f}-[-(A)ᵣ-(B)ₛ—]ₚ-(A)_{g}- such that formula (4) has general formula (5b):

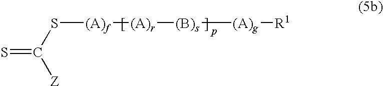

where each A and B is independently a polymerised residue of an ethylenically unsaturated monomer such that A provides hydrophobic properties (i.e. is the polymerised residue of hydrophobic monomer), B provides hydrophilic properties (i.e. is the polymerised residue of hydrophilic monomer), and [-(A)ᵣ-(B)ₛ-]ₚ represents a random, alternating or tapered copolymer; f and g independently range from 0 to 100 (preferably. 1 to 100); r and s independently range from 1 to 20; each repeat unit p may be the same or different; and p ranges from 5 to 200; with the proviso that the sum of f, r, s, p and g is no greater than about 2000; or
4) a variation on general formula (5b) wherein Z is —S-(A)_{f}-[-(A)ᵣ-(B)ₛ—]ₚ-(A)_{g}-R¹, where each A, B, R¹, g, f, r, s and p are as defined in point (3) directly above and may be the same or different thereto.

In contrast with the pre-formed vesicle approach, the selected hydrophilic/hydrophobic character of the R¹ and Z groups in agents used in the polymerisation approach can be less influential in terms of the ability to form the polymerisable particles. Without wishing to be limited by theory, this is believed to result from agents used in the polymerisation approach generally being of higher molecular weight than those used in the pre-formed vesicle approach. In particular, the —(X)ₙ— component of such higher molecular weight agents is believed to dominate their hydrophilic/hydrophobic properties.

The polymerisable particles formed by the polymerisation approach are often more consistent in size compared with the vesicle structures formed by preformed vesicle approach. Thus, there is generally no need to grade the size of the polymerisable particles formed by the polymerisation approach.

When performing the polymerisation approach, a proportion of the ethylenically unsaturated monomers is polymerised. The monomer polymerised will generally introduce hydrophobic character to the agent (i.e. it will generally be a hydrophobic monomer). Without wishing to be limited by theory, it is believed that polymerisation of the monomer renders the agent less soluble in the aqueous phase and in doing so promotes the formation of the polymerisable particles. Agents used in this approach are not believed to be capable in their own right of forming vesicle structures in the aqueous phase without undergoing this polymerisation step. The amount of monomer required to be polymerised in order to promote assembly of the polymerisable particle will generally vary depending upon the nature of the reagents used and reaction conditions employed. Formation of the polymerisable particles can be confirmed using microscopy techniques mentioned above.

The polymerisation step required to form the polymerisable particles via the polymerisation approach will generally be continued through to formation of the vesiculated polymer particles. Thus, the process of forming the polymerisable particles through to forming the vesiculated polymer particles may be viewed as a continuum.

When preparing the aqueous dispersion of polymerisable particles, it may be desirable to incorporate a material within the inner aqueous phase of the particles. Thus, upon polymerisation of the one or more ethylenically unsaturated monomers the aqueous filled void of the resulting vesiculated polymer particles would contain that material.

One approach for including material within the inner aqueous phase of the polymerisable particles may be to prepare the particles using an aqueous medium comprising a water soluble material (e.g. a biologically active agent such as a pharmaceutical, a cosmetic agent, a fragrance, a dye, a chemical reagent or other materials with industrial significance).

Alternatively, it may be possible to include solid particulate material within the inner aqueous phase of the polymerisable particles. One approach for achieving this may be via a modified form of the aforementioned polymerisation approach. In this case, the aqueous dispersion of polymerisable particles may be prepared by (a) forming an initial dispersion comprising a continuous organic phase comprising the one or more ethylenically unsaturated monomers, solid particulate material, and RAFT agent, (b) introducing sufficient aqueous medium to the initial dispersion to render the continuous organic phase discontinuous in the aqueous medium and thereby form a further dispersion comprising a continuous aqueous phase, the RAFT, the solid particulate material and a dispersed organic phase comprising the one or more ethylenically unsaturated monomers (i.e. similar to the dispersion formed in step (a) of the polymerisation approach), and (c) polymerising at least a portion of the one or more ethylenically unsaturated monomers under the control of the RAFT agent such that the resulting polymerised RAFT agent assembles to form the dispersion of polymerisable particles having the solid particulate material within the inner aqueous phase of the particles.

According to this modified version of the polymerisation approach it is believed that the aqueous medium introduced to the initial dispersion combines with and envelopes the dispersed particles of solid material to form a dispersed aqueous phase within the continuous organic phase, wherein the particles of dispersed aqueous phase have solid particulate material contained therein. Addition of the “sufficient” aqueous medium then gives rise to the further dispersion comprising a continuous aqueous phase, the RAFT agent, the solid particulate material and a dispersed organic phase comprising the one or more ethylenically unsaturated monomers. Polymerisation of at least a degree of the monomer then provides for the polymerisable particles as hereinbefore described except that the solid particulate material is located within the inner aqueous phase of the particles.

Solid particulate material might also be included within the inner aqueous phase of the polymerisable particles by (a) forming an initial dispersion having a continuous organic phase comprising the one or more ethylenically unsaturated monomers, a dispersed aqueous phase and a RAFT agent, (b) introducing (1) solid particulate material to the initial dispersion, and (2) sufficient aqueous medium to render the continuous organic phase discontinuous in the aqueous medium to render the continuous organic phase discontinuous in the aqueous medium and thereby form a further dispersion comprising a continuous aqueous phase, the RAFT agent, the solid particulate material and a dispersed organic phase comprising the one or more ethylenically unsaturated monomers (i.e. similar to the dispersion formed in step (a) of the polymerisation approach), and (c) polymerising at least a portion of the one or more ethylenically unsaturated monomers under the control of the RAFT agent such that the resulting polymerised RAFT agent assembles to form the dispersion of polymerisable particles having the solid particulate material within the inner aqueous phase of the particles.

There is no particular limit on the size or shape of the solid particulate material that may be incorporated within the inner aqueous phase of the polymerisable particles. However, it will be appreciated that the particulate material must be small enough to fit within the void defined by the inner aqueous phase. In other words, the solid particulate material must be smaller than the void defined by the inner aqueous phase.

The solid particulate material that is incorporated within the inner aqueous phase of the polymerisable particles may be in the form of one or more primary particles, or in the form of one or more aggregation of primary particles. The approaches described above for incorporating solid particles within the inner aqueous phase have advantageously been found to be particularly effective at incorporating a single primary particle or a single aggregation of primary particles within the inner aqueous phase.

Suitable substances from which the solid particulate material may be formed include, but are not limited to, pigments in general, inorganic material such as titanium dioxide, zinc oxide, calcium carbonate, iron oxide, silicon dioxide, barium sulphate, magnetic materials such γ-iron oxide, and combinations thereof. More hydrophobic organic materials such as waxes, bioactive agents such as pesticides, herbicides, fungicides and pharmaceuticals, and organic pigments such as phthalocyanine blue, phthalocyanine green, quinacridone and dibromananthrone can prove more difficult to incorporate within the hydrophilic environment of the inner aqueous phase.

Preferably, the solid particulate material is hydrophilic in character (i.e. can be wetted by a hydrophilic liquid). Examples of such materials include, but are not limited to, titanium dioxide, zinc oxide, calcium carbonate, iron oxide, silicon dioxide, barium sulphate, and magnetic materials such γ-iron oxide.

Bearing in mind the discussion above on selecting RAFT agents to prepare the dispersion of polymerisable particles, preferred R¹ groups of formula (4) include, but are not limited to, an optionally substituted organic group.

Preferred R¹ organic groups of formula (4) include alkyl, alkenyl, alkynyl, aryl, acyl, carbocyclyl, heterocyclyl, heteroaryl, alkyloxy, alkenyloxy, alkynyloxy, aryloxy, acyloxy, carbocyclyloxy, heterocyclyloxy, heteroaryloxy, alkylthio, alkenylthio, alkynylthio, arylthio, acylthio, carbocyclylthio, heterocyclylthio, heteroarylthio, alkylalkenyl, alkylalkynyl, alkylaryl, alkylacyl, alkylcarbocyclyl, alkylheterocyclyl, alkylheteroaryl, alkyloxyalkyl, alkenyloxyalkyl, alkynyloxyalkyl, aryloxyalkyl, alkylacyloxy, alkylcarbocyclyloxy, alkylheterocyclyloxy, alkylheteroaryloxy, alkylthioalkyl, alkenylthioalkyl, alkynylthioalkyl, arylthioalkyl, alkylacylthio, alkylcarbocyclylthio, alkylheterocyclylthio, alkylheteroarylthio, alkylalkenylalkyl, alkylalkynylalkyl, alkylarylalkyl, alkylacylalkyl, arylalkylaryl, arylalkenylaryl, arylalkynylaryl, arylacylaryl, arylacyl, arylcarbocyclyl, arylheterocyclyl, arylheteroaryl, alkenyloxyaryl, alkynyloxyaryl, aryloxyaryl, arylacyloxy, arylcarbocyclyloxy, arylheterocyclyloxy, arylheteroaryloxy, alkylthioaryl, alkenylthioaryl, alkynylthioaryl, arylthioaryl, arylacylthio, arylcarbocyclylthio, arylheterocyclylthio, and arylheteroarylthio.

More preferred R¹ organic groups of formula (4) include C₁-C₁₈ alkyl, C₂-C₁₈ alkenyl, C₂-C₁₈ alkynyl, C₆-C₁₈ aryl, C₁-C₁₈ acyl, C₃-C₁₈ carbocyclyl, C₂-C₁₈ heterocyclyl, C₃-C₁₈ heteroaryl, C₁-C₁₈ alkyloxy, C₂-C₁₈ alkenyloxy, C₂-C₁₈ alkynyloxy, C₆-C₁₈ aryloxy, C₁-C₁₈ acyloxy, C₃-C₁₈ carbocyclyloxy, C₂-C₁₈ heterocyclyloxy, C₃-C₁₈ heteroaryloxy, C₁-C₁₈ alkylthio, C₂-C₁₈ alkenylthio, C₂-C₁₈ alkynylthio, C₆-C₁₈ arylthio, C₁-C₁₈ acylthio, C₃-C₁₈ carbocyclylthio, C₂-C₁₈ heterocyclylthio, C₃-C₁₈ heteroarylthio, C₃-C₁₈ alkylalkenyl, C₃-C₁₈ alkylalkynyl, C₇-C₂₄ alkylaryl, C₂-C₁₈ alkylacyl, C₄-C₁₈ alkylcarbocyclyl, C₃-C₁₈ alkylheterocyclyl, C₄-C₁₈ alkylheteroaryl, C₂-C₁₈ alkyloxyalkyl, C₃-C₁₈ alkenyloxyalkyl, C₃-C₁₈ alkynyloxyalkyl, C₇-C₂₄ aryloxyalkyl, C₂-C₁₈ alkylacyloxy, C₄-C₁₈ alkylcarbocyclyloxy, C₃-C₁₈ alkylheterocyclyloxy, C₄-C₁₈ alkylheteroaryloxy, C₂-C₁₈ alkylthioalkyl, C₃-C₁₈ alkenylthioalkyl, C₃-C₁₈ alkynylthioalkyl, C₇-C₂₄ arylthioalkyl, C₂-C₁₈ alkylacylthio, C₄-C₁₈ alkylcarbocyclylthio, C₃-C₁₈ alkylheterocyclylthio, C₄-C₁₈ alkylheteroarylthio, C₄-C₁₈ alkylalkenylalkyl, C₄-C₁₈ alkylalkynylalkyl, C₈-C₂₄ alkylarylalkyl, C₃-C₁₈ alkylacylalkyl, C₁₃-C₂₄ arylalkylaryl, C₁₄-C₂₄ arylalkenylaryl, C₁₄-C₂₄ arylalkynylaryl, C₁₃-C₂₄ arylacylaryl, C₇-C₁₈ arylacyl, C₉-C₁₈ arylcarbocyclyl, C₈-C₁₈ arylheterocyclyl, C₉-C₁₈ arylheteroaryl, C₈-C₁₈ alkenyloxyaryl, C₈-C₁₈ alkynyloxyaryl, C₁₂-C₂₄ aryloxyaryl, C₇-C₁₈ arylacyloxy, C₉-C₁₈ arylcarbocyclyloxy, C₈-C₁₈ arylheterocyclyloxy, C₉-C₁₈ arylheteroaryloxy, C₇-C₁₈ alkylthioaryl, C₈-C₁₈ alkenylthioaryl, C₈-C₁₈ alkynylthioaryl, C₁₂-C₂₄ arylthioaryl, C₇-C₁₈ arylacylthio, C₉-C₁₈ arylcarbocyclylthio, C₈-C₁₈ arylheterocyclylthio, and C₉-C₁₈ arylheteroarylthio.

Most preferred R¹ organic groups of formula (4) include alkyl and alkylaryl.

Where the polymerisable particles are formed by the pre-formed vesicle approach, the R¹ organic group of formula (4) will generally be substituted with one or more hydrophilic substituents. In this case, preferred hydrophilic substituents include —CO₂H, —CO₂RN, —SO₃H, —OSO₃H, —SORN, —SO₂RN, —OP(OH)₂, —P(OH)₂, —PO(OH)₂, —OH, —ORN, —(OCH₂—CHR)_{w}—OH, —CONH₂, CONHR′, CONR′R″, —NR′R″, —N⁺R′R″R′″, where R is selected from C₁-C₆ alkyl, w is 1 to 10, R′, R″ and R′″ are independently selected from alkyl and aryl which are optionally substituted with one or more hydrophilic substituents selected from —CO₂H, —SO₃H, —OSO₃H, —OH, —(COCH₂CHR)_{w}—OH, —CONH₂, —SOR and —SO₂R, and salts thereof, R and w are as defined above.

Where the polymerisable particles are formed by the pre-formed vesicle approach, preferred R¹ groups of formula (4) include, but are not limited to, C₁-C₆ alkyl, C₇-C₂₄ aryloxyalkyl, C₄-C₁₈ alkylheteroaryloxy, each of which is substituted with one or more hydrophilic groups selected from —CO₂H, —CO₂RN, —SO₃H, —OSO₃H, —SORN, —SO₂RN, —OP(OH)₂, —P(OH)₂, —PO(OH)₂, —OH, —ORN, —(OCH₂—CHR)_{w}—OH, —CONH₂, CONHR′, CONR′R″, —NR′R″, —N⁺R′R″R′″, where R is selected from C₁-C₆ alkyl, w is 1 to 10, R′, R″ and R′″ are independently selected from alkyl and aryl which are optionally substituted with one or more hydrophilic substituents selected from —CO₂H, —SO₃H, —OSO₃H, —OH, —(COCH₂CHR)_{w}—OH, —CONH₂, —SOR and —SO₂R, and salts thereof, R and w are as defined above.

Where the polymerisable particles are formed by the pre-formed vesicle approach, particularly preferred R¹ groups formula (4) include, but are not limited to, —CH(CH₃)CO₂H, —CH(CO₂H)CH₂CO₂H, and —C(CH₃)₂CO₂H.

Where the polymerisable particles are formed by the polymerisation approach, preferred R¹ groups of formula (4) include, but are not limited to, those indicated above as preferred and particular preferred for the pre-formed vesicle approach and alkylaryl (e.g. benzyl).

Preferred Z groups of formula (4) include, but are not limited to, alkoxy, aryloxy, alkyl, aryl, heterocyclyl, arylalkyl, alkylthio, arylalkylthio, dialkoxy- or diaryloxy-phosphinyl [—P(═O)OR²₂], dialkyl- or diaryl-phosphinyl [—P(═O)R²₂], acylamino, acylimino, amino, R¹—(X)ₙ—S— and a polymer chain formed by any mechanism, for example polyalkylene oxide polymers such as water soluble polyethylene glycol or polypropylene glycol, and alkyl end capped derivatives thereof, where R¹, X and n are as defined above and R² is selected from the group consisting of alkyl, alkenyl, aryl, heterocyclyl, and alkylaryl.

More preferred Z groups of formula (4) include, but are not limited to, C₁-C₂₀ alkoxy, C₆-C₂₀ aryloxy, C₁-C₂₀ alkyl, C₆-C₂₀ aryl, C₃-C₂₀ heterocyclyl, C₇-C₂₀ arylalkyl, C₁-C₂₀ alkylthio, C₇-C₂₀ arylalkylthio, dialkoxy- or diaryloxy-phosphinyl [—P(═O)OR²₂], dialkyl- or diaryl-phosphinyl [—P(═O)R²₂], C₁-C₂₀ acylamino, C₁-C₂₀ acylimino, C₀-C₂₀ amino, and R¹—(X)ₙ—S—, where R¹, X and n are as defined above and R² is selected from the group consisting of C₁-C₁₈ alkyl, C₂-C₁₈ alkenyl, C₂-C₁₈ alkynyl, C₆-C₁₈ aryl, C₂-C₁₈ heterocyclyl, and C₇-C₂₄ alkylaryl.

For avoidance of doubt, the nomenclature “Cₓ-C_{y} optionally substituted [group]” is intended to mean that the [group], whether substituted or not, has a total number of carbon atoms in the range Cₓ-C_{y}.

Particularly preferred Z groups of formula (4) include, but are not limited to, —CH₂(C₆H₅), C₁-C₂₀ alkyl,

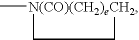

where e is 2 to 4, and —SR³, where R³ is selected from C₁ to C₂₀ alkyl.

In the lists above defining divalent groups from which R¹, R² or Z may be selected, each alkyl, alkenyl, alkynyl, aryl, carbocyclyl, heteroaryl, and heterocyclyl moiety may be optionally substituted. For avoidance of any doubt, where a given R¹, R² or Z group contains two or more of such moieties (e.g. alkylaryl), each of such moieties may be optionally substituted with one, two, three or more optional substituents as herein defined.

In the lists above defining divalent groups from which R¹, R² or Z may be selected, where a given R¹, R² or Z group contains two or more subgroups (e.g. [group A][group B]), the order of the subgroups are not intended to be limited to the order in which they are presented. Thus, an R¹, R² or Z group with two subgroups defined as [group A] [group B] (e.g. alkylaryl) is intended to also be a reference to an R¹, R² or Z with two subgroups defined as [group B][group A] (e.g. arylalkyl).

Preferred optional substituents for R² or Z groups of formula (4) include epoxy, hydroxy, alkoxy, acyl, acyloxy, carboxy (and salts), sulfonic acid (and salts), alkoxy- or aryloxy-carbonyl, isocyanato, cyano, silyl, halo, and dialkylamino.

In selecting both R¹ and Z groups for RAFT agents of formula (4), those agents resulting from any combination of preferred R¹ and Z groups are also preferred. Where the hydrophilic group is —N⁺R′R″R′″ there will be an associated counter anion.

As indicated above, RAFT agents of general formula (4) used in the preformed vesicle or polymerisation approach will generally be selected such that —(X)ₙ— comprises the polymerised residue of hydrophilic and hydrophobic monomers. At least a proportion of the polymerised residue of hydrophilic monomer is preferably the polymerised residue of an ionizable ethylenically unsaturated monomer. Where —(X)ₙ— comprises the polymerised residue of ionizable ethylenically unsaturated monomer, adjusting the pH of the aqueous phase or medium when performing the method of the inventions can promote ionisation of some or all of the ionizable residues, which in turn has been found to facilitate formation of the vesicles and/or the polymerisable particles.

As used herein, the term “alkyl”, used either alone or in compound words denotes straight chain, branched or cyclic alkyl, preferably C₁₋₂₀ alkyl, e.g. C₁₋₁₀ or C₁₋₆. Examples of straight chain and branched alkyl include methyl, ethyl, n-propyl, isopropyl, n-butyl, sec-butyl, t-butyl, n-pentyl, 1,2-dimethylpropyl, 1,1-dimethyl-propyl, hexyl, 4-methylpentyl, 1-methylpentyl, 2-methylpentyl, 3-methylpentyl, 1,1-dimethylbutyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, heptyl, 5-methylhexyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethyl-pentyl, 1,2,3-trimethylbutyl, 1,1,2-trimethylbutyl, 1,1,3-trimethylbutyl, octyl, 6-methylheptyl, 1-methylheptyl, 1,1,3,3-tetramethylbutyl, nonyl, 1-, 2-, 3-, 4-, 5-, 6- or 7-methyloctyl, 1-, 2-, 3-, 4- or 5-ethylheptyl, 1-, 2- or 3-propylhexyl, decyl, 1-, 2-, 3-, 4-, 5-, 6-, 7- and 8-methylnonyl, 1-, 2-, 3-, 4-, 5- or 6-ethyloctyl, 1-, 2-, 3- or 4-propylheptyl, undecyl, 1-, 2-, 3-, 4-, 5-, 6-, 7-, 8- or 9-methyldecyl, 1-, 2-, 3-, 4-, 5-, 6- or 7-ethylnonyl, 1-, 2-, 3-, 4- or 5-propyloctyl, 1-, 2- or 3-butylheptyl, 1-pentylhexyl, dodecyl, 1-, 2-, 3-, 4-, 5-, 6-, 7-, 8-, 9- or 10-methylundecyl, 1-, 2-, 3-, 4-, 5-, 6-, 7- or 8-ethyldecyl, 1-, 2-, 3-, 4-, 5- or 6-propylnonyl, 1-, 2-, 3- or 4-butyloctyl, 1-2-pentylheptyl and the like. Examples of cyclic alkyl include mono- or polycyclic alkyl groups such as cyclopropyl, cyclobutyl, cyclopentyl, cyclohexyl, cycloheptyl, cyclooctyl, cyclononyl, cyclodecyl and the like. Where an alkyl group is referred to generally as “propyl”, butyl” etc, it will be understood that this can refer to any of straight, branched and cyclic isomers where appropriate. An alkyl group may be optionally substituted by one or more optional substituents as herein defined.

The term “alkenyl” as used herein denotes groups formed from straight chain, branched or cyclic hydrocarbon residues containing at least one carbon to carbon double bond including ethylenically mono-, di- or polyunsaturated alkyl or cycloalkyl groups as previously defined, preferably C₂₋₂₀ alkenyl (e.g. C₂₋₁₀ or C₂₋₆). Examples of alkenyl include vinyl, allyl, 1-methylvinyl, butenyl, iso-butenyl, 3-methyl-2-butenyl, 1-pentenyl, cyclopentenyl, 1-methyl-cyclopentenyl, 1-hexenyl, 3-hexenyl, cyclohexenyl, 1-heptenyl, 3-heptenyl, 1-octenyl, cyclooctenyl, 1-nonenyl, 2-nonenyl, 3-nonenyl, 1-decenyl, 3-decenyl, 1,3-butadienyl, 1,4-pentadienyl, 1,3-cyclopentadienyl, 1,3-hexadienyl, 1,4-hexadienyl, 1,3-cyclohexadienyl, 1,4-cyclohexadienyl, 1,3-cycloheptadienyl, 1,3,5-cycloheptatrienyl and 1,3,5,7-cyclooctatetraenyl. An alkenyl group may be optionally substituted by one or more optional substituents as herein defined.

As used herein the term “alkynyl” denotes groups formed from straight chain, branched or cyclic hydrocarbon residues containing at least one carbon-carbon triple bond including ethylenically mono-, di- or polyunsaturated alkyl or cycloalkyl groups as previously defined. Unless the number of carbon atoms is specified the term preferably refers to C₂₋₂₀ alkynyl (e.g. C₂₋₁₀ or C₂₋₆). Examples include ethynyl, 1-propynyl, 2-propynyl, and butynyl isomers, and pentynyl isomers. An alkynyl group may be optionally substituted by one or more optional substituents as herein defined.

The term “halogen” (“halo”) denotes fluorine, chlorine, bromine or iodine (fluoro, chloro, bromo or iodo). Preferred halogens are chlorine, bromine or iodine.

The term “aryl” (or “carboaryl)” denotes any of single, polynuclear, conjugated and fused residues of aromatic hydrocarbon ring systems. Examples of aryl include phenyl, biphenyl, terphenyl, quaterphenyl, naphthyl, tetrahydronaphthyl, anthracenyl, dihydroanthracenyl, benzanthracenyl, dibenzanthracenyl, phenanthrenyl, fluorenyl, pyrenyl, idenyl, azulenyl, chrysenyl. Preferred aryl include phenyl and naphthyl. An aryl group may or may not be optionally substituted by one or more optional substituents as herein defined. The term “arylene” is intended to denote the divalent form of aryl.

The term “carbocyclyl” includes any of non-aromatic monocyclic, polycyclic, fused or conjugated hydrocarbon residues, preferably C₃₋₂₀ (e.g. C₃₋₁₀ or C₃₋₈). The rings may be saturated, e.g. cycloalkyl, or may possess one or more double bonds (cycloalkenyl) and/or one or more triple bonds (cycloalkynyl). Particularly preferred carbocyclyl moieties are 5-6-membered or 9-10 membered ring systems. Suitable examples include cyclopropyl, cyclobutyl, cyclopentyl, cyclohexyl, cycloheptyl, cyclooctyl, cyclononyl, cyclodecyl, cyclopentenyl, cyclohexenyl, cyclooctenyl, cyclopentadienyl, cyclohexadienyl, cyclooctatetraenyl, indanyl, decalinyl and indenyl. A carbocyclyl group may be optionally substituted by one or more optional substituents as herein defined. The term “carbocyclylene” is intended to denote the divalent form of carbocyclyl.

The term “heterocyclyl” when used alone or in compound words includes any of monocyclic, polycyclic, fused or conjugated hydrocarbon residues, preferably C₃₋₂₀ (e.g. C₃₋₁₀ or C₃₋₈) wherein one or more carbon atoms are replaced by a heteroatom so as to provide a non-aromatic residue. Suitable heteroatoms include O, N, S, P and Se, particularly O, N and S. Where two or more carbon atoms are replaced, this may be by two or more of the same heteroatom or by different heteroatoms. The heterocyclyl group may be saturated or partially unsaturated, i.e. possess one or more double bonds. Particularly preferred heterocyclyl are 5-6 and 9-10 membered heterocyclyl. Suitable examples of heterocyclyl groups may include aziridinyl, oxiranyl, thiiranyl, azetidinyl, oxetanyl, thietanyl, 2H-pyrrolyl, pyrrolidinyl, pyrrolinyl, piperidyl, piperazinyl, morpholinyl, indolinyl, imidazolidinyl, imidazolinyl, pyrazolidinyl, thiomorpholinyl, dioxanyl, tetrahydrofuranyl, tetrahydropyranyl, tetrahydropyrrolyl, tetrahydrothiophenyl, pyrazolinyl, dioxolanyl, thiazolidinyl, isoxazolidinyl, dihydropyranyl, oxazinyl, thiazinyl, thiomorpholinyl, oxathiazyl, dithianyl, trioxanyl, thiadiazinyl, dithiazinyl, trithianyl, azepinyl, oxepinyl, thiepinyl, indenyl, indanyl, 3H-indolyl, isoindolinyl, 4H-quinolizinyl, chromenyl, chromanyl, isochromanyl, pyranyl and dihydropyranyl. A heterocyclyl group may be optionally substituted by one or more optional substituents as herein defined. The term “heterocyclylene” is intended to denote the divalent form of heterocyclyl.

The term “heteroaryl” includes any of monocyclic, polycyclic, fused or conjugated hydrocarbon residues, wherein one or more carbon atoms are replaced by a heteroatom so as to provide an aromatic residue. Preferred heteroaryl have 3-20 ring atoms, e.g. 3-10. Particularly preferred heteroaryl are 5-6 and 9-10 membered bicyclic ring systems.

Suitable heteroatoms include, O, N, S, P and Se, particularly O, N and S. Where two or more carbon atoms are replaced, this may be by two or more of the same heteroatom or by different heteroatoms. Suitable examples of heteroaryl groups may include pyridyl, pyrrolyl, thienyl, imidazolyl, furanyl, benzothienyl, isobenzothienyl, benzofuranyl, isobenzofuranyl, indolyl, isoindolyl, pyrazolyl, pyrazinyl, pyrimidinyl, pyridazinyl, indolizinyl, quinolyl, isoquinolyl, phthalazinyl, 1,5-naphthyridinyl, quinozalinyl, quinazolinyl, quinolinyl, oxazolyl, thiazolyl, isothiazolyl, isoxazolyl, triazolyl, oxadiazolyl, oxatriazolyl, triazinyl, and furazanyl. A heteroaryl group may be optionally substituted by one or more optional substituents as herein defined. The term “heteroarylene” is intended to denote the divalent form of heteroaryl.

The term “acyl” either alone or in compound words denotes a group containing the moiety C═O (and not being a carboxylic acid, ester or amide) Preferred acyl includes C(O)—R^{e}, wherein R^{e} is hydrogen or an alkyl, alkenyl, alkynyl, aryl, heteroaryl, carbocyclyl, or heterocyclyl residue. Examples of acyl include formyl, straight chain or branched alkanoyl (e.g. C₁₋₂₀) such as acetyl, propanoyl, butanoyl, 2-methylpropanoyl, pentanoyl, 2,2-dimethylpropanoyl, hexanoyl, heptanoyl, octanoyl, nonanoyl, decanoyl, undecanoyl, dodecanoyl, tridecanoyl, tetradecanoyl, pentadecanoyl, hexadecanoyl, heptadecanoyl, octadecanoyl, nonadecanoyl and icosenoyl; cycloalkylcarbonyl such as cyclopropylcarbonyl cyclobutylcarbonyl, cyclopentylcarbonyl and cyclohexylcarbonyl; aroyl such as benzoyl, toluoyl and naphthoyl; aralkanoyl such as phenylalkanoyl (e.g. phenylacetyl, phenylpropanoyl, phenylbutanoyl, phenylisobutylyl, phenylpentanoyl and phenylhexanoyl) and naphthylalkanoyl (e.g. naphthylacetyl, naphthylpropanoyl and naphthylbutanoyl]; aralkenoyl such as phenylalkenoyl (e.g. phenylpropenoyl, phenylbutanoyl, phenylmethacryloyl, phenylpentanoyl and phenylhexanoyl and naphthylalkenoyl (e.g. naphthylpropenoyl, naphthylbutenoyl and naphthylpentenoyl); aryloxyalkanoyl such as phenoxyacetyl and phenoxypropionyl; arylthiocarbamoyl such as phenylthiocarbamoyl; arylglyoxyloyl such as phenylglyoxyloyl and naphthylglyoxyloyl; arylsulfonyl such as phenylsulfonyl and napthylsulfonyl; heterocycliccarbonyl; heterocyclicalkanoyl such as thienylacetyl, thienylpropanoyl, thienylbutanoyl, thienylpentanoyl, thienylhexanoyl, thiazolylacetyl, thiadiazolylacetyl and tetrazolylacetyl; heterocyclicalkenoyl such as heterocyclicpropenoyl, heterocyclicbutenoyl, heterocyclicpentenoyl and heterocyclichexenoyl; and heterocyclicglyoxyloyl such as thiazolyglyoxyloyl and thienylglyoxyloyl. The R^{e} residue may be optionally substituted as described herein.

The term “sulfoxide”, either alone or in a compound word, refers to a group —S(O)R^{f} wherein R^{f} is selected from hydrogen, alkyl, alkenyl, alkynyl, aryl, heteroaryl, heterocyclyl, carbocyclyl, and aralkyl. Examples of preferred R^{f} include C₁₋₂₀alkyl, phenyl and benzyl.

The term “sulfonyl”, either alone or in a compound word, refers to a group S(O)₂—R^{f}, wherein R^{f} is selected from hydrogen, alkyl, alkenyl, alkynyl, aryl, heteroaryl, heterocyclyl, carbocyclyl and aralkyl. Examples of preferred R^{f} include C₁₋₂₀alkyl, phenyl and benzyl.

The term “sulfonamide”, either alone or in a compound word, refers to a group S(O)NR^{f}R^{f} wherein each R^{f} is independently selected from hydrogen, alkyl, alkenyl, alkynyl, aryl, heteroaryl, heterocyclyl, carbocyclyl, and aralkyl. Examples of preferred R^{f} include C₁₋₂₀alkyl, phenyl and benzyl. In a preferred embodiment at least one R^{f} is hydrogen. In another form, both R^{f} are hydrogen.

The term, “amino” is used here in its broadest sense as understood in the art and includes groups of the formula NR^{a}R^{b} wherein R^{a} and R^{b} may be any independently selected from hydrogen, alkyl, alkenyl, alkynyl, aryl, carbocyclyl, heteroaryl, heterocyclyl, arylalkyl, and acyl. R^{a} and R^{b}, together with the nitrogen to which they are attached, may also form a monocyclic, or polycyclic ring system e.g. a 3-10 membered ring, particularly, 5-6 and 9-10 membered systems. Examples of “amino” include NH₂, NHalkyl (e.g. C₁₋₂₀alkyl), NHaryl (e.g. NHphenyl), NHaralkyl (e.g. NHbenzyl), NHacyl (e.g. NHC(O)C₁₋₂₀alkyl, NHC(O)phenyl), Nalkylalkyl (wherein each alkyl, for example C₁₋₂₀, may be the same or different) and 5 or 6 membered rings, optionally containing one or more same or different heteroatoms (e.g. O, N and S).

The term “amido” is used here in its broadest sense as understood in the art and includes groups having the formula C(O)NR^{a}R^{b}, wherein R^{a} and R^{b} are as defined as above.

Examples of amido include C(O)NH₂, C(O)NHalkyl (e.g. C₁₋₂₀alkyl), C(O)NHaryl (e.g. C(O)NHphenyl), C(O)NHaralkyl (e.g. C(O)NHbenzyl), C(O)NHacyl (e.g. C(O)NHC(O)C₁₋₂₀alkyl, C(O)NHC(O)phenyl), C(O)Nalkylalkyl (wherein each alkyl, for example C₁₋₂₀, may be the same or different) and 5 or 6 membered rings, optionally containing one or more same or different heteroatoms (e.g. O, N and S).

The term “carboxy ester” is used here in its broadest sense as understood in the art and includes groups having the formula CO₂R^{g}, wherein R^{g} may be selected from groups including alkyl, alkenyl, alkynyl, aryl, carbocyclyl, heteroaryl, heterocyclyl, aralkyl, and acyl. Examples of carboxy ester include CO₂C₁₋₂₀alkyl, CO₂aryl (e.g. CO₂phenyl), CO₂aralkyl (e.g. CO₂ benzyl).

In this specification “optionally substituted” is taken to mean that a group may or may not be substituted or fused (so as to form a condensed polycyclic group) with one, two, three or more of organic and inorganic groups, including those selected from: alkyl, alkenyl, alkynyl, carbocyclyl, aryl, heterocyclyl, heteroaryl, acyl, aralkyl, alkaryl, alkheterocyclyl, alkheteroaryl, alkcarbocyclyl, halo, haloalkyl, haloalkenyl, haloalkynyl, haloaryl, halocarbocyclyl, haloheterocyclyl, haloheteroaryl, haloacyl, haloaryalkyl, hydroxy, hydroxyalkyl, hydroxyalkenyl, hydroxyalkynyl, hydroxycarbocyclyl, hydroxyaryl, hydroxyheterocyclyl, hydroxyheteroaryl, hydroxyacyl, hydroxyaralkyl, alkoxyalkyl, alkoxyalkenyl, alkoxyalkynyl, alkoxycarbocyclyl, alkoxyaryl, alkoxyheterocyclyl, alkoxyheteroaryl, alkoxyacyl, alkoxyaralkyl, alkoxy, alkenyloxy, alkynyloxy, aryloxy, carbocyclyloxy, aralkyloxy, heteroaryloxy, heterocyclyloxy, acyloxy, haloalkoxy, haloalkenyloxy, haloalkynyloxy, haloaryloxy, halocarbocyclyloxy, haloaralkyloxy, haloheteroaryloxy, haloheterocyclyloxy, haloacyloxy, nitro, nitroalkyl, nitroalkenyl, nitroalkynyl, nitroaryl, nitroheterocyclyl, nitroheteroayl, nitrocarbocyclyl, nitroacyl, nitroaralkyl, amino (NH₂), alkylamino, dialkylamino, alkenylamino, alkynylamino, arylamino, diarylamino, aralkylamino, diaralkylamino, acylamino, diacylamino, heterocyclamino, heteroarylamino, carboxy, carboxyester, amido, alkylsulphonyloxy, arylsulphenyloxy, alkylsulphenyl, arylsulphenyl, thio, alkylthio, alkenylthio, alkynylthio, arylthio, aralkylthio, carbocyclylthio, heterocyclylthio, heteroarylthio, acylthio, sulfoxide, sulfonyl, sulfonamide, aminoalkyl, aminoalkenyl, aminoalkynyl, aminocarbocyclyl, aminoaryl, aminoheterocyclyl, aminoheteroaryl, aminoacyl, aminoaralkyl, thioalkyl, thioalkenyl, thioalkynyl, thiocarbocyclyl, thioaryl, thioheterocyclyl, thioheteroaryl, thioacyl, thioaralkyl, carboxyalkyl, carboxyalkenyl, carboxyalkynyl, carboxycarbocyclyl, carboxyaryl, carboxyheterocyclyl, carboxyheteroaryl, carboxyacyl, carboxyaralkyl, carboxyesteralkyl, carboxyesteralkenyl, carboxyesteralkynyl, carboxyestercarbocyclyl, carboxyesteraryl, carboxyesterheterocyclyl, carboxyesterheteroaryl, carboxyesteracyl, carboxyesteraralkyl, amidoalkyl, amidoalkenyl, amidoalkynyl, amidocarbocyclyl, amidoaryl, amidoheterocyclyl, amidoheteroaryl, amidoacyl, amidoaralkyl, formylalkyl, formylalkenyl, formylalkynyl, formylcarbocyclyl, formylaryl, formylheterocyclyl, formylheteroaryl, formylacyl, formylaralkyl, acylalkyl, acylalkenyl, acylalkynyl, acylcarbocyclyl, acylaryl, acylheterocyclyl, acylheteroaryl, acylacyl, acylaralkyl, sulfoxidealkyl, sulfoxidealkenyl, sulfoxidealkynyl, sulfoxidecarbocyclyl, sulfoxidearyl, sulfoxideheterocyclyl, sulfoxideheteroaryl, sulfoxideacyl, sulfoxidearalkyl, sulfonylalkyl, sulfonylalkenyl, sulfonylalkynyl, sulfonylcarbocyclyl, sulfonylaryl, sulfonylheterocyclyl, sulfonylheteroaryl, sulfonylacyl, sulfonylaralkyl, sulfonamidoalkyl, sulfonamidoalkenyl, sulfonamidoalkynyl, sulfonamidocarbocyclyl, sulfonamidoaryl, sulfonamidoheterocyclyl, sulfonamidoheteroaryl, sulfonamidoacyl, sulfonamidoaralkyl, nitroalkyl, nitroalkenyl, nitroalkynyl, nitrocarbocyclyl, nitroaryl, nitroheterocyclyl, nitroheteroaryl, nitroacyl, nitroaralkyl, cyano, sulfate and phosphate groups. Optional substitution may also be taken to refer to where a —CH₂— group in a chain or ring is replaced by a group selected from —O—, —S—, —NR^{a}—, —C(O)— (i.e. carbonyl), —C(O)O— (i.e. ester), and —C(O)NR^{a}— (i.e. amide), where R^{a} is as defined herein.

Preferred optional substituents include alkyl, (e.g. C₁₋₆ alkyl such as methyl, ethyl, propyl, butyl, cyclopropyl, cyclobutyl, cyclopentyl or cyclohexyl), hydroxyalkyl (e.g. hydroxymethyl, hydroxyethyl, hydroxypropyl), alkoxyalkyl (e.g. methoxymethyl, methoxyethyl, methoxypropyl, ethoxymethyl, ethoxyethyl, ethoxypropyl etc) alkoxy (e.g. C₁₋₆ alkoxy such as methoxy, ethoxy, propoxy, butoxy, cyclopropoxy, cyclobutoxy), halo, trifluoromethyl, trichloromethyl, tribromomethyl, hydroxy, phenyl (which itself may be further substituted e.g., by C₁₋₆ alkyl, halo, hydroxy, hydroxyC₁₋₆ alkyl, C₁₋₆ alkoxy, haloC₁₋₆alkyl, cyano, nitro OC(O)C₁₋₆ alkyl, and amino), benzyl (wherein benzyl itself may be further substituted e.g., by C₁₋₆ alkyl, halo, hydroxy, hydroxyC₁₋₆alkyl, C₁₋₆ alkoxy, haloC₁₋₆ alkyl, cyano, nitro OC(O)C₁₋₆ alkyl, and amino), phenoxy (wherein phenyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), benzyloxy (wherein benzyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), amino, alkylamino (e.g. C₁₋₆ alkyl, such as methylamino, ethylamino, propylamino etc), dialkylamino (e.g. C₁₋₆ alkyl, such as dimethylamino, diethylamino, dipropylamino), acylamino (e.g. NHC(O)CH₃), phenylamino (wherein phenyl itself may be further substituted e.g., by C₁₋₆ alkyl, halo, hydroxy, hydroxyC₁₋₆ alkyl, C₁₋₆ alkoxy, haloC₁₋₆ alkyl, cyano, nitro OC(O)C₁₋₆ alkyl, and amino), nitro, formyl, —C(O)-alkyl (e.g. C₁₋₆ alkyl, such as acetyl), O—C(O)-alkyl (e.g. C₁₋₆alkyl, such as acetyloxy), benzoyl (wherein the phenyl group itself may be further substituted e.g., by C₁₋₆ alkyl, halo, hydroxy hydroxyC₁₋₆ alkyl, C₁₋₆ alkoxy, haloC₁₋₆ alkyl, cyano, nitro OC(O)C₁₋₆alkyl, and amino), replacement of CH₂ with C═O, CO₂H, CO₂alkyl (e.g. C₁₋₆ alkyl such as methyl ester, ethyl ester, propyl ester, butyl ester), CO₂phenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONH₂, CONHphenyl (wherein phenyl itself may be further substituted e.g., by C₁₋₆ alkyl, halo, hydroxy, hydroxyl C₁₋₆ alkyl, C₁₋₆ alkoxy, halo C₁₋₆ alkyl, cyano, nitro OC(O)C₁₋₆ alkyl, and amino), CONHbenzyl (wherein benzyl itself may be further substituted e.g., by C₁₋₆ alkyl, halo, hydroxy hydroxyl C₁₋₆ alkyl, C₁₋₆ alkoxy, halo C₁₋₆ alkyl, cyano, nitro OC(O)C₁₋₆ alkyl, and amino), CONHalkyl (e.g. C₁₋₆ alkyl such as methyl ester, ethyl ester, propyl ester, butyl amide) CONHdialkyl (e.g. C₁₋₆ alkyl) aminoalkyl (e.g., HN C₁₋₆ alkyl-, C₁₋₆alkylHN—C₁₋₆ alkyl- and (C₁₋₆ alkyl)₂N—C₁₋₆ alkyl-), thioalkyl (e.g., HS C₁₋₆ alkyl-), carboxyalkyl (e.g., HO₂CC₁₋₆ alkyl-), carboxyesteralkyl (e.g., C₁₋₆ alkylO₂CC₁₋₆ alkyl-), amidoalkyl (e.g., H₂N(O)CC₁₋₆ alkyl-, H(C₁₋₆ alkyl)N(O)CC₁₋₆ alkyl-), formylalkyl (e.g., OHCC₁₋₆alkyl-), acylalkyl (e.g., C₁₋₆ alkyl(O)CC₁₋₆ alkyl-), nitroalkyl (e.g., O₂NC₁₋₆ alkyl-), sulfoxidealkyl (e.g., R(O)SC₁₋₆ alkyl, such as C₁₋₆ alkyl(O)SC₁₋₆ alkyl-), sulfonylalkyl (e.g., R(O)₂SC₁₋₆ alkyl- such as C₁₋₆ alkyl(O)₂SC₁₋₆ alkyl-), sulfonamidoalkyl (e.g., ₂HRN(O)SC₁₋₆alkyl, H(C₁₋₆ alkyl)N(O)SC₁₋₆ alkyl-).

The term “heteroatom” or “hetero” as used herein in its broadest sense refers to any atom other than a carbon atom which may be a member of a cyclic organic group. Particular examples of heteroatoms include nitrogen, oxygen, sulfur, phosphorous, boron, silicon, selenium and tellurium, more particularly nitrogen, oxygen and sulfur.

For monovalent substituents, terms written as “[groupA][group B]” refer to group A when linked by a divalent form of group B. For example, “[group A][alkyl]” refers to a particular group A (such as hydroxy, amino, etc.) when linked by divalent alkyl, i.e. alkylene (e.g. hydroxyethyl is intended to denote HO—CH₂—CH—). Thus, terms written as “[group]oxy” refer to a particular group when linked by oxygen, for example, the terms “alkoxy” or “alkyloxy”, “alkenoxy” or “alkenyloxy”, “alkynoxy” or alkynyloxy”, “aryloxy” and “acyloxy”, respectively, denote alkyl, alkenyl, alkynyl, aryl and acyl groups as hereinbefore defined when linked by oxygen. Similarly, terms written as “[group]thio” refer to a particular group when linked by sulfur, for example, the terms “alkylthio”, “alkenylthio”, alkynylthio” and “arylthio”, respectively, denote alkyl, alkenyl, alkynyl and aryl groups as hereinbefore defined when linked by sulfur.

As used herein, the term “salt” denotes a species in ionised form, and includes both acid addition and base addition salts. In the context of the present invention, suitable salts are those that do not interfere with the RAFT chemistry.

As used herein, the term “counter anion” denotes a species capable of providing a negative charge to balance the charge of the corresponding cation. Examples of counter anions include, Cl⁻, I⁻, Br⁻, F⁻, NO₃⁻, CN⁻ and PO₃⁻.

Most preferred RAFT agents of formula (4) include, but are not limited to, agents represented by the following general formulas 6 to 10:

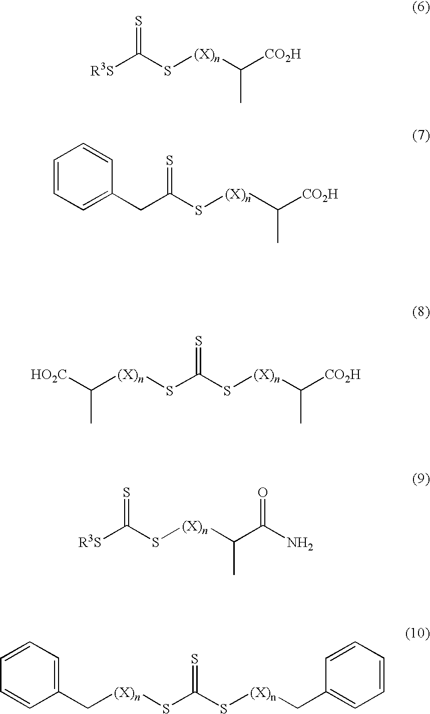

where R³, X and n are as previously defined.

When selecting a RAFT agent for use in accordance with the method of the invention, it is preferable that it demonstrates hydrolytic stability. Trithiocarbonyl RAFT agents have been found to generally offer good hydrolytic stability.

In accordance with the method of the invention, ethylenically unsaturated monomers are polymerised under the control of the RAFT agent to form a polymer layer around the inner aqueous phase of the polymerisable particles. The polymerisation will usually require initiation from a source of free radicals. The source of initiating radicals can be provided by any suitable method of generating free radicals, such as the thermally induced homolytic scission of suitable compound(s) (thermal initiators such as peroxides, peroxyesters, or azo compounds), the spontaneous generation from monomers (e.g. styrene), redox initiating systems, photochemical initiating systems or high energy radiation such as electron beam, X— or gamma-radiation. The initiating system is chosen such that under the reaction conditions there is no substantial adverse interaction of the initiator or the initiating radicals with the amphipathic RAFT agent under the conditions of the reaction.

Thermal initiators are chosen to have an appropriate half life at the temperature of polymerisation. These initiators can include one or more of the following compounds:
2,2′-azobis(isobutyronitrile), 2,2′-azobis(2-cyanobutane), dimethyl 2,2′-azobis(isobutyrate), 4,4′-azobis(4-cyanovaleric acid), 1,1′-azobis(cyclohexanecarbonitrile), 2-(t-butylazo)-2-cyanopropane, 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N,N′-dimethyleneisobutyramidine) dihydrochloride, 2,2′-azobis(2-amidinopropane) dihydrochloride, 2,2′-azobis(N,N′-dimethyleneisobutyramidine), 2,2′-azobis{2-methyl-N-[1,1-bis(hydroxymethyl)-2-hydroxyethyl]propionamide}, 2,2′-azobis {2-methyl-N-[1,1-bis(hydroxymethyl)-2-ethyl]propionamide}, 2,2′-azobis[2-methyl-N-(2-hydroxyethyl)propionamide], 2,2′-azobis(isobutyramide) dihydrate, 2,2′-azobis(2,2,4-trimethylpentane), 2,2′-azobis(2-methylpropane), t-butyl peroxyacetate, t-butyl peroxybenzoate, t-butyl peroxyneodecanoate, t-butylperoxy isobutyrate, t-amyl peroxypivalate, t-butyl peroxypivalate, diisopropyl peroxydicarbonate, dicyclohexyl peroxydicarbonate, dicumyl peroxide, dibenzoyl peroxide, dilauroyl peroxide, potassium peroxydisulfate, ammonium peroxydisulfate, di-t-butyl hyponitrite, dicumyl hyponitrite. This list is not exhaustive.

Photochemical initiator systems are chosen to have the requisite solubility in the reaction medium and have an appropriate quantum yield for radical production under the conditions of the polymerisation. Examples include benzoin derivatives, benzophenone, acyl phosphine oxides, and photo-redox systems.

Redox initiator systems are chosen to have the requisite solubility in the reaction medium and have an appropriate rate of radical production under the conditions of the polymerisation; these initiating systems can include, but are not limited to, combinations of the following oxidants and reductants:
oxidants: potassium, peroxydisulfate, hydrogen peroxide, t-butyl hydroperoxide. reductants: iron (II), titanium (III), potassium thiosulfate, potassium bisulfite.

Other suitable initiating systems are described in recent texts. See, for example, Moad and Solomon “the Chemistry of Free Radical Polymerisation”, Pergamon, London, 1995, pp 53-95.

Initiators having an appreciable solubility in an aqueous medium include, but are not limited to, 4,4-azobis(cyanovaleric acid), 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis(N,N′-dimethyleneisobutyramidine), 2,2′-azobis(N,N′-dimethyleneiso butyramidine) dihydrochloride, 2,2′-azobis(2-amidinopropane) dihydrochloride, 2,2′-azobis{2-methyl-N-[1,1-bis(hydroxymethyl)-2-ethyl]propionamide}, 2,2′-azobis[2-methyl-N-(2-hydroxyethyl)propionamide], 2,2′-azobis(isobutyramide) dihydrate, and derivatives thereof.

Initiators having an appreciable solubility in a hydrophobic medium include, but are not limited to, azo compounds exemplified by the well known material 2,2′-azobisisobutyronitrile and 2,2′-azobis(2-methylbutyronitrile). Other readily available initiators are acyl peroxides such as acetyl and benzoyl peroxide as well as alkyl peroxides such as cumyl and t-butyl peroxides. Hydroperoxides such as t-butyl and cumyl hydroperoxides may also be used.

Preferred initiators include, but are not limited to, 2,2′-azobisisobutyronitrile and 2,2′-azobis(2-methylbutyronitrile).

The aqueous phase in a given polymerisation process may also contain other additives, for example additives to regulate or adjust pH.

It is preferable that polymerisation of the monomers is maintained under the control of the RAFT agent throughout the entire polymerisation. However, provided that the polymer layer around the aqueous filled void is at least in part formed under the control of a RAFT agent, monomer may also be polymerised by other free radical pathways. Having said this, it will be appreciated that as the amount of monomer polymerised under the control of the RAFT agent decreases, the propensity for irregular growth and the formation of polymer in one reaction site only increases. The amount of monomer that may be polymerised by other free radical pathways in a given reaction sequence will to a large extent depend upon the intended application for the vesiculated polymer particles.

Evidence as to whether the polymerisation reaction has proceeded, at least in part, under the control of a RAFT agent may be obtained by a simple visual assessment (for example by Transmission Electron Microscopy) of the polymer layer formed around the aqueous filled void. Significant loss of “RAFT control” will be characterised by an irregular non-uniform polymer layer, whereas polymerisation under the control of the RAFT agent provides a regular uniform polymer layer.

The composition and architecture of the polymer layer formed around the aqueous filled void may be tailored through the selection and controlled addition of monomer. A wide range of ethylenically unsaturated monomers may be used in accordance with the method. Suitable monomers are those which can be polymerised by a free radical process. The monomers should also be capable of being polymerised with other monomers. The factors which determine copolymerisability of various monomers are well documented in the art. For example, see: Greenlee, R. Z., in Polymer Handbook 3^{rd} Edition (Brandup, J., and Immergut. E. H. Eds) Wiley: New York, 1989 p II/53. Such monomers include those with the general formula (15):

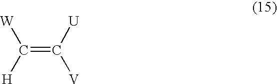

where U and W are independently selected from the group consisting of —CO₂H, —CO₂R², —COR², —CSR², —CSOR²—COSR², —CONH₂, —CONHR², —CONR²₂, hydrogen, halogen and optionally substituted C₁-C₄ allyl wherein the substituents are independently selected from the group consisting of hydroxy, —CO₂H, —CO₂R¹, —COR², —CSR², —CSOR², —COSR², —CN, —CONH₂, —CONHR², —CONR²₂, —OR², —SR², —O₂CR², —SCOR², and —OCSR²; and
V is selected from the group consisting of hydrogen, R², —CO₂H, —CO₂R², —COR², —CSR², —CSOR², —COSR², —CONH₂, —CONHR², —CONR²₂, —OR², —SR², —O₂CR², —SCOR², and —OCSR²;
where R¹ is selected from the group consisting of optionally substituted C₁-C₁₈ alkyl, optionally substituted C₂-C₁₈ alkenyl, optionally substituted aryl, optionally substituted heteroaryl, optionally substituted carbocyclyl, optionally substituted heterocyclyl, optionally substituted aralkyl, optionally substituted heteroarylalkyl, optionally substituted alkaryl, optionally substituted alkylheteroaryl and polymer chains wherein the substituents are independently selected from the group consisting of alkyleneoxidyl (epoxy), hydroxy, alkoxy, acyl, acyloxy, formyl, alkylcarbonyl, carboxy, sulfonic acid, alkoxy- or aryloxy-carbonyl, isocyanato, cyano, silyl, halo, amino, including salts and derivatives thereof. Preferred polymer chains include, but are not limited to, polyalkylene oxide, polyarylene ether and polyalkylene ether.

Examples of such monomers include, but are not limited to, maleic anhydride, N-alkylmaleimide, N-arylmaleimide, dialkyl fumarate and cyclopolymerisable monomers, acrylate and methacrylate esters, acrylic and methacrylic acid, styrene, acrylamide, methacrylamide, and methacrylonitrile, mixtures of these monomers, and mixtures of these monomers with other monomers. As one skilled in the art would recognise, the choice of comonomers is determined by their steric and electronic properties. The factors which determine copolymerisability of various monomers are well documented in the art. For example, see: Greenlee, R Z. in Polymer Handbook 3^{rd} Edition (Brandup, J., and Immergut, E. H Eds.) Wiley: New York. 1989 pII/53.

Specific examples of useful ethylenically unsaturated monomers include the following: methyl methacrylate, ethyl methacrylate, propyl methacrylate (all isomers), butyl methacrylate (all isomers), 2-ethylhexyl methacrylate, isobornyl methacrylate, methacrylic acid, benzyl methacrylate, phenyl methacrylate, methacrylonitrile, alpha-methylstyrene, methyl acrylate, ethyl acrylate, propyl acrylate (all isomers), butyl acrylate (all isomers), 2-ethylhexyl acrylate, isobornyl acrylate, acrylic acid, benzyl acrylate, phenyl acrylate, acrylonitrile, styrene, functional methacrylates, acrylates and styrenes selected from glycidyl methacrylate, 2-hydroxyethyl methacylate, hydroxypropyl methacrylate (all isomers), hydroxybutyl methacrylate (all isomers), N,N-dimethylaminoethyl methacrylate, N,N-diethylaminoethyl methacrylate, triethyleneglycol methacrylate, itaconic anhydride, itaconic acid, glycidyl acrylate, 2-hydroxyethyl acrylate, hydroxypropyl acrylate (all isomers), hydroxybutyl acrylate (all isomers), N,N-dimethylaminoethyl acrylate, N,N-diethylaminoethyl acrylate, triethyleneglycol acrylate, methacrylamide, N-methylacrylamide, N,N-dimethylacrylamide, N-tert-butylmethacrylamide, N-n-butylmethacrylamide, N-methylolmethacrylamide, N-ethylolmethacrylamide, N-tert-butylacrylamide, N-n-butylacrylamide, N-methylolacrylamide, N-ethylolacrylamide, vinyl benzoic acid (all isomers), diethylamino styrene (all isomers), alpha-methylvinyl benzoic acid (all isomers), diethylamino alpha-methylstyrene (all isomers), p-vinylbenzene sulfonic acid, p-vinylbenzene sulfonic sodium salt, trimethoxysilylpropyl methacrylate, triethoxysilylpropyl methacrylate, tributoxysilylpropyl methacrylate, dimethoxymethylsilylpropyl methacrylate, diethoxymethylsilylpropyl methacrylate, dibutoxymethylsilylpropyl methacrylate, diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, trimethoxysilylpropyl acrylate, triethoxysilylpropyl acrylate, tributoxysilylpropylacrylate, dimethoxymethylsilylpropyl acrylate, diethoxymethylsilylpropyl acrylate, dibutoxymethylsilylpropyl acrylate, diisopropoxymethylsilylpropyl acrylate, dimethoxysilylpropyl acrylate, diethoxysilylpropyl acrylate, dibutoxysilylpropyl acrylate, diisopropoxysilylpropyl acrylate, vinyl acetate, vinyl butyrate, vinyl benzoate, vinyl chloride, vinyl fluoride, vinyl bromide, maleic anhydride, N-phenylmaleimide, N-butylmaleimide, N-vinylpyrrolidone, N-vinylcarbazole, butadiene, ethylene and chloroprene. This list is not exhaustive.

Those skilled in the art will appreciate that monomers that are selected to form the polymer layer will strongly influence its glass transition temperature (Tg). The “Tg” is a narrow range of temperature over which an amorphous polymer (or the amorphous regions in a partially crystalline polymer) changes from a relatively hard and brittle state to a relatively viscous or rubbery state. The Tg of the polymer layer can conveniently be tailored to suit the intended application for the vesiculated polymer particles. For example, monomers that are polymerised to form the polymer layer may be selected to provide a Tg that enables the aqueous dispersion of vesiculated polymer particles (as in a paint formulation) to coalesce and form a film.

Tg values referred to herein are calculated, and those relating to a copolymer are calculated in accordance with the Fox equation (1/Tg=Wₐ/Tg₍ₐ₎+W_{b}/Tg_{(b)}+ . . . (where Wₐ is the weight fraction of monomer a, W_{b} is the weight fraction of monomer b . . . )). Unless otherwise stated, where the polymer comprises a mixture of polymers or copolymers having different Tg's, the Tg of the overall polymer layer is calculated as a weighted average value. For example, a polymer layer comprising a copolymer (50 wt. %) with a calculated Fox Tg of −10° C. and a copolymer (50 wt. %) with a calculated Fox Tg of 50° C., will provide an overall Tg of 20° C.

Those skilled in the art will be capable of selecting monomers to afford a polymer with an appropriate Tg for the intended application of the vesiculated polymer particles.

Where the vesiculated polymer particles prepared in accordance with the invention are to be used in contact with solvents in which the polymer layer may be soluble, or for other commercially relevant reasons, it may be desirable to introduce a degree of crosslinking into the polymer layer. This crosslinked polymer structure may be derived by any known means, but it is preferable that it is derived through the use of polymerised ethylenically unsaturated monomers. Those skilled in the art will appreciate that crosslinked polymer structures may be derived in a number of ways through the use of polymerised ethylenically unsaturated monomers. For example, multi-ethylenically unsaturated monomers can afford a crosslinked polymer structure through polymerisation of at least two unsaturated groups to provide a crosslink. In this case, the crosslinked structure is typically derived during polymerisation and provided through a free radical reaction mechanism.

Alternatively, the crosslinked polymer structure may be derived from ethylenically unsaturated monomers which also contain a reactive functional group that is not susceptible to taking part in free radical reactions (i.e. “functionalised” unsaturated monomers). In this case, the monomers are incorporated into the polymer backbone through polymerisation of the unsaturated group, and the resulting pendant functional group provides means through which crosslinking may occur. By utilising monomers that provide complementary pairs of reactive functional groups (i.e. groups that will react with each other), the pairs of reactive functional groups can react through non radical reaction mechanisms to provide crosslinks. Formation of such crosslinks may occur during or after polymerisation of the monomers.

A variation on using complementary pairs of reactive functional groups is where the monomers are provided with non-complementary reactive functional groups. In this case, the functional groups will not react with each other but instead provide sites which can subsequently be reacted with a crosslinking agent to form the crosslinks. It will be appreciated that such crosslinking agents will be used in an amount to react with substantially all of the non-complementary reactive functional groups. Formation of the crosslinks under these circumstances will generally be induced after polymerisation of the monomers.

A combination of these methods of forming a crosslinked polymer structure may be used.

The terms “multi-ethylenically unsaturated monomers” and “functionalised unsaturated monomers” mentioned above can conveniently and collectively also be referred to herein as “crosslinking ethylenically unsaturated monomers” or “crosslinking monomers”. By the general expression “crosslinking ethylenically unsaturated monomers” or “crosslinking monomers” is meant an ethylenically unsaturated monomer through which a crosslink is or will be derived. Accordingly, a multi-ethylenically unsaturated monomer will typically afford a crosslink during polymerisation, whereas a functionalised unsaturated monomer can provide means through which a crosslink can be derived either during or after polymerisation. It will be appreciated that not all unsaturated monomers that contain a functional group will be used in accordance with the invention for the purpose of functioning as a crosslinking monomer. For example, acrylic acid should not be considered as a crosslinking monomer unless it is used to provide a site through which a crosslink is to be derived.

Examples of suitable multi-ethylenically unsaturated monomers that may be selected to provide the crosslinked polymer structure include, but are not limited to, ethylene glycol di(meth)acrylate, triethylene glycol di(meth)acrylate, tetraethylene glycol di(meth)acrylate, 1,3-butylene glycol di(meth)acrylate, trimethylolpropane tri(meth)acrylate, 1,4-butanediol di(meth)acrylate, neopentyl glycol di(meth)acrylate, 1,6-hexanediol di(meth)acrylate, pentaerythritol di(meth)acrylate, pentaerythritol tri(meth)acrylate, pentaerythritol tetra(meth)acrylate, glycerol di(meth)acrylate, glycerol allyloxy di(meth)acrylate, 1,1,1-tris(hydroxymethyl)ethane di(meth)acrylate, 1,1,1-tris(hydroxymethyl)ethane tri(meth)acrylate, 1,1,1-tris(hydroxymethyl)propane di(meth)acrylate, 1,1,1-tris(hydroxymethyl)propane tri(meth)acrylate, triallyl cyanurate, triallyl isocyanurate, triallyl trimellitate, diallyl phthalate, diallyl terephthalate, divinyl benzene, methylol (meth)acrylamide, triallylamine, oleyl maleate, glyceryl propoxy triacrylate, allyl methacrylate, methacrylic anhydride and methylenebis (meth) acrylamide.

Examples of suitable ethylenically unsaturated monomers which contain a reactive functional group that is not susceptible to taking part in free radical reactions include, but are not limited to, acetoacetoxyethyl methacrylate, glycidyl methacrylate, N-methylolacrylamide, (isobutoxymethyl)acrylamide, hydroxyethyl acrylate, t-butyl-carbodiimidoethyl methacrylate, acrylic acid, γ-methacryloxypropyltriisopropoxysilane, 2-isocyanoethyl methacrylate and diacetone acrylamide.

Examples of suitable pairs of monomers mentioned directly above that provide complementary reactive functional groups include N-methylolacrylamide and itself, (isobutoxymethyl)acrylamide and itself, γ-methacryloxypropyltriisopropoxysilane and itself, 2-isocyanoethyl methacrylate and hydroxyethyl acrylate, and t-butyl-carbodiimidoethyl methacrylate and acrylic acid.

Examples of suitable crosslinking agents that can react with the reactive functional groups of one or more of the functionalised unsaturated monomers mentioned above include, but are not limited to, amines such as hexamethylene diamine, ammonia, methyl amine, ethyl amine, Jeffamines™ and diethylene triamine, melamine, trimethylolpropane tris(2-methyl-1-aziridine propionate) and adipic bishydrazide. Examples of pairs of crosslinking agents and functionalised unsaturated monomers that provide complementary reactive groups include hexamethylene diamine and acetoacetoxyethyl methacrylate, amines such as hexamethylene diamine, ammonia, methyl amine, ethyl amine, Jeffamines™ and diethylene triamine and glycidyl methacrylate, melamine and hydroxyethyl acrylate, trimethylolpropane tris(2-methyl-1-aziridine propionate) and acrylic acid, adipic bishydrazide and diacetone acrylamide.

General techniques used in performing conventional emulsion and mini-emulsion polymerizations can advantageously be employed in performing the method of the invention.

The method of the invention will generally be operated in batch, or semi-continuous modes.

A semi-continuous mode of operation may offer superior control of polymer architecture together with control over the polymer polydispersity. According to these modes of operation, monomer may be added gradually or in stages thereby enabling different monomers and other additives to be introduced during the course of the polymerisation reaction. As the solid content of the dispersion increases, the resulting vesiculated polymer particles may not be adequately stabilised. In this case, further RAFT agent may be also added to the reaction with the monomer in order to replenish the surface of the particles with stabilising moieties.

The method of the invention may provide means to tailor the composition of the polymer layer that is formed around the aqueous filled void. In particular, the method provides means to polymerize specific or specialised monomers in strategic locations throughout the polymer. Such control over the polymerisation can be particularly useful in preparing vesiculated polymer particles that are to be used in coating compositions such as paints.

The mode of polymerisation which operates in accordance with the method of the invention also enables the internal composition of the polymer layer formed around the aqueous filled void to be controlled. In particular, the composition of the internal region of the polymer layer can be varied from that of the surface composition to provide an inner sub-layer. In the simplest case, polymer may be formed whereby a specific monomer is polymerised at one stage of the process and a different monomer is polymerised at a later stage to form a block copolymer. In this way, the aqueous filled void may be first encapsulated with a hard polymer and then with a soft film forming exterior layer. Alternatively, the aqueous filled void may be first encapsulated with a soft elastomeric polymer layer and then with a hard non-film forming skin layer.

Conventional vesiculated polymer particles (i.e. those not prepared in accordance with the invention) have generally been used in coating compositions solely as an opacifier. To impart opacity to the dry paint film, vesiculated polymer particles have to date generally had a hard outer shell to avoid collapse of the internal void during film formation. Cross linked polystyrene particles has been used for this purpose. However, such hard shell particles will generally not take part in film formation at ambient temperatures. Vesiculated polymer particles of this type are therefore generally considered by those skilled in the art to be pigment in CPVC calculations.

As with pigment, addition of hard vesiculated polymer particles to a paint formulation will eventually bring the paint film above the CPVC and create air voids external to the vesiculated polymer particles. Above the CPVC, the porosity of the film increases dramatically, and liquids can penetrate quickly into the film surface. Although such paint compositions may provide films with good opacifying properties, due to their porosity the films will generally exhibit poor mechanical properties such scrub resistance and also poor stain resistance properties. Paints that provide films with poor mechanical and stain resistance properties will generally be limited in their ability to be employed in many applications.

In accordance with the invention, vesiculated polymer particles can advantageously be prepared with a film forming exterior polymer layer such that the particles can function as an opacifying polymeric binder. Vesiculated polymer particles of this type can be employed with little if no effect on the CPVC, and can be used to reduce the level of conventional binder or replace it completely.

Providing the vesiculated polymer particles of the invention with film forming exterior polymer layer can advantageously be achieved via several techniques. For example, a soft polymer segment(s) may be incorporated in the RAFT agent (e.g. as part of —(X)ₙ—), a soft polymer segment(s) may be formed during the polymerisation of the one or more ethylenically unsaturated monomers (e.g. via a semicontinuous feed of soft monomer after hard monomer has been polymerised to form a hard inner shell of the vesiculated polymer particles), or soft polymer may be grafted onto the surface of a hard polymer shell of the vesiculated polymer particles.

Film forming vesiculated particles are potentially useful even in circumstances where the size of the void is too small to scatter light on its own. A small void in vesiculated particles can reduce the effective refractive index of a paint film and thereby improve the light scattering efficiency of the primary pigments. Small voided vesiculated particles also occupy volume in the dry film that would otherwise be occupied by more expensive pigments and polymers. Paint derived from dispersions of such particles will have a lower density than conventional paint and occupy the same amount of dry film volume on the wall.

By the terms “hard” and “soft” polymer is meant polymers that are formed from monomers where the homopolymer glass transition temperature (Tg) is above and below room temperature (ie. 25° C.), respectively. Soft polymer will typically be film forming at room temperature whereas hard polymer will not. Suitable hard monomers include, but are not limited to, methyl methacrylate, t-butyl acrylate and methacrylate, and styrene. Suitable soft monomers include, but are not limited to, esters of acrylic acid such as ethyl, butyl and 2-ethyl hexyl acrylates.

Aqueous dispersions of polymer particles are used extensively in waterborne products such as paints, adhesives, fillers, primers, liquid inks and sealants. Such products also typically comprise other formulation components such as pigments, extenders, film forming aids and other additives, all present at different levels and in different combinations. The use of pigments in such products is important not only in providing “hiding” power to the product but also to enable the products to be provided in a variety of colours.

Pigments have traditionally been incorporated in waterborne products by adding the pigments to a preformed aqueous dispersion of polymer particles and dispersing them with the assistance of dispersing agents. Alternatively, pigments are dispersed with the aid of dispersing agents in an initial stage to form what is termed a millbase, and then this millbase is blended with a preformed aqueous dispersion of polymer particles. The dispersion step requires high agitation speeds in order to impart shear on the pigment particles. This dispersion step can sometimes be problematic because conventional aqueous dispersions of polymer particles are not always stable at the levels of shear exerted during pigment dispersion.

In many applications where such pigmented products are used, agglomeration of pigment particles, in the product per se and also during curing of the product, can adversely effect properties such as the products gloss, scrub/stain resistance, flow, mechanical properties, opacity, colour and/or colour strength. Whilst being particularly desirable, reducing or avoiding detrimental agglomeration of pigment particles in such products has to date been difficult to achieve using conventional technology.

The vesiculated polymer particles in accordance with the invention can advantageously function as an opacifier in the aforementioned waterborne products and therefore enable the pigment level of these products to be reduced. By incorporating solid particulate material within the vesiculated polymer particles as hereinbefore described, the vesiculated polymer particles can also be used to minimise, if not eliminate, problems such as pigment agglomeration in such products.

The invention also provides a method of preparing a paint, filler, adhesive, liquid ink, primer, sealant, diagnostic product or therapeutic product comprising preparing an aqueous dispersion of vesiculate polymer particles in accordance with the invention, and combining the dispersion with one or more formulation components.

Those skilled in the art will have an understanding of suitable formulation components that may be included in paints, fillers, adhesives, liquid ink, primers, sealants, diagnostic products or therapeutic products. Examples of such formulation components include, but are not limited to, thickeners, antifungal agents, Uv absorbers, extenders, bioactive reagents, and tinting agents.

The invention further provides a paint, filler, adhesive, primer, sealant, diagnostic product or therapeutic product comprising an aqueous dispersion of vesiculate polymer particles prepared in accordance with the invention.

In selecting a suitable RAFT agent for use in accordance with the invention, the group represented by R¹ in formula (4) may be chosen such that it is either hydrophilic or hydrophobic in character. In some embodiments of the invention R¹ is preferably hydrophilic in character. Due to R¹ being somewhat removed from the thiocarbonylthio group, its role in modifying the reactivity of the RAFT agent becomes limited as n increases. However, it is important that the group —(X)ₙ—R¹ of formula (4), and subsets thereof described herein (i.e. in formulas (5), (5a), and (5b)), is a free radical leaving group that is capable of re-initiating polymerisation.

The selection of Z is typically more important with respect to providing the RAFT agent with the ability to gain control over the polymerisation. In selecting a Z group for compounds of formula (4) it is important that such a group does not provide a leaving group that is a better leaving group in comparison with the —(X)ₙ—R¹, (or subset thereof) group of formula (4). By this limitation, monomer insertion preferentially occurs between —(X)ₙ—R¹ (or subset thereof) and its nearest sulfur atom. This will of course not be relevant if the Z group is also an —(X)ₙ—R¹ group.

RAFT agents of formula (4) may be prepared by a number of methods. Preferably they are prepared by polymerising ethylenically unsaturated monomers under the control of a RAFT agent having the following general formula (11):

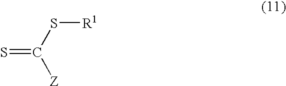

where Z and R¹ are as previously defined.

In preparing surface active RAFT agents of general formula (4) from RAFT agents of general formula (11) it is important to bear in mind that the resulting agent (4) must be capable of forming and stabilising the polymerisable particles as hereinbefore described. Compounds of formula (11) may also have some surface activity, however this will generally not be sufficient to form and stabilise the polymerisable particles. In order to achieve adequate stabilising and polymerisable particle forming properties, with reference to compounds of formula (4), compounds of formula (11) are subsequently reacted with appropriate ethylenically unsaturated monomers.

Ethylenically unsaturated monomers suitable for use in preparing compounds of formula (4) can be any monomer that may be polymerised by a free radical process and include those hereinbefore described. Such monomers are typically chosen for their hydrophilic or hydrophobic qualities.

Examples of hydrophobic ethylenically unsaturated monomers include, but are not limited to, styrene, alpha-methyl styrene, butyl acrylate, butyl methacrylate, amyl methacrylate, hexyl methacrylate, lauryl methacrylate, stearyl methacrylate, ethyl hexyl methacrylate, crotyl methacrylate, cinnamyl methacrylate, oleyl methacrylate, ricinoleyl methacrylate, vinyl butyrate, vinyl tert-butyrate, vinyl stearate and vinyl laurate.

Examples of hydrophilic ethylenically unsaturated monomers include, but are not limited to, acrylic acid, methacrylic acid, hydroxyethyl methacrylate, hydroxypropyl methacrylate, acrylamide and methacrylamide, hydroxyethyl acrylate, N-methylacrylamide or dimethylaminoethyl methacrylate.

The monomers may also be selected for their ionizable or non-ionizable qualities.

By the term “ionizable”, used in connection with ethylenically unsaturated monomers or a group or section of a RAFT agent formed from such monomers, is meant that the monomer, group or section has a functional group which can be ionised to form a cationic or anionic group. Such functional groups will generally be capable of being ionised under acidic or basic conditions through loss or acceptance of a proton. Generally, the ionizable functional groups are acid groups or basic groups. For example, a carboxylic acid functional group may form a carboxylate anion under basic conditions, and an amine functional group may form a quaternary ammonium cation under acidic conditions. The functional groups may also be capable of being ionised through an ion exchange process.

By the term “non-ionizable”, used in connection with ethylenically unsaturated monomers or a group or section of a RAFT agent formed from such monomers, is meant that the monomer, group or section does not have ionizable functional groups. In particular, such monomers, groups or regions do not have acid groups or basic groups which can loose or accept a proton under acidic or basic conditions.

Examples of ionizable ethylenically unsaturated monomers which have acid groups include, but are not limited to, methacrylic acid, acrylic acid, itaconic acid, p-styrene carboxylic acids, p-styrene sulfonic acids, vinyl sulfonic acid, vinyl phosphonic acid, ethacrylic acid, alpha-chloroacrylic acid, crotonic acid, fumaric acid, citraconic acid, mesaconic acid and maleic acid. Examples of ionizable ethylenically unsaturated monomers which have basic groups include, but are not limited to, 2-(dimethyl amino) ethyl and propyl acrylates and methacrylates, and the corresponding 3-(diethylamino) ethyl and propyl acrylates and methacrylates. Examples of non-ionizable hydrophilic ethylenically unsaturated monomers include, but are not limited to, hydroxy ethyl methacrylate, hydroxy propyl methacrylate, and hydroxy ethyl acrylate.

Polymerisation of ethylenically unsaturated monomers to form compounds of formula (4) may be conducted in either an aqueous solution or an organic solvent, the choice of which is dictated primarily by the nature of the monomers to be polymerised. Polymerisation may also be conducted in the monomer itself.

Polymerisation of the monomers to form RAFT agents of formula (4) will usually require initiation from a source of radicals. Initiating systems previously described are also suitable for this purpose.

A method for preparing a RAFT agent of formula (4) (or subsets thereof) wherein R¹ is hydrophilic might, for example, comprise first selecting a suitable RAFT agent. The selected RAFT agent is then combined with a thermal initiator, solvent and hydrophilic monomer within a reaction vessel. Typically all reagents used are essentially free of dissolved oxygen and the reaction solution is purged of any remaining oxygen by way of an inert gas, such as nitrogen, prior to polymerisation. The reaction is subsequently initiated by increasing the temperature of the solution such that thermally induced homolytic scission of the initiator occurs. The polymerisation reaction then proceeds under control of the RAFT agent, thereby providing further hydrophilic character to the hydrophilic end of the RAFT agent through insertion of the hydrophilic monomer. For compounds of formula (5), upon exhaustion of the hydrophilic monomer, hydrophobic monomer may be added to the solution immediately, or at a later stage if the intermediate product is isolated, and the polymerisation continued under RAFT control to provide the desired block copolymer structure.

The effectiveness of a specific compound embraced by formula (11) to prepare RAFT agents of formula (4) will depend on its transfer constant, which is determined by the nature of the R¹ and Z groups, the monomer and the prevailing reaction conditions. These considerations are discussed above in relation to RAFT agents of formula (4). With respect to the RAFT agents of formula (11), such considerations are essentially the same. In particular, as groups R¹ and Z are carried through to the RAFT agent of formula (4), their selection is subject to similar considerations. However, due to closer proximity to the thiocarbonylthio group, the R¹ group plays a significant role in the effectiveness of a specific compound as a RAFT agent.

In selecting both R¹ and Z groups for RAFT agents of formula (II), those agents resulting from the combination of preferred R¹ and Z groups are also preferred.

Most preferred RAFT agents of formula (11) include, but are not limited to, those agents represented by the following general formulas 12 to 16:

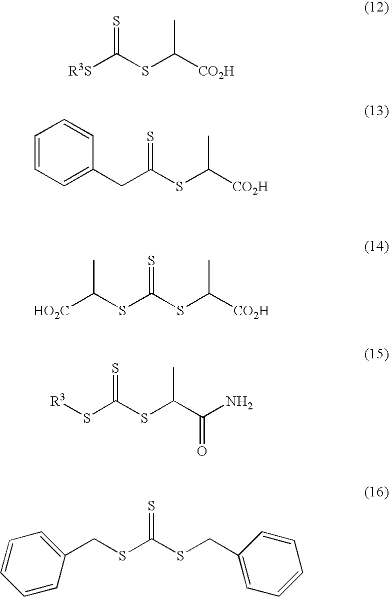

wherein R³ is as previously defined.

When selecting a RAFT agent of formula (11) for use in aqueous environment, it is preferable that it demonstrates hydrolytic stability. Trithiocarbonyl RAFT agents are particularly preferred for use in an aqueous environment.

Where a dithiocarbonyl compound is used as a RAFT agent, it may be a dithioester, a dithiocarbonate, a trithiocarbonate, a dithiocarbamate or the like.

The invention will now be described with reference to the following examples which illustrate some preferred embodiments of the invention. However, it is to be understood that the particularity of the following description is not to supersede the generality of the preceding description of the invention.

### EXAMPLES

### Example 1

### Synthesis of Polymeric Hollow Particles Using Diblock poly(AA-b-BA) of 2-{[(butylsulfanyl)carbonothioyl]sulfanyl}propanoic Acid RAFT Agent

Part 1.1: Preparation of a Diblock poly[(butyl acrylate)ₘ-b-(acrylic acid)ₙ] macro-RAFT Agent with Respective Degrees of Polymerization m≈5 and n≈5, in Dioxane

A solution of 2-{[(butylsulfanyl)carbonothioyl]sulfanyl}propanoic acid (2.0 g, 8.4 mmol), 2,2′-azobisisobutyronitrile (0.118 g, 0.42 mmol), acrylic acid (3.02 g, 42.0 mmol) in dioxane (12.0 g) was prepared in a 50 mL round bottom flask. This was stirred magnetically and sparged with nitrogen for 10 minutes. The flask was then placed in a 60° C. oil bath for 2 hours with constant stirring. To the reacted mixture, butyl acrylate (5.33 g, 42 mmol), 2,2′-azobisisobutyronitrile (0.03 g, 0.12 mmol) and dioxane (4.0 g) were added and again sparged with nitrogen for 10 minutes. The flask was then placed in a 70° C. oil bath for 3 hours with constant stirring. The final copolymer solution had solids of 20.6%. The dioxane was then evaporated in a vacuum oven. The copolymer was dissolved in a 1M NaOH solution (mole ratio 1:2.5 copolymer to NaOH) and then dried to produce a half sodium salt of the synthesised copolymer.

Part (1.2): Synthesis of Polystyrene Hollow Particles Using the macro-RAFT Agent Prepared in Part (1.1), Method 1.

A 5 weight percent solution of macro-RAFT diblock from part (1.1) (0.27 g of the macro-RAFT agent in 5.129 g water) was allowed to self-assemble into a vesicle dispersion. The size of the vesicles within this dispersion can be controlled by passage through a membrane with a chosen pore size. To this dispersion, 0.108 g of styrene monomer in which 0.0197 g of AIBN (0.12 mmol) had been dissolved, was added. The mixture was stirred for an hour and transferred to a 20 mL round bottom flask which was sealed and sparged with nitrogen for 10 minutes. The flask was immersed in an oil bath at 80° C. for 2 hours with constant stirring. To this reaction, 2.4 g of styrene monomer in which 0.0197 g of AIBN was dissolved was added dropwise continuously over 11 hours. The final solution was white and transmission electron microscopy showed that the product consisted of polymeric hollow particles.

Part (1.3): Synthesis of Polystyrene Hollow Particles Using the macro-RAFT Agent Prepared in Part (1.1), Method 2.

A 45 weight percent solution of macro-RAFT diblock from part (1.1) (0.45 g macro-RAFT from part (a) in 0.55 g water) was left to self-assemble into a lamellar phase. To this phase, 0.18 g of styrene monomer in which 0.0197 g of AIBN has been dissolved was added to the mixture and the vial rolled for several hours. The resultant milky solution was a concentrated vesicle dispersion which was diluted with 9 g of water. The size of the vesicles within this dispersion can be controlled by passage through a membrane with a chosen pore size. This solution was transferred to a 20 mL round bottom flask, sparged with nitrogen for 10 minutes and immersed in an oil bath at 80° C. for 2 hours with constant stirring. To this reaction mixture a further 7.4 g of styrene monomer in which 0.04 g of AIBN has been dissolved was added continuously at a rate of 0.2 mL/min. The final solution was white and transmission electron microscopy showed that the product consisted of polymeric hollow particles.

Part (1.4): Preparation of a diblock poly[(butyl acrylate)ₘ-b-(acrylic acid)ₙ] macro-RAFT Agent with Respective Degrees of Polymerization m≈5 and n≈10, in Dioxane

A solution of 2-{[(butylsulfanyl)carbonothioyl]sulfanyl}propanoic acid (2.0 g, 8.4 mmol), 2,2′-azobisisobutyronitrile (0.118 g, 0.42 mmol), acrylic acid (3.02 g, 42.0 mmol) in dioxane (12.0 g) was prepared in a 50 mL round bottom flask. This was stirred magnetically and sparged with nitrogen for 10 minutes. The flask was then placed in a 60° C. oil bath for 2 hours with constant stirring. To the reacted mixture, butyl acrylate (10.75 g, 83 mmol), 2,2′-azobisisobutyronitrile (0.03 g, 0.12 mmol) and dioxane (4.0 g) were added and again sparged with nitrogen for 10 minutes. The flask was then placed in a 70° C. oil bath for 3 hours with constant stirring. The final copolymer solution had solids of 33.96%. The dioxane was then evaporated in a vacuum oven. The copolymer was dissolved in a 1M NaOH solution (mole ratio 1:2.5 copolymer to NaOH) and then dried to produce the half sodium salt of the synthesised copolymer.

Part (1.5): Synthesis of Polystyrene Hollow Particles Using the macro-RAFT Agent Prepared in Part (1.4), Method 1

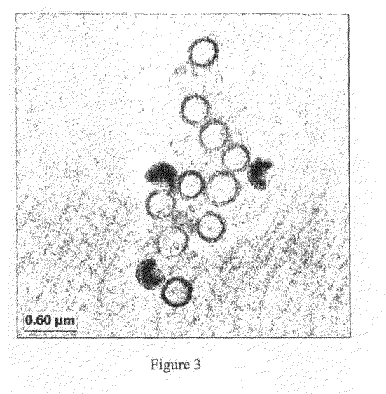

A 5 weight percent solution of macro-RAFT diblock from part (1.4) (0.26 g macro-RAFT diblock in 4.8963 g water) was left to self-assemble into a vesicle dispersion. The size of the vesicles within this dispersion can be controlled by passage through a membrane with a chosen pore size. To this dispersion, styrene monomer (0.052 g) in which AIBN (0.0123 g, 0.075 mmol) had been dissolved, was added. The mixture was stirred for an hour and transferred to a 20 mL round bottom flask which was sealed and sparged with nitrogen for 10 minutes. The flask was immersed in an oil bath at 80° C. for 2 hours with constant stirring. To this reaction, styrene monomer (3.2 g) in which AIBN (0.0198 g) was dissolved was added dropwise continuously over 11 hours. The final polymeric dispersion was white and transmission electron microscopy showed that the product consisted of polymeric hollow particles. (See FIG. 3)

Part (1.6): Synthesis of Polystyrene Hollow Particles Using the macro-RAFT Agent Prepared in Part (1.4), Method 2

A 25 weight percent solution of macro-RAFT diblock from part (1.4) (0.32 g macro-RAFT diblock in 0.97 g water) was left to self-assemble into a lamellar phase. To this phase, styrene monomer (0.145 g) in which AIBN (0.0050 g) had been dissolved was added to the mixture and the vial rolled for several hours. The resultant milky solution was a concentrated vesicle dispersion which was diluted with 14 mL of water. The size of the vesicles within this dispersion can be controlled by passage through a membrane with a chosen pore size. This solution was transferred to a 20 mL round bottom flask, sparged with nitrogen for 10 minutes and immersed in an oil bath at 80° C. for 2 hours with constant stirring. To this reaction styrene monomer (4.4 g) in which AIBN (0.04 g) had been dissolved was added continuously at a rate of 0.2 mL/min. The final solution was white and transmission electron microscopy showed that the product consisted of polymeric hollow particles.

### Example 2

### Synthesis of Polymeric Hollow Particles Using Random poly(AA-co-BA) of 2-{[(butylsulfanyl)carbonothioyl]sulfanyl}propanoic Acid RAFT Agent

Part (2.1): Preparation of a random poly[(butyl acrylate)ₘ-co-(acrylic acid)ₙ] macro-RAFT Agent with Respective Degrees of Polymerization m≈50 and n≈20, in Dioxane

A solution of 2-{[(butylsulfanyl)carbonothioyl]sulfanyl}propanoic acid (0.50 g, 2.10 mmol), 2,2′-azobisisobutyronitrile (0.036 g, 0.22 mmol), acrylic acid (3.03 g, 42.10 mmol), butyl acrylate (13.70 g, 106.90 mmol) in dioxane (25.66 g) was prepared in a 50 mL round bottom flask. This was stirred magnetically and sparged with nitrogen for 10 minutes. The flask was then placed in a 70° C. oil bath for 2 hours with constant stirring. The final copolymer solution had solids of 39.7%. The dioxane was then evaporated off under a stream of nitrogen.

Part (2.2): Synthesis of Polystyrene Hollow Particles Using the macro-RAFT Agent Prepared in Part (2.1) as a Sole Stabilizer.

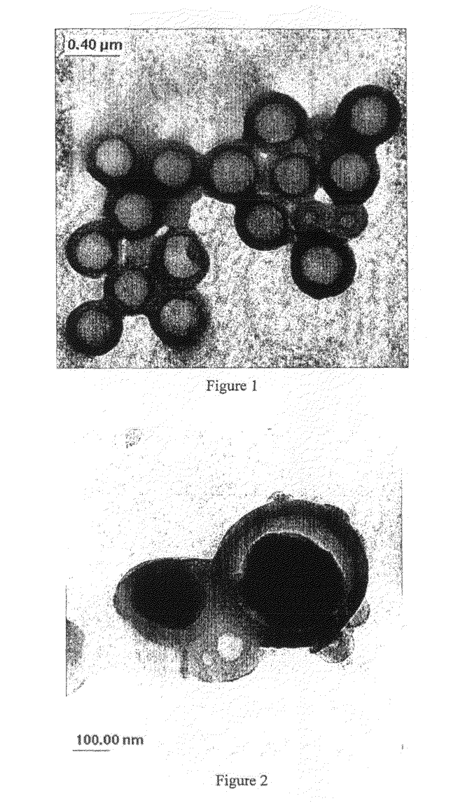

A solution of styrene (10.56 g, 101.54 mmol), 2,2′-azobisisobutyronitrile (0.041 g, 0.25 mmol) and macro-RAFT random copolymer from part (2.1) (0.66 g, 0.08 mmol) was prepared in a 50 mL beaker. To this solution, 2 g of sodium hydroxide solution (0.07 g of sodium hydroxide in 22.04 g of water) was added in drop wise while the solution was stirred on a magnetic stirrer at a speed setting of 0.6 (IKA model RCT, 1.5 cm spin bar) for 20 minutes to produce a cloudy water in oil emulsion. To this emulsion, the rest of the sodium hydroxide solution was added dropwise with constant stirring to yield a white oil in water emulsion, with targeted final solids of 38%. The emulsion was transferred to a 50 mL round bottom flask which was sealed and subsequently immersed in an oil bath with a temperature setting of 80° C., which temperature was maintained for 2 hours, with constant magnetic stirring. Transmission electron microscopy showed that the latex contained polymeric hollow particles. (See FIG. 1).

### Example 3

### Synthesis of Polymeric Hollow Particles Using Random poly(DMAEMA-co-BA) of 2-{[(butylsulfanyl)carbonothioyl]sulfanyl}propanoic Acid RAFT Agent

Part (3.1): Preparation of a random poly[(butyl acrylate)ₘ-co-(dimethylamino ethyl methacrylate)ₙ] macro-RAFT agent with respective degrees of polymerization m≈60 and n≈30

A solution of 2-{[(butylsulfanyl)carbonothioyl]sulfanyl}propanoic acid (0.19 g, 0.79 mmol), 2,2′-azobisisobutyronitrile (0.01 g, 0.08 mmol), dimethylamino ethyl methacrylate (3.73 g, 23.74 mmol), butyl acrylate (6.09 g, 47.50 mmol) in dioxane (10.08 g) was prepared in a 25 mL round bottom flask. This was stirred magnetically and sparged with nitrogen for 10 minutes. The flask was then maintained at 70° C. and maintained at that temperature for at least 8 hours with constant stirring. The final copolymer solution had 44.6% solids.

Part (3.2): Synthesis of Polystyrene Hollow Particles Using the macro-RAFT Agent Prepared in Part (3.1) as a Sole Stabilizer

A solution of styrene (5.94 g, 57.04 mmol), 2,2′-azobisisobutyronitrile (0.04 g, 0.24 mmol) and macro-RAFT solution from part (3.1) (1.24 g, 0.05 mmol) was prepared in a 50 mL round bottom flask. To this solution, hydrochloric acid solution (HCl 32% 0.16 g, water 14.58 g) was added in drop wise while the oil solution was stirred at 8/10 speed using a magnetic stirrer (Labortechnik, IKA), magnetic bar 1.5 cm long, to produce a white emulsion. The flask was sealed and subsequently deoxygenated with nitrogen sparging for 10 minutes. The whole flask was immersed in an oil bath with a temperature setting of 80° C. and maintained at that temperature for 3 hours under constant magnetic stirring at a setting of 8/10. Transmission electron microscopy showed that the latex contained polymeric hollow particles.

### Example 4

### Synthesis of Polymeric Hollow Particles Using poly[(AA-co-BA)-b-(styrene)] diblock of 2-{[(butylsulfanyl)carbonothioyl]sulfanyl}propanoic Acid RAFT Agent

Part (4.1): Preparation of a poly{[(butyl acrylate)ₘ-co-(acrylic acid)ₙ]-block-(styrene)ₜ} macro-RAFT Agent with Respective Degrees of Polymerization m≈60, n≈30 and t≈30, in Dioxane

A solution of 2-{[(butylsulfanyl)carbonothioyl]sulfanyl}propanoic acid (0.18 g, 0.8 mmol), 2,2′-azobisisobutyronitrile (0.03 g, 0.2 mmol), acrylic acid (1.64 g, 22.8 mmol), butyl acrylate (5.86 g, 45.7 mmol) in dioxane (15.02 g) was prepared in a 100 mL round bottom flask. This was stirred magnetically and sparged with nitrogen for 10 minutes. The flask was then maintained at 70° C. for 2 hours 30 minutes under constant stirring. At the end of the heating, styrene (2.38 g, 22.9 mmol) and 2,2′-azobisisobutyronitrile (0.03 g, 0.2 mmol) was added to the polymer solution. The flask was sealed, deoxygenated with nitrogen for 10 minutes and then maintained at 70° C. for another 12 hours under constant stirring. The final copolymer solution had 39.7% solids.

Part (4.2): Synthesis of Polystyrene Hollow Particles Using the macro-RAFT Agent Prepared in Part (4.1) as a Sole Stabilizer

A solution of styrene (25.21 g, 242.1 mmol), 2,2′-azobisisobutyronitrile (0.26 g, 1.6 mmol) and macro-RAFT solution from part (4.1) (7.50 g, 0.2 mmol) was prepared in a 100 mL beaker. To this solution, ammonium hydroxide (1.62 g, 28%) was added in drop wise while the solution was stirred at 1000 rpm using an overhead mixer (Labortechnik, IKA) to produce a cloudy water in oil emulsion. To this emulsion, water (5 g) was added drop by drop under constant stirring to yield a viscous white water in oil emulsion. A further 53 g water was slowly poured into beaker while the stirring was maintained to produce a viscous white oil in water emulsion. The emulsion was transferred to a 100 mL round bottom flask which was sealed and subsequently deoxygenated by nitrogen sparging. The whole flask was immersed in an oil bath with a temperature setting of 80° C., which temperature was maintained for 2 hours with constant magnetic stirring. The final latex was white and stable, containing particles about 444 nm in diameter (HPPS, Malvern Instruments Ltd). It had a solids content of 30.5%. Transmission electron microscopy showed that the latex contained polymeric hollow particles.

Part (4.3): Encapsulation of Titanium Dioxide TiO₂ Pigment (TR92, Huntsman Corporation) in Polystyrene Hollow Particles Using the macro-RAFT Agent Prepared in Part (4.1) as a Sole Stabilizer

A solution of styrene (20.56 g, 197.4 mmol) and macro-RAFT solution from part (4.1) (7.53 g, 0.2 mmol) was prepared in a 100 mL beaker. To this solution, ammonium hydroxide (1.70 g, 28%) was added drop wise while the solution was stirred at 1000 rpm using an overhead mixer (Labortechnik, IKA) to produce a cloudy water in oil emulsion.

To this emulsion, TiO₂ pigment (10.57 g) was added, mixed and was further thoroughly dispersed using a Vibra-Cell Ultrasonic Processor (Sonics and Materials, Inc.) standard probe at 30% amplitude for 1 minute. During the sonication process, the dispersion was stirred magnetically and cooled in a water bath. At the end of sonication, 2,2′-azobisisobutyronitrile (0.20 g, 1.2 mmol) was mixed with the dispersion followed by a slow addition of water (52.87 g) under constant stirring to yield a viscous white emulsion. The emulsion was transferred to a 100 mL round bottom flask which was sealed and deoxygenated by nitrogen sparging. The whole flask was immersed in an oil bath with a temperature setting of 80° C., which temperature was maintained for 3 hours with constant magnetic stirring. The final latex was white and stable, containing particles about 414 nm in diameter (HPPS, Malvern Instruments Ltd). It had 36.3% solids. Transmission electron microscopy showed that the latex contained both encapsulated titanium dioxide and polymeric hollow particles. (See FIG. 2)

Part (4.4): Preparation of a poly{[(butyl acrylate)ₘ-co-(acrylic acid)ₙ]-block-(styrene)ₜ} macro-RAFT agent with Respective Degrees of Polymerization m≈100, n≈50 and t≈50, in Dioxane

A solution of 2-{[(butylsulfanyl)carbonothioyl]sulfanyl}propanoic acid (0.22 g, 0.9 mmol), 2,2′-azobisisobutyronitrile (0.03 g, 0.2 mmol), acrylic acid (3.30 g, 45.8 mmol), butyl acrylate (11.80 g, 92.0 mmol) in dioxane (24.76 g) was prepared in a 100 mL round bottom flask. This was stirred magnetically and sparged with nitrogen for 10 minutes. The flask was then maintained at 70° C. and maintained at that temperature for 2 hours 30 minutes with constant stirring. At the end of this period, styrene (4.77 g, 45.8 mmol) and 2,2′-azobisisobutyronitrile (0.03 g, 0.2 mmol) was added to the polymer solution. The flask was sealed, sparged with nitrogen for 10 minutes and then maintained at 70° C. for another 12 hours under constant stirring. The final copolymer solution had 39.4% solids.

Part (4.5): Synthesis of Polystyrene Hollow Particles Using the macro-RAFT Agent Prepared in Part (4.4) as a Sole Stabilizer

A solution containing the macro-RAFT solution from part (4.4) (6.14 g, 0.1 mmol), water (4.06 g) and ammonia (1.60 g, 28%) was prepared in a 100 mL beaker. This solution was added in drop wise to styrene (16.19 g, 155.5 mmol) containing 2,2′-azobisisobutyronitrile (0.26 g, 1.6 mmol) while it was stirred at 1000 rpm using an overhead mixer (Labortechnik, IKA) to produce a cloudy water in oil emulsion. To this emulsion, water (42.34 g) was slowly poured under constant stirring to yield a viscous white oil in water emulsion. The emulsion was transferred to a 100 mL round bottom flask which was sealed and subsequently deoxygenated by nitrogen sparging. The whole flask was immersed in an oil bath with a temperature setting of 80° C. for 2 hours under constant magnetic stirring. The final latex was white and stable, containing particles about 475 nm in diameter (HPPS, Malvern Instruments Ltd). The latex had final solids of 26.0%. Transmission electron microscopy showed that the latex contained polymeric hollow particles.

### Example 5

### Synthesis of Polymeric Hollow Particles Using Random Copolymer (AA-co-BA) of 2-{[(dodecylsulfanyl)carbonothioyl]sulfanyl}propanoic RAFT Agent

Part (5.1): Preparation of a Random poly[(butyl acrylate)ₘ-co-(acrylic acid)ₙ] macro-RAFT Agent with Respective Degrees of Polymerization m≈60 and n≈30, in Dioxane

A solution of 2-{[(dodecylsulfanyl)carbonothioyl]sulfanyl}propanoic acid (1.01 g, 2.87 mmol), 2,2′-azobisisobutyronitrile (0.06 g, 0.37 mmol), acrylic acid (6.21 g, 86.12 mmol), butyl acrylate (22.01 g, 171.73 mmol) in dioxane (43.53 g) was prepared in a 100 mL round bottom flask. This was stirred magnetically and sparged with nitrogen for 15 minutes. The flask was then maintained at 70° C. for overnight under constant stirring. The final copolymer solution had 40.2% solids. The dioxane was then evaporated off under a stream of nitrogen.

Part (5.2): Synthesis of Polystyrene Hollow Particles Using the macro-RAFT Agent Prepared in Part (5.1) as a Sole Stabilizer

An oil solution of styrene (6.52 g, 62.56 mmol), 2,2′-azobisisobutyronitrile (0.05 g, 0.28 mmol) was prepared in a 100 mL round bottom flask. To this oil solution, 6.03 g of macro-RAFT solution of the random copolymer from part (5.1) (0.53 g, 0.05 mmol), sodium hydroxide (0.06 g, 1.57 mmol) and water (16.18 g) was added in drop wise while the oil solution was stirred on a magnetic stirrer at a speed setting of 0.7 (IKA model RCT, 1.5 cm spin bar) for 90 minutes to produce a cloudy emulsion. To this emulsion, the rest of the macro-RAFT solution was added dropwise with constant stirring to yield an oil in water emulsion, with targeted final solids of 30%. The round bottom flask was sealed and immersed in an oil bath with a temperature setting of 80° C., which temperature was maintained for 2 hours with constant magnetic stirring. 20.44 g water was added to the round bottom flask after 1 hour of reaction, to have final solids of 16.4%. Transmission electron microscopy showed that the latex contained polymeric hollow particles.

Part (5.3): Preparation of a random poly[(butyl acrylate)ₘ-co-(acrylic acid)ₙ] macro-RAFT Agent with Respective Degrees of Polymerization m≈100 and n≈50, in Dioxane

A solution of 2-{[(dodecylsulfanyl)carbonothioyl]sulfanyl}propanoic acid (0.40 g, 1.14 mmol), 2,2′-azobisisobutyronitrile (0.06 g, 0.37 mmol), acrylic acid (4.13 g, 57.28 mmol), butyl acrylate (14.65 g, 114.32 mmol) in dioxane (28.00 g) was prepared in a 50 mL round bottom flask. This was stirred magnetically and sparged with nitrogen for 15 minutes. The flask was then maintained at 70° C. for overnight under constant stirring. The final copolymer solution had 40.7% solids.

Part (5.4): Synthesis of Polystyrene Hollow Particles Using the macro-RAFT Agent Prepared in Part (5.3) as a Sole Stabilizer

An oil solution of styrene (6.56 g, 62.97 mmol), 2,2′-azobisisobutyronitrile (0.04 g, 0.26 mmol) was prepared in a 100 mL round bottom flask. To this oil solution, 7.67 g of macro-RAFT solution of the random copolymer from part (5.3) (1.74 g, 0.04 mmol), sodium hydroxide (0.09 g, 2.18 mmol) and water (15.69 g) was added in drop wise while the oil solution was stirred on a magnetic stirrer at a speed setting of 0.8 (IKA model RCT, 1.5 cm spin bar) for 60 minutes to produce a cloudy emulsion. To this emulsion, the rest of the macro-RAFT solution was added dropwise with constant stirring to yield an oil in water emulsion, with targeted final solids of 30.7%. The emulsion was stirred overnight. The round bottom flask was then sealed, sparged with nitrogen for 10 minutes and immersed in an oil bath with a temperature setting of 80° C., which temperature was maintained for 2 hours and 50 minutes with constant magnetic stirring. 10.26 g and 5.07 g water was added to the round bottom flask after 30 minutes and 80 minutes of reaction, respectively, to have final solids of 18.7%. Transmission electron microscopy showed that the latex contained polymeric hollow particles.

### Example 6

### Synthesis of Polymeric Hollow Particles Using Diblock poly[(AA-co-BA)-b-(styrene)] of 2-{[(dodecylsulfanyl)carbonothioyl]sulfanyl}propanoic Acid RAFT Agent

Part (6.1): Preparation of a poly{[(butyl acrylate)ₘ-co-(acrylic acid)ₙ]-block-(styrene)ₜ} macro-RAFT Agent with Respective Degrees of Polymerization m≈100, n≈50 and t≈30

A solution of 2-{[(dodecylsulfanyl)carbonothioyl]sulfanyl}propanoic acid (0.26 g, 0.74 mmol), 2,2′-azobisisobutyronitrile (0.05 g, 0.31 mmol), styrene (2.28 g, 21.93 mmol) in dioxane (15.02 g) was prepared in a 50 mL round bottom flask. This was stirred magnetically and sparged with nitrogen for 10 minutes. The flask was then maintained at 70° C. for at least 6 hours under constant stirring. At the end of the heating period, butyl acrylate (9.51 g, 74.16 mmol), acrylic acid (2.68 g, 37.23 mmol) 2,2′-azobisisobutyronitrile (0.07 g, 0.42 mmol) and dioxane (15.01 g) was added to the polymer solution. The flask was sealed, deoxygenated with nitrogen for 10 minutes and then maintained at 70° C. overnight under constant stirring. The final copolymer solution had 41% solids.

Part (6.2): Synthesis of Polystyrene Hollow Particles Using The macro-RAFT Agent Prepared in Part (6.1) as a Sole Stabilizer

A solution of styrene (18.68 g, 179.35 mmol), 2,2′-azobisisobutyronitrile (0.10 g, 0.61 mmol) and macro-RAFT solution from part (6.1) (5.77 g, 0.12 mmol) was prepared in a 100 mL round bottom flask. To this solution, sodium hydroxide solution (NaOH 0.22 g, water 44.13 g) was added in drop wise while the solution was stirred at 400 rpm using an overhead mixer (Labortechnik, IKA) to produce an emulsion. The round bottom flask was then sealed and subsequently deoxygenated by nitrogen sparging for 10 minutes. The whole flask was immersed in an oil bath with a temperature setting of 80° C., which temperature was maintained for 2 hours with constant magnetic stirring. Transmission electron microscopy showed that the final latex contained polymeric hollow particles.

Part (6.3): Preparation of a poly{[(butyl acrylate)ₘ-co-(acrylic acid)ₙ]-block-(styrene)ₜ} macro-RAFT Agent with Respective Degrees of Polymerization m≈100, n≈50 and t≈50, in Dioxane

A solution of 2-{[(dodecylsulfanyl)carbonothioyl]sulfanyl}propanoic acid (0.40 g, 1.14 mmol), 2,2′-azobisisobutyronitrile (0.04 g, 0.22 mmol), acrylic acid (4.16 g, 57.73 mmol), butyl acrylate (14.65 g, 114.34 mmol) in dioxane (26.07 g) was prepared in a 50 mL round bottom flask. This was stirred magnetically and sparged with nitrogen for 5 minutes. The flask was then maintained at 70° C. for 6 hours under constant stirring. At the end of the heating, to 25.01 g of the polymer solution, styrene (3.35 g, 32.20 mmol), 2,2′-azobisisobutyronitrile (0.03 g, 0.16 mmol) and dioxane (6.53 g) was added. The flask was sealed, deoxygenated with nitrogen for 5 minutes and then maintained at 70° C. for overnight under constant stirring. The final copolymer solution had 40.1% solids.

Part (6.4): Synthesis of Polystyrene Hollow Particles Using the macro-RAFT Agent Prepared in Part (6.3) as a Sole Stabilizer

An oil solution of styrene (16.17 g, 155.24 mmol), 2,2′-azobisisobutyronitrile (0.26 g, 1.60 mmol) and macro-RAFT solution from part (6.3) (5.71 g, 0.10 mmol) was prepared in a 100 mL beaker. To this solution, ammonium hydroxide (1.63 g, 28%) in extra amount of water (4.63 g) was added in drop wise while the solution was stirred at 1000 rpm using an overhead mixer (Labortechnik, IKA) to produce a viscous and white emulsion. To this emulsion, further 41.92 g water was slowly poured into beaker while the stirring was maintained to produce a stable white oil in water emulsion. The emulsion was transferred to a 100 mL round bottom flask which was sealed deoxygenated with nitrogen for 10 minutes and then immersed in an oil bath with a temperature setting of 80° C., which temperature was maintained for 2 hours with constant magnetic stirring. Transmission electron microscopy showed that the final latex contained polymeric hollow particles.

Part (6.5): Preparation of a poly{[(butyl acrylate)ₘ-co-(acrylic acid)ₙ]-block-(styrene)ₜ} macro-RAFT Agent with Respective Degrees of Polymerization m≈60, n≈30 and t≈30, in Dioxane

A solution of 2-{[(dodecylsulfanyl)carbonothioyl]sulfanyl}propanoic acid (0.50 g, 1.43 mmol), 2,2′-azobisisobutyronitrile (0.05 g, 0.27 mmol), acrylic acid (3.11 g, 43.19 mmol), butyl acrylate (11.05 g, 86.22 mmol) in dioxane (20.13 g) was prepared in a 50 mL round bottom flask. This was stirred magnetically and sparged with nitrogen for 5 minutes. The flask was then maintained at 70° C. for 6 hours under constant stirring. At the end of the heating, to 20.00 g of the polymer solution, styrene (2.60 g, 24.96 mmol), 2,2′-azobisisobutyronitrile (0.02 g, 0.12 mmol) and dioxane (5.01 g) was added. The flask was sealed, deoxygenated with nitrogen for 5 minutes and then maintained at 70° C. for overnight under constant stirring. The final copolymer solution had 40.1% solids.

Part (6.6): Synthesis of Polystyrene Hollow Particles Using the macro-RAFT Agent Prepared in Part (6.5) as a Sole Stabilizer

An oil solution of styrene (14.83 g, 142.35 mmol), 2,2′-azobisisobutyronitrile (0.22 g, 1.35 mmol) and macro-RAFT solution from part (6.5) (3.01 g, 0.09 mmol) was prepared in a 100 mL beaker. To this solution, ammonium hydroxide (1.41 g, 28%) in extra amount of water (4.71 g) was added in drop wise while the solution was stirred at 900 rpm using an overhead mixer (Labortechnik, IKA) to produce a viscous and white emulsion. To this emulsion, further 35.11 g water was slowly poured into beaker while the stirring was maintained to produce a white oil in water emulsion. The emulsion was transferred to a 100 mL round bottom flask which was sealed and immersed in an oil bath with a temperature setting of 80° C., which temperature was maintained for 2 hours with constant magnetic stirring. Transmission electron microscopy showed that the final latex contained polymeric hollow particles.

### Example 7

### Synthesis of Polymeric Hollow Particles Using Diblock poly[(AA-co-BA)-b-(styrene)] of 2,2′-(carbonothioyldisulfanediyl)dipropanoic Acid(diPAT) RAFT Agent

Part (7.1): Preparation of a poly{[(butyl acrylate)ₘ-co-(acrylic acid)ₙ]-block-(styrene)ₜ} macro-RAFT Agent with Respective Degrees of Polymerization m≈120, n≈60 and t≈60, in Dioxane

A solution of 2,2′-(carbonothioyldisulfanediyl)dipropanoic acid (0.20 g, 0.80 mmol), 2,2′-azobisisobutyronitrile (0.03 g, 0.17 mmol), acrylic acid (3.41 g, 47.25 mmol), butyl acrylate (12.15 g, 94.80 mmol) in dioxane (23.08 g) was prepared in a 100 mL round bottom flask. This was stirred magnetically and sparged with nitrogen for 5 minutes. The flask was then maintained at 70° C. for 3 hours under constant stirring. At the end of the heating, styrene (5.00 g, 47.99 mmol), 2,2′-azobisisobutyronitrile (0.03 g, 0.18 mmol) and dioxane (9.16 g) was added to the copolymer solution. The flask was sealed, deoxygenated with nitrogen for 10 minutes and then maintained at 70° C. for overnight under constant stirring. The final copolymer solution had 39.2% solids.

Part (7.2): Synthesis of Polystyrene Hollow Particles Using the macro-RAFT Agent Prepared in Part (7.1) as a Sole Stabilizer

An oil solution of styrene (11.32 g, 108.72 mmol), 2,2′-azobisisobutyronitrile (0.10 g, 0.59 mmol) and macro-RAFT solution from part (7.1) (6.03 g, 0.09 mmol) was prepared in a 100 mL beaker. To this solution, sodium hydroxide solution (0.22 g NaOH in 5.01 g water) was added in drop wise while the oil solution was stirred at 1000 rpm using an overhead mixer (Labortechnik, IKA) to produce a stable emulsion. To this emulsion, further 30.16 g water was added slowly into the beaker while the stirring was maintained to produce a white oil in water emulsion, to have a final solid of 26.5%. The emulsion was transferred to a 100 mL round bottom flask which was sealed and immersed in an oil bath with a temperature setting of 80° C., which temperature was maintained for 2 hours and 30 minutes with constant magnetic stirring. After 1 hour of reaction, 23.76 g water was added to the reactor to reduce a very high viscosity of the forming latex, to have a final solid of 18.3%. Transmission electron microscopy showed that the final latex contained polymeric hollow particles.

Part (7.3): Synthesis of Polystyrene Hollow Particles Using the macro-RAFT Agent Prepared in Part (7.1) as a Sole Stabilizer

An oil solution of styrene (23.58 g, 226.37 mmol), 2,2′-azobisisobutyronitrile (0.19 g, 1.11 mmol) and macro-RAFT solution from part (7.1) (10.01 g, 0.15 mmol) was prepared in a 250 mL beaker. To this solution, sodium hydroxide solution (0.37 g NaOH in 10.00 g water) was added in drop wise while the oil solution was stirred at 1000 rpm using an overhead mixer (Labortechnik, IKA) to produce a viscous emulsion. To this emulsion, further 60.41 g water was slowly added into beaker while the stirring was maintained to produce a white stable oil in water emulsion, to have a final solid of 26.8%. The emulsion was transferred to a 250 mL round bottom flask which was sealed, deoxygenated with nitrogen for 10 minutes and then immersed in an oil bath with a temperature setting of 80° C., which temperature was maintained for at least 2 hours with constant magnetic stirring. Transmission electron microscopy showed that the final latex contained polymeric hollow particles, whose sizes were bigger than those obtained in Part (b).

Part (7.4): Synthesis of Polystyrene Hollow Particles Using the macro-RAFT Agent Prepared in Part (a) as a Sole Stabilizer

An oil solution of styrene (42.27 g, 405.85 mmol), 2,2′-azobisisobutyronitrile (0.34 g, 2.07 mmol) and macro-RAFT solution from part (7.1) (15.03 g, 0.23 mmol) was prepared in a 250 mL beaker. To this solution, sodium hydroxide solution (0.55 g NaOH in 15.05 g water) was added in drop wise while the solution was stirred at 1000 rpm using an overhead mixer (Labortechnik, IKA) to produce a viscous and white emulsion. To this emulsion, further 115.10 g water was slowly added into the beaker while the stirring was maintained to produce a stable white oil in water emulsion. The emulsion was transferred to a 500 mL round bottom flask which was sealed, deoxygenated with nitrogen for 10 minutes and then immersed in an oil bath with a temperature setting of 80° C., which temperature was maintained for 3 hours with constant magnetic stirring. divinyl benzene (4 g) was then fed to the latex, using a syringe pump over the course of 2 hours, and cooked for further 1 hour at 80° C. Transmission electron microscopy showed that the final latex contained polymeric hollow particles.

### Example 8

### Synthesis of Polymeric Hollow Particles Using Diblock poly[(AA-co-BA)-b-(styrene)] of Dibenzyl Trithiocarbonate (diBent) RAFT Agent

Part 8.1: Preparation of a poly{[(butyl acrylate)ₘ-co-(acrylic acid)ₙ]-block-(styrene)ₜ} macro-RAFT Agent with Respective Degrees of Polymerization m≈120, n≈40 and t≈80, in Dioxane

A solution of dibenzyl trithiocarbonate (0.21 g, 0.72 mmol), 2,2′-azobisisobutyronitrile (0.02 g, 0.14 mmol), acrylic acid (2.01 g, 27.92 mmol), butyl acrylate (10.60 g, 82.74 mmol) in dioxane (19.00 g) was prepared in a 100 mL round bottom flask. This was stirred magnetically and sparged with nitrogen for 5 minutes. The flask was then maintained at 70° C. for 3 hours under constant stirring. At the end of the heating, styrene (5.75 g, 55.21 mmol), 2,2′-azobisisobutyronitrile (0.02 g, 0.15 mmol) and dioxane (6.96 g) was added to the copolymer solution. The flask was sealed, deoxygenated with nitrogen for 5 minutes and then maintained at 70° C. for overnight under constant stirring. The final copolymer solution had 41.7% solids.

Part 8.2: Synthesis of Polystyrene Hollow Particles Using the macro-RAFT Agent Prepared in Part (a) as a Sole Stabilizer

An oil solution of styrene (11.11 g, 106.64 mmol), 2,2′-azobisisobutyronitrile (0.09 g, 0.53 mmol) and macro-RAFT solution from part (8.1) (5.51 g, 0.09 mmol) was prepared in a 100 mL beaker. To this solution, sodium hydroxide solution (0.18 g NaOH in 5.11 g water) was added in drop wise while the solution was stirred at 1000 rpm using an overhead mixer (Labortechnik, IKA) to produce a viscous and white emulsion. To this emulsion, further 30.28 g water was slowly poured into the beaker while the stirring was maintained to produce a stable white oil in water emulsion, to have a final solid of 26.2%. The emulsion was transferred to a 100 mL round bottom flask which was sealed, deoxygenated for 10 minutes and then immersed in an oil bath with a temperature setting of 80° C., which temperature was maintained for 3 hours with constant magnetic stirring. Transmission electron microscopy showed that the final latex contained polymeric hollow particles.

Part 8.3: Synthesis of Polystyrene Hollow Particles Using the macro-RAFT Agent Prepared in Part (8.1) as a Sole Stabilizer

An oil solution of styrene (12.94 g, 124.23 mmol), 2,2′-azobisisobutyronitrile (0.11 g, 0.65 mmol) and macro-RAFT solution from part (8.1) (5.00 g, 0.08 mmol) was prepared in a 100 mL beaker. To this solution, sodium hydroxide solution (0.17 g NaOH in 5.11 g water) was added in drop wise while the solution was stirred at 1000 rpm using an overhead mixer (Labortechnik, IKA) to produce a viscous and white emulsion. To this emulsion, further 35.44 g water was slowly added into the beaker while the stirring was maintained to produce a stable white oil in water emulsion, to have a final solid of 26.0%. The emulsion was transferred to a 100 mL round bottom flask which was sealed, deoxygenated for 10 minutes and then immersed in an oil bath with a temperature setting of 80° C., which temperature was maintained for 3 hours with constant magnetic stirring. Transmission electron microscopy showed that the final latex contained polymeric hollow particles, whose sizes were bigger than those obtained in Part (8.2).

Part 8.4: Synthesis of Polystyrene Hollow Particles Using the macro-RAFT Agent Prepared in Part (8.1) as a Sole Stabilizer

An oil solution of styrene (15.15 g, 145.49 mmol), 2,2′-azobisisobutyronitrile (0.12 g, 0.74 mmol) and macro-RAFT solution from part (8.1) (5.03 g, 0.08 mmol) was prepared in a 100 mL beaker. To this solution, sodium hydroxide solution (0.17 g NaOH in 5.13 g water) was added in drop wise while the solution was stirred at 1000 rpm using an overhead mixer (Labortechnik, IKA) to produce a viscous and white emulsion. To this emulsion, further 40.08 g water was slowly added into the beaker while the stirring was maintained to produce a stable white oil in water emulsion, to have a final solid of 26.7%. The emulsion was transferred to a 100 mL round bottom flask which was sealed, deoxygenated for 10 minutes and then immersed in an oil bath with a temperature setting of 80° C., which temperature was maintained for 3 hours with constant magnetic stirring. Transmission electron microscopy showed that the final latex contained polymeric hollow particles, whose sizes were bigger than those obtained in Part (8.3).

Part 8.5: Preparation of a poly{[(butyl acrylate)ₘ-co-(acrylic acid)ₙ]-block-(styrene)ₜ} macro-RAFT Agent with Respective Degrees of Polymerization m≈120, n≈60 and t≈80, in Dioxane

A solution of dibenzyl trithiocarbonate (0.31 g, 1.05 mmol), 2,2′-azobisisobutyronitrile (0.06 g, 0.36 mmol), acrylic acid (4.47 g, 62.09 mmol), butyl acrylate (15.92 g, 124.19 mmol) in dioxane (31.28 g) was prepared in a 100 mL round bottom flask. This was stirred magnetically and sparged with nitrogen for 5 minutes. The flask was then maintained at 70° C. for 3 hours under constant stirring. At the end of the heating, styrene (8.62 g, 82.74 mmol), 2,2′-azobisisobutyronitrile (0.04 g, 0.25 mmol) and dioxane (12.37 g) was added to the copolymer solution. The flask was sealed, deoxygenated with nitrogen for 10 minutes and then maintained at 70° C. for overnight under constant stirring. The final copolymer solution had 40.3% solids.

Part 8.6: Synthesis of Polystyrene Hollow Particles Using the macro-RAFT Agent Prepared in Part (8.5) as a Sole Stabilizer

An oil solution of styrene (10.88 g, 104.48 mmol), 2,2′-azobisisobutyronitrile (0.09 g, 0.53 mmol) and macro-RAFT solution from part (8.5) (6.02 g, 0.09 mmol) was prepared in a 100 mL beaker. To this solution, sodium hydroxide solution (0.21 g NaOH in 5.02 g water) was added in drop wise while the solution was stirred at 1000 rpm using an overhead mixer (Labortechnik, IKA) to produce a viscous emulsion. To this emulsion, further 30.04 g water was slowly added into the beaker while the stirring was maintained to produce a stable white oil in water emulsion, to have a final solid of 26.0%. The emulsion was transferred to a 100 mL round bottom flask which was sealed, deoxygenated for 10 minutes and then immersed in an oil bath with a temperature setting of 80° C., which temperature was maintained for 3 hours with constant magnetic stirring. After 1 hour and 25 minutes, 17.97 g water was added to the reactor to reduce a very high viscosity of the forming latex, to have a final solid of 19.4%. Transmission electron microscopy showed that the final latex contained polymeric hollow particles.

Part 8.7: Synthesis of Polystyrene Hollow Particles Using the macro-RAFT Agent Prepared in Part (8.5) as a Sole Stabilizer

An oil solution of styrene (13.59 g, 130.48 mmol), 2,2′-azobisisobutyronitrile (0.11 g, 0.67 mmol) and macro-RAFT solution from part (8.5) (6.01 g, 0.09 mmol) was prepared in a 100 mL beaker. To this solution, sodium hydroxide solution (0.21 g NaOH in 5.00 g water) was added in drop wise while the solution was stirred at 1000 rpm using an overhead mixer (Labortechnik, IKA) to produce a viscous emulsion. To this emulsion, further 30.10 g water was slowly added into the beaker while the stirring was maintained to produce a stable white oil in water emulsion, to have a final solid of 29.7%. The emulsion was transferred to a 100 mL round bottom flask which was sealed, deoxygenated for 10 minutes and then immersed in an oil bath with a temperature setting of 80° C., which temperature was maintained for 3 hours with constant magnetic stirring. After 1 hour and 25 minutes, 17.54 g water was added to the reactor to reduce a very high viscosity of the forming latex, to have a final solid of 22.5%. Transmission electron microscopy showed that the final latex contained polymeric hollow particles, whose sizes were bigger than those obtained in Part (8.6).

Part 8.8: Synthesis of Polystyrene Hollow Particles Using the macro-RAFT Agent Prepared in Part (8.5) as a Sole Stabilizer

An oil solution of styrene (13.60 g, 130.56 mmol), 2,2′-azobisisobutyronitrile (0.11 g, 0.66 mmol) and macro-RAFT solution from part (8.5) (5.02 g, 0.07 mmol) was prepared in a 100 mL beaker. To this solution, sodium hydroxide solution (0.18 g NaOH in 5.02 g water) was added in drop wise while the solution was stirred at 1000 rpm using an overhead mixer (Labortechnik, IKA) to produce a viscous emulsion. To this emulsion, further 35.09 g water was slowly added into the beaker while the stirring was maintained to produce a stable white oil in water emulsion, to have a final solid of 26.9%. The emulsion was transferred to a 100 mL round bottom flask which was sealed, deoxygenated for 10 minutes and then immersed in an oil bath with a temperature setting of 80° C., which temperature was maintained for 65 minutes with constant magnetic stirring. After 45 minutes, 15.15 g water was added to the reactor to reduce a very high viscosity of the forming latex, to have a final solid of 21.4%. Transmission electron microscopy showed that the final latex contained polymeric hollow particles.

Part 8.9: Preparation of poly{[(butyl acrylate)ₘ-co-(acrylic acid)ₙ]-block-(styrene)ₜ} macro-RAFT Agent with Respective Degrees of Polymerization m≈120, n≈60 and t≈80, in Dioxane

Dibenzyl trithiocarbonate (0.3 g, 1.03 mmol), 2,2′-azobisisobutyronitrile (0.038 g, 0.231 mmol), acrylic acid (4.48 g, 62.15 mmol), butyl acrylate (15.90 g, 124.02 mmol) in dioxane (31.01 g) was prepared in a 100 mL round bottom flask. This was stirred magnetically and sparged with nitrogen for 10 minutes. The flask was then heated at 70° C. for 3 hours under constant stirring. At the end of the heating, styrene (8.63 g, 82.86 mmol), 2,2′-azobisisobutyronitrile (0.038 g, 0.231 mmol) and dioxane (12.02 g) was added to the polymer solution. The flask was sealed, deoxygenated with nitrogen for 15 minutes and then heated at 70° C. for another 12 hours under constant stirring. The final copolymer solution had 35.3% solids.

Part 8.10: Polystyrene Hollow Particle Synthesis Using macro-RAFT Agent from Part (8.9), Using 2,2′-azobisisobutyronitrile Initiator

Macro-RAFT solution from part (8.9) (18.00 g, 0.26 mmol), styrene (45.81 g, 439.87 mmol) and 2,2′-azobisisobutyronitrile (0.36 g, 2.21 mmol) was placed in a 400 mL beaker. To this macro-RAFT solution, 0.62 g (15.60 mmol) of NaOH dissolved in 18.02 g of water was added while the solution was stirred at 1000 rpm using an overhead mixer (Labortechnik, IKA) producing a thick yellowish white emulsion. After 30 minutes of stirring, 39.82 g of water was added using a pippette while the solution was being stirred at 1000 rpm. After a further 5 minutes of stirring, 55.63 g of water was poured into the while the stirring was maintained at 1000 rpm to produce a viscous bright white emulsion. The emulsion was transferred to a 250 mL round bottom flask which was sealed and subsequently purged with nitrogen for 15 min. The whole flask was immersed in an oil bath with a temperature setting of 80° C. and the heating was carried out for 3 hours under constant magnetic stirring. 10 g water was then added to the round bottom flask which was sealed and subsequently purged with nitrogen for 15 min. The whole flask was immersed in an oil bath with a temperature setting of 80° C. under constant magnetic stirring and divinyl benzene (5.03 ml, 35.18 mmol) was injected via a syringe pump, over the course of 2 hours. The latex was left stirring in the 80° C. oil bath overnight. The final latex had 31.1% solids. Transmission electron microscopy showed that the latex contains polymeric hollow particles.

Part 8.11: Polystyrene Hollow Particle Synthesis Using macro-RAFT Agent from Part (8.9), Using 2,2′-azobis(2-methylbutyronitrile) Initiator

Macro-RAFT solution from part (8.9) (5.00 g, 0.07 mmol), styrene (12.64 g, 121.39 mmol), and 2,2′-azobis(2-methylbutyronitrile) (0.13 g, 0.71 mmol) was placed in a 150 mL beaker. To this macro-RAFT solution, 0.17 g (4.31 mmol) of NaOH dissolved in 5.70 g of water was added while the solution was stirred at 1000 rpm using an overhead mixer (Labortechnik, IKA) producing a thick creamy white emulsion. After 30 minutes of stirring, 11.43 g of water was added using a pippette while the solution was being stirred at 1000 rpm. After a further 5 minutes of stirring, 14.56 g of water was poured into the while the stirring was maintained at 1000 rpm to produce a bright white emulsion. The emulsion was transferred to a 100 mL round bottom flask which was sealed and subsequently purged with nitrogen for 15 min. The whole flask was immersed in an oil bath with a temperature setting of 80° C. and the heating was carried out for 3 hours under constant magnetic stirring. Transmission electron microscopy showed that the latex contains polymeric hollow particles.

Part 8.12: Polystyrene Hollow Particle Synthesis Using macro-RAFT Agent from Part (8.9), Using 4,4′-azobis(4-cyanopentanoic Acid) Initiator

Macro-RAFT solution from part (8.9) (5.00 g, 0.07 mmol), styrene (12.64 g, 121.33 mmol), and 4,4′-azobis(4-cyanopentanoic acid) (0.17 g, 0.61 mmol) was placed in a 150 mL beaker. To this macro-RAFT solution, 0.18 g (4.42 mmol) of NaOH dissolved in 5.03 g of water was added while the solution was stirred at 1000 rpm using an overhead mixer (Labortechnik, IKA) producing a thick white emulsion. After 30 minutes of stirring, 12.03 g of water was added using a pippette while the solution was being stirred at 1000 rpm. After a further 5 minutes of stirring, 14.51 g of water was poured into the while the stirring was maintained at 1000 rpm to produce a thick bright white emulsion. The emulsion was transferred to a 100 mL round bottom flask, which was sealed and subsequently purged with nitrogen for 15 min. The whole flask was immersed in an oil bath with a temperature setting of 80° C. and the heating was carried out for 3 hours under constant magnetic stirring. Transmission electron microscopy showed that the latex contains polymeric hollow particles.

Part 8.13: Polystyrene Hollow Particle Synthesis Using macro-RAFT Agent from Part (8.9), Using Benzoyl Peroxide (BPO) Initiator

Macro-RAFT solution from part (8.9) (5.00 g, 0.07 mmol), styrene (12.63 g, 121.2 mmol), and Benzoyl Peroxide (0.15 g, 0.61 mmol) was placed in a 150 mL beaker. To this macro-RAFT solution, 0.18 g (4.42 mmol) of NaOH dissolved in 5.33 g of water was added while the solution was stirred at 1000 rpm using an overhead mixer (Labortechnik, IKA) producing a yellow-white emulsion. After 30 minutes of stirring, 12.41 g of water was added using a pippette while the solution was being stirred at 1000 rpm. After a further 5 minutes of stirring, 14.11 g of water was poured into the while the stirring was maintained at 1000 rpm to produce a thick bright white emulsion. The emulsion was transferred to a 100 mL round bottom flask which was sealed and subsequently purged with nitrogen for 15 min. The whole flask was immersed in an oil bath with a temperature setting of 80° C. and the heating was carried out for 3 hours under constant magnetic stirring. Transmission electron microscopy showed that the latex contains polymeric hollow particles.

Part 8.14: Polystyrene Hollow Particle Synthesis Using macro-RAFT Agent from Part (8.9), Using Ammonium Persulfate Initiator

Macro-RAFT solution from part (8.9) (5.01 g, 0.07 mmol), styrene (12.64 g, 121.36 mmol), and ammonium persulfate (0.14 g, 0.62 mmol) was placed in a 150 mL beaker. To this macro-RAFT solution, 0.17 g (4.30 mmol) of NaOH dissolved in 5.02 g of water was added while the solution was stirred at 1000 rpm using an overhead mixer (Labortechnik, IKA) producing a thick creamy white emulsion. After 30 minutes of stirring, 12.01 g of water was added using a pippette while the solution was being stirred at 1000 rpm. After a further 5 minutes of stirring, 14.54 g of water was poured into the while the stirring was maintained at 1000 rpm to produce a thick bright white emulsion. The emulsion was transferred to a 100 mL round bottom flask which was sealed and subsequently purged with nitrogen for 15 min. The whole flask was immersed in an oil bath with a temperature setting of 80° C. and the heating was carried out for 3 hours under constant magnetic stirring. Transmission electron microscopy showed that the latex contains some polymeric hollow particles.

Part 8.15: Poly(vinyl toluene) Hollow Particle Synthesis Using macro-RAFT Agent from Part (8.9)

Macro-RAFT solution from part (8.9) (2.02 g, 0.03 mmol), vinyl toluene (5.76 g, 55.34 mmol) and 2,2′-azobisisobutyronitrile (0.04 g, 0.24 mmol) was placed in a 100 mL beaker. To this macro-RAFT solution, 0.07 g (1.75 mmol) of NaOH dissolved in 2.02 g of water was added while the solution was stirred at 1000 rpm using an overhead mixer (Labortechnik, IKA) producing a thick yellowish white emulsion. After 30 minutes of stirring, 5.50 g of water was added using a pippette while the solution was being stirred at 1000 rpm. After a further 5 minutes of stirring, 6.51 g of water was poured into the while the stirring was maintained at 1000 rpm to produce a bright white emulsion. The emulsion was transferred to a 50 mL round bottom flask which was sealed and subsequently purged with nitrogen for 15 min. The whole flask was immersed in an oil bath with a temperature setting of 80° C. and the heating was carried out for 3 hours under constant magnetic stirring. The final latex had 32.4% solids. Transmission electron microscopy showed that the latex contains polymeric hollow particles.

Part 8.16: Poly(ethyl acrylate-co-t-butyl methacrylate) Hollow Particle Synthesis Using macro-RAFT Agent from Part (8.9)

Macro-RAFT solution from part (8.9) (5.02 g, 0.07 mmol), ethyl acrylate (7.15 g, 71.41 mmol), t-butyl methacrylate (7.15 g, 50.27 mmol) and 2,2′-azobisisobutyronitrile (0.06 g, 0.36 mmol) was placed in a 150 mL beaker. To this macro-RAFT solution, 0.17 g (4.31 mmol) of NaOH dissolved in 5.05 g of water was added while the solution was stirred at 1000 rpm using an overhead mixer (Labortechnik, IKA) producing a slightly gelatinous pale yellow emulsion. After 30 minutes of stirring, 14.05 g of water was added using a pippette while the solution was being stirred at 1000 rpm. After a further 5 minutes of stirring, 16.01 g of water was poured into the while the stirring was maintained at 1000 rpm to produce a viscous bright white emulsion. The emulsion was transferred to a 100 mL round bottom flask which was sealed and subsequently purged with nitrogen for 15 min. The whole flask was immersed in an oil bath with a temperature setting of 80° C. and the heating was carried out for 3 hours under constant magnetic stirring. The final latex had 23.3% solids. Transmission electron microscopy showed that the latex contains polymeric hollow particles.

Part 8.17: Poly(t-butyl methacrylate-co-butyl acrylate) Hollow Particle Synthesis Using macro-RAFT Agent from Part (8.9)

Macro-RAFT solution from part (8.9) (5.02 g, 0.07 mmol), butyl acrylate (1.13 g, 8.84 mmol), t-butyl methacrylate (10.09 g, 70.94 mmol) and 2,2′-azobisisobutyronitrile (0.06 g, 0.37 mmol) was placed in a 150 mL beaker. To this macro-RAFT solution, 0.17 g (4.33 mmol) of NaOH dissolved in 5.04 g of water was added while the solution was stirred at 1000 rpm using an overhead mixer (Labortechnik, IKA) producing a slightly gelatinous yellowish white emulsion. After 30 minutes of stirring, 11.11 g of water was added using a pippette while the solution was being stirred at 1000 rpm. After a further 5 minutes of stirring, 15.22 g of water was poured into the while the stirring was maintained at 1000 rpm to produce a yellowy white emulsion. The emulsion was transferred to a 100 mL round bottom flask which was sealed and subsequently purged with nitrogen for 15 min. The whole flask was immersed in an oil bath with a temperature setting of 80° C. and the heating was carried out for 3 hours under constant magnetic stirring. Transmission electron microscopy showed that the final latex contains polymeric hollow particles.

Part 8.18: Preparation of poly{[(butyl acrylate)ₘ-co-(acrylic acid)ₙ]-block-(styrene)ₜ} macro-RAFT Agent with Respective Degrees of Polymerization m≈100, n≈50 and t≈75, in Dioxane

Dibenzyl trithiocarbonate (0.24 g, 0.8 mmol), 2,2′-azobisisobutyronitrile (0.03 g, 0.2 mmol), acrylic acid (3.04 g, 42.2 mmol), butyl acrylate (10.33 g, 80.7 mmol) in dioxane (30.20 g) was prepared in a 100 mL round bottom flask. This was stirred magnetically and sparged with nitrogen for 10 minutes. The flask was then heated at 70° C. for 2 hours 30 minutes under constant stirring. At the end of the heating, styrene (6.38 g, 61.2 mmol) and 2,2′-azobisisobutyronitrile (0.03 g, 0.2 mmol) was added to the polymer solution. The flask was sealed, deoxygenated with nitrogen for 15 minutes and then heated at 70° C. for another 12 hours under constant stirring. The final copolymer solution had 32.1% solids.

Part 8.19: Polystyrene Hollow Particle Synthesis Using macro-RAFT Agent from Part (8.18)

Macro-RAFT solution from part (8.18) (5.06 g, 0.08 mmol) was placed in a 100 mL beaker. To this macro-RAFT solution, 4.19 g of water was added while the solution was stirred at 1000 rpm using an overhead mixer (Labortechnik, IKA) producing a cloudy yellow emulsion. To this mixture of macro-RAFT and water, ammonium hydroxide (1.52 g, 28%) was added in drop wise while the solution was stirred at 1000 rpm using an overhead mixer (Labortechnik, IKA) producing a yellow cloudy dispersion. A solution of styrene (10.83 g, 104.0 mmol), 2,2′-azobisisobutyronitrile (0.15 g, 0.9 mmol) was added to this dispersion under constant stirring. 40.17 g of water was then added drop wise into beaker while the stirring was maintained at 1000 rpm to produce a viscous white emulsion. The emulsion was transferred to a 100 mL round bottom flask which was sealed and subsequently purged with nitrogen for 15 min. The whole flask was immersed in an oil bath with a temperature setting of 80° C. and the heating was carried out for 3 hours under constant magnetic stirring. The final latex was white and stable, containing particles about 578 nm in diameter (HPPS, Malvern Instruments Ltd). It had final solids of 20.1%. Transmission electron microscopy showed that the latex contains polymeric hollow particles.

Part 8.20: Polystyrene Encapsulation of Titanium Dioxide Using macro-RAFT Agent from Part (8.18)

Macro-RAFT solution from part (8.18) (5.29 g, 0.1 mmol) was placed in a 100 mL beaker. To this macro-RAFT solution, 4.25 g of water was added while the solution was stirred at 1000 rpm using an overhead mixer (Labortechnik, IKA) producing a cloudy yellow mixture. To this mixture of macro-RAFT and water, ammonium hydroxide (1.53 g, 28%) was added in drop wise while the solution was stirred at 1000 rpm using an overhead mixer (Labortechnik, IKA) producing a yellow cloudy dispersion. Titanium dioxide (5.14 g) was then thoroughly mixed with this dispersion to produce a white viscous dispersion. A solution of styrene (10.47 g, 100.5 mmol), 2,2′-azobisisobutyronitrile (0.13 g, 0.8 mmol) was added to this dispersion under constant stirring. 50.31 g of water was then added drop wise into beaker while the stirring was maintained at 1000 rpm to produce a viscous white emulsion. The emulsion was transferred to a 100 mL round bottom flask which was sealed and subsequently purged with nitrogen for 15 min. The whole flask was immersed in an oil bath with a temperature setting of 80° C. and the heating was carried out for 3 hours under constant magnetic stirring. The final latex was white and stable, containing particles about 684 nm in diameter (HPPS, Malvern Instruments Ltd). It had 21.9% solids. Transmission electron microscopy showed that the latex contains encapsulated titanium dioxide as well as polymeric hollow particles.

Part 8.21: Preparation of poly{[(butyl acrylate)ₘ-co-(acrylic acid)ₙ]-block-(styrene)ₜ} macro-RAFT Agent with Respective Degrees of Polymerization m≈180, n=60 and t≈80, in Dioxane

Dibenzyl trithiocarbonate (0.22 g, 0.73 mmol), 2,2′-azobisisobutyronitrile (0.03 g, 0.16 mmol), acrylic acid (2.99 g, 41.47 mmol), butyl acrylate (15.89 g, 124.0 mmol) in dioxane (28.0 g) was prepared in a 100 mL round bottom flask. This was stirred magnetically and sparged with nitrogen for 5 minutes. The flask was then heated at 70° C. for 3 hours under constant stirring. At the end of the heating, styrene (5.76 g, 55.30 mmol) and 2,2′-azobisisobutyronitrile (0.04 g, 0.22 mmol) was added to the polymer solution. The flask was sealed, deoxygenated with nitrogen for 5 minutes and then heated at 70° C. for another 12 hours under constant stirring. The final copolymer solution had 36.3% solids.

Part 8.22: Polystyrene Hollow Particle Synthesis Using macro-RAFT Agent from Part (8.21)

Macro-RAFT solution from part (8.21) (15.04 g, 0.18 mmol); styrene (37.52 g, 360.27 mmol), 2,2′-azobisisobutyronitrile (0.30 g, 1.83 mmol) was placed in a 200 mL beaker. To this macro-RAFT solution mixture, sodium hydroxide solution (sodium hydroxide (0.51 g, 12.67 mmol) and 15.03 g water) was added while the solution was stirred at 1000 rpm using an overhead mixer (Labortechnik, IKA) producing a viscous creamy white emulsion. The dispersion was left to stir for 30 minutes. To this dispersion under constant stirring, 37.25 g water was then added quickly into beaker while the stirring was maintained at 1000 rpm to produce a less viscous white emulsion. The dispersion was left to stir for 10 min before the final 44.59 g water was pipette in. The dispersion was then left to stir at 1000 rpm for another 20 minutes. The emulsion was transferred to a 250 mL round bottom flask which was sealed and subsequently purged with nitrogen for 10 min. The whole flask was immersed in an oil bath with a temperature setting of 80° C. and the heating was carried out for 3 hours and 30 minutes under constant magnetic stirring. 5.04 g divinyl benzene was added to the latex. The round bottom flask was sealed again and left stirring at the ambient temperature for 4 hours, subsequently deoxygenated with nitrogen gas for 10 minutes. The whole flask was then immersed in an oil bath with a temperature setting of 80° C. and the heating was carried out for overnight, under a constant magnetic stirring. Transmission electron microscopy showed that the final latex contains polymeric hollow particles.

Part 8.23: Preparation of poly{[(butyl acrylate)ₘ-co-(acrylic acid)ₙ]-block-(styrene)ₜ} macro-RAFT Agent with Respective Degrees of Polymerization m≈100, n≈40 and t≈60, in Dioxane

Dibenzyl trithiocarbonate (0.33 g, 1.1 mmol), 2,2′-azobisisobutyronitrile (0.04 g, 0.2 mmol), acrylic acid (3.26 g, 45.3 mmol), butyl acrylate (14.44 g, 112.6 mmol) in dioxane (36.08 g) was prepared in a 100 mL round bottom flask. This was stirred magnetically and sparged with nitrogen for 10 minutes. The flask was then heated at 70° C. for 3 hours under constant stirring. At the end of the heating, styrene (7.04 g, 67.6 mmol) and 2,2′-azobisisobutyronitrile (0.04 g, 0.2 mmol) was added to the polymer solution. The flask was sealed, deoxygenated with nitrogen for 10 minutes and then heated at 70° C. for another 12 hours under constant stirring. The final copolymer solution had 39.3% solids.

Part 8.24: Polystyrene Hollow Particle Synthesis Using macro-RAFT Agent from Part (8.23)

Macro-RAFT solution from part (8.23) (6.02 g, 0.11 mmol); styrene (21.22 g, 203.8 mmol), 2,2′-azobisisobutyronitrile (0.17 g, 1.0 mmol) was placed in a 100 mL beaker. To this macro-RAFT solution mixture, sodium hydroxide solution (sodium hydroxide (0.32 g, 8.0 mmol) and 9.11 g of water) was added while the solution was stirred at 1000 rpm using an overhead mixer (Labortechnik, IKA) producing a viscous yellowish white emulsion. The dispersion was left to stir for 30 minutes. To this dispersion under constant stirring, 16.08 g of water was then pipette quickly into beaker while the stirring was maintained at 1000 rpm to produce a less viscous white emulsion. The dispersion was left to stir for 10 min before the final 28.52 g of water was pipette in. After the final water was pipette in, the dispersion was left to stir at 1000 rpm for another 20 minutes. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetic stirring. The final latex had 27.1% solids. Transmission electron microscopy showed that the latex contains polymeric hollow particles.

Part 8.25: Poly(styrene-co-butyl acrylate) Hollow Particle Synthesis Using macro-RAFT Agent from Part (8.23)

Macro-RAFT solution from part (8.23) (5.98 g, 0.11 mmol); styrene (19.45 g, 186.8 mmol), butyl acrylate (2.18 g, 17.0 mmol) and 2,2′-azobisisobutyronitrile (0.16 g, 1.0 mmol) was placed in a 100 mL beaker. To this macro-RAFT solution mixture, sodium hydroxide solution (sodium hydroxide (0.32 g, 8.0 mmol) and 9.27 g of water) was added while the solution was stirred at 1000 rpm using an overhead mixer (Labortechnik, IKA) producing a viscous yellowish white emulsion. The dispersion was left to stir for 30 minutes. To this dispersion under constant stirring, 16.11 g of water was then pipette quickly into beaker while the stirring was maintained at 1000 rpm to produce a less viscous white emulsion. The dispersion was left to stir for 10 min before the final 28.06 g of water was pipette in. After the final water was pipette in, the dispersion was left to stir at 1000 rpm for another 30 minutes. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetic stirring. The final latex had 28.4% solids. Transmission electron microscopy showed that the latex contains polymeric hollow particles.

Part 8.26: Preparation of poly{[(butyl acrylate)ₘ-co-(acrylic acid)ₙ]-block-(styrene)ₜ} macro-RAFT Agent with Respective Degrees of Polymerization m≈60, n z 30 and t≈50, in Dioxane

Dibenzyl trithiocarbonate (0.30, 1.0 mmol), 2,2′-azobisisobutyronitrile (0.04 g, 0.2 mmol), acrylic acid (2.24 g, 31.1 mmol), butyl acrylate (7.95 g, 62.0 mmol) in dioxane (16.00 g) was prepared in a 100 mL round bottom flask. This was stirred magnetically and sparged with nitrogen for 10 minutes. The flask was then heated at 70° C. for 3 hours under constant stirring. At the end of the heating, styrene (5.39 g, 51.8 mmol), 2,2′-azobisisobutyronitrile (0.05 g, 0.3 mmol) and dioxane (7.00 g) was added to the polymer solution. The flask was sealed, deoxygenated with nitrogen for 10 minutes and then heated at 70° C. for another 12 hours under constant stirring. The final copolymer solution had 39.0% solids.

Part 8.27: Polystyrene Hollow Particle Synthesis Using macro-RAFT Agent from Part (8.26)

Macro-RAFT solution from part (8.26) (3.03, 0.08 mmol); styrene (10.0 g, 96.85 mmol), was placed in a 100 mL beaker. To this macro-RAFT solution mixture, sodium hydroxide solution (sodium hydroxide (0.16 g, 4.1 mmol) and 3.03 g of water) was added while the solution was stirred at 1000 rpm using an overhead mixer (Labortechnik, IKA) producing a viscous yellowish white emulsion. The dispersion was left to stir for 30 minutes. To this dispersion under constant stirring, 8.15 g of water was then pipette quickly into beaker while the stirring was maintained at 1000 rpm to produce a less viscous white emulsion. The dispersion was left to stir for 30 min before the final 13.9 g of water was pipette in. After the final water was pipette in, the dispersion was left to stir at 1000 rpm for another 30 minutes. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetic stirring. The final latex had 29.2% solids and formed white chips after drying. Transmission electron microscopy showed that the latex contains polymeric hollow particles.

Part 8.28: Preparation of poly{[(butyl acrylate)ₘ-co-(acrylic acid)ₙ]-block-(styrene)ₜ} macro-RAFT Agent with Respective Degrees of Polymerization m≈80, n≈40 and t≈60, in Dioxane

Dibenzyl trithiocarbonate (0.25 g, 0.86 mmol), 2,2′-azobisisobutyronitrile (0.03 g, 0.19 mmol), acrylic acid (2.49 g, 34.57 mmol), butyl acrylate (8.83 g, 63.93 mmol) in dioxane (17.51 g) was prepared in a 100 mL round bottom flask. This was stirred magnetically and sparged with nitrogen for 10 minutes. The flask was then heated at 70° C. for 3 hours under constant stirring. At the end of the heating, styrene (5.39 g, 51.79 mmol), 2,2′-azobisisobutyronitrile (0.04 g, 0.26 mmol) and dioxane (8.04 g) was added to the polymer solution. The flask was sealed, deoxygenated with nitrogen for 15 minutes and then heated at 70° C. for another 12 hours under constant stirring. The final copolymer solution had 37.79% solids.

Part 8.29: Polystyrene Hollow Particle Synthesis Using macro-RAFT Agent from Part (8.28)

Macro-RAFT solution from part (8.28) (2.51 g, 0.05 mmol), styrene (7.95 g, 76.34 mmol) and 2,2′-azobisisobutyronitrile (0.06 g, 0.38 mmol) was placed in a 100 mL beaker. To this macro-RAFT solution, 0.12 g (3.11 mmol) of NaOH dissolved in 2.59 g of water was added while the solution was stirred at 1000 rpm using an overhead mixer (Labortechnik, IKA) producing a slightly phase separated yellowish white emulsion. After 30 minutes of stirring, 8.53 g of water was added using a pippette while the solution was being stirred at 1000 rpm. After a further 5 minutes of stirring, 8.0 g of water was poured into the while the stirring was maintained at 1000 rpm to produce a viscous white emulsion. The emulsion was transferred to a 50 mL round bottom flask which was sealed and subsequently purged with nitrogen for 15 min. The whole flask was immersed in an oil bath with a temperature setting of 80° C. and the heating was carried out for 3 hours under constant magnetic stirring. The final latex had 30.8% solids. Transmission electron microscopy showed that the latex contains polymeric hollow particles.

Part 8.30: Preparation of poly{[(butyl acrylate)ₘ-co-(acrylic acid)ₙ]-block-(styrene)ₜ} macro-RAFT Agent with Respective Degrees of Polymerization m≈40, n≈20 and t≈30, in Dioxane

Dibenzyl trithiocarbonate (0.35 g, 1.21 mmol), 2,2′-azobisisobutyronitrile (0.04 g, 0.26 mmol), acrylic acid (1.74 g, 24.13 mmol), butyl acrylate (6.18 g, 48.24 mmol) in dioxane (12.51 g) was prepared in a 50 mL round bottom flask. This was stirred magnetically and sparged with nitrogen for 10 minutes. The flask was then heated at 70° C. for 3 hours under constant stirring. At the end of the heating, styrene (3.77 g, 36.26 mmol), 2,2′-azobisisobutyronitrile (0.06 g, 0.37 mmol) and dioxane (5.06 g) was added to the polymer solution. The flask was sealed, deoxygenated with nitrogen for 15 minutes and then heated at 70° C. for another 12 hours under constant stirring. The final copolymer solution had 42.61% solids.

Part 8.31: Polystyrene Hollow Particle Synthesis Using macro-RAFT Agent from Part (8.30)

Macro-RAFT solution from part (8.30) (3.01 g, 0.12 mmol), styrene (16.00 g, 153.66 mmol) and 2,2′-azobisisobutyronitrile (0.12 g, 0.75 mmol) was placed in a 100 mL beaker. To this macro-RAFT solution, sodium hydroxide solution (NaOH (0.15 g, 3.80 mmol) in 10.37 g of water) was added while the solution was stirred at 1000 rpm using an overhead mixer (Labortechnik, IKA) producing a viscous creamy white emulsion. After 30 minutes of stirring, 27.54 g of water was added while the stirring was maintained at 1000 rpm for another 30 minutes to produce a white emulsion. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetic stirring. Transmission electron microscopy showed that the final latex contains polymeric hollow particles.

Part 8.32: Preparation of a poly{[(butyl acrylate)ₘ-co-(acrylic acid)ₙ]-block-(styrene)ₜ} macro-RAFT Agent with Respective Degrees of Polymerization m≈100, n≈50 and t≈75, in Texanol

A solution of dibenzyl trithiocarbonate (0.31 g, 1.05 mmol), 2,2′-azobisisobutyronitrile (0.04 g, 0.21 mmol), acrylic acid (3.73 g, 51.81 mmol), butyl acrylate (13.25 g, 103.39 mmol) in texanol (25.02 g) was prepared in a 100 mL round bottom flask. This was stirred magnetically and sparged with nitrogen for 5 minutes. The flask was then maintained at 70° C. for 3 hours under constant stirring. At the end of the heating, styrene (8.09 g, 77.69 mmol), 2,2′-azobisisobutyronitrile (0.04 g, 0.21 mmol) and texanol (12.01 g) was added to the copolymer solution. The flask was sealed, deoxygenated with nitrogen for 10 minutes and then maintained at 70° C. for overnight under constant stirring. The final copolymer solution had 40.7% solids.

Part 8.33: Synthesis of Polystyrene Hollow Particles Using the macro-RAFT Agent Prepared in Part (8.32) as a Sole Stabilizer

An oil solution of styrene (13.27 g, 127.41 mmol), 2,2′-azobisisobutyronitrile (0.11 g, 0.69 mmol) and macro-RAFT solution from part (8.32) (5.04 g, 0.09 mmol) was prepared in a 100 mL beaker. To this solution, sodium hydroxide solution (0.17 g NaOH in 5.01 g water) was added in drop wise while the solution was stirred at 1000 rpm using an overhead mixer (Labortechnik, IKA) to produce a viscous emulsion. To this emulsion, further 35.02 g water was slowly added into the beaker while the stirring was maintained to produce a stable white oil in water emulsion, to have a final solid of 26.6%. The emulsion was transferred to a 100 mL round bottom flask which was sealed, deoxygenated for 10 minutes and then immersed in an oil bath with a temperature setting of 80° C., which temperature was maintained for 3 hours with constant magnetic stirring. Transmission electron microscopy showed that the final latex contained polymeric hollow particles.

Part 8.34: Preparation of poly{[(butyl acrylate)ₘ-co-(acrylic acid)ₙ]-block-(styrene)ₜ} macro-RAFT Agent with Respective Degrees of Polymerization m≈100, n≈50 and t≈75, in Butanone

Dibenzyl trithiocarbonate (0.28 g, 0.9 mmol), 2,2′-azobisisobutyronitrile (0.03 g, 0.2 mmol), acrylic acid (3.30 g, 45.7 mmol), butyl acrylate (11.70 g, 91.2 mmol) in butanone (30.17 g) was prepared in a 100 mL round bottom flask. This was stirred magnetically and sparged with nitrogen for 10 minutes. The flask was then heated at 70° C. for 2 hours 30 minutes under constant stirring. At the end of the heating, styrene (7.14 g, 68.5 mmol) and 2,2′-azobisisobutyronitrile (0.03 g, 0.2 mmol) was added to the polymer solution. The flask was sealed, deoxygenated with nitrogen for 15 minutes and then heated at 70° C. for another 12 hours under constant stirring. The final copolymer solution had 30.2% solids.

Part 8.35: Polystyrene Hollow Particle Synthesis Using macro-RAFT Agent from Part (8.34)

Macro-RAFT solution from part (8.34) (5.15 g, 0.09 mmol) was placed in a 100 mL beaker. To this macro-RAFT solution, 4.05 g of water was added while the solution was stirred at 1000 rpm using an overhead mixer (Labortechnik, IKA) producing a cloudy yellow emulsion. To this mixture of macro-RAFT and water, ammonium hydroxide (1.54 g, 28%) was added in drop wise while the solution was stirred at 1000 rpm using an overhead mixer (Labortechnik, IKA) producing a yellow cloudy dispersion. A solution of styrene (12.00 g, 115.1 mmol), 2,2′-azobisisobutyronitrile (0.15 g, 0.9 mmol) was added to this dispersion under constant stirring. 40.06 g of water was then added drop wise into beaker while the stirring was maintained at 1000 rpm to produce a viscous white emulsion. The emulsion was transferred to a 100 mL round bottom flask which was sealed and subsequently purged with nitrogen for 15 min. The whole flask was immersed in an oil bath with a temperature setting of 80° C. and the heating was carried out for 3 hours under constant magnetic stirring. The final latex was white and stable, containing particles about 616 nm in diameter (HPPS, Malvern Instruments Ltd). It had 23.8% solids. Transmission electron microscopy showed that the latex contains polymeric hollow particles.

Part 8.36: Preparation of poly{[(butyl acrylate)ₘ-co-(acrylic acid)ₙ]-block-(styrene)ₜ} macro-RAFT agent with respective degrees of polymerization m≈120, n≈60 and t≈80, in methyl tetraglycol.

Dibenzyl trithiocarbonate (0.25 g, 0.9 mmol), 2,2′-azobisisobutyronitrile (0.03 g, 0.2 mmol), acrylic acid (3.82 g, 53.0 mmol), butyl acrylate (13.57 g, 105.9 mmol) in methyl tetraglycol (36.04 g) was prepared in a 100 mL round bottom flask. This was stirred magnetically and sparged with nitrogen for 10 minutes. The flask was then heated at 70° C. for 3 hours under constant stirring. At the end of the heating, styrene (7.36 g, 70.7 mmol) and 2,2′-azobisisobutyronitrile (0.03 g, 0.2 mmol) was added to the polymer solution. The flask was sealed, deoxygenated with nitrogen for 10 minutes and then heated at 70° C. for another 12 hours under constant stirring. The final copolymer solution had 39.0% solids.

Part 8.37: Polystyrene Hollow Particle Synthesis Using macro-RAFT Agent from Part (8.36)

Macro-RAFT solution from part (8.36) (5.00 g, 0.07 mmol); styrene (21.22 g, 128.7 mmol), 2,2′-azobisisobutyronitrile (0.11 g, 0.7 mmol) was placed in a 100 mL beaker. To this macro-RAFT solution mixture, sodium hydroxide solution (sodium hydroxide (0.26 g, 6.4 mmol) and 5.02 g of water) was added while the solution was stirred at 1000 rpm using an overhead mixer (Labortechnik, IKA) producing a viscous yellowish white emulsion. The dispersion was left to stir for 30 minutes. To this dispersion under constant stirring, 12.97 g of water was then pipette quickly into beaker while the stirring was maintained at 1000 rpm to produce a less viscous white emulsion. The dispersion was left to stir for 30 min before the final 16.00 g of water was pipette in. After the final water was pipette in, the dispersion was left to stir at 1000 rpm for another 30 minutes. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetic stirring. The final latex had 34.0% solids. Transmission electron microscopy showed that the latex contains polymeric hollow particles.

Part 8.38: Polystyrene Hollow Particle Synthesis Using macro-RAFT Agent from Part (8.36)

Macro-RAFT solution from part (8.36) (3.01 g, 0.04 mmol); styrene (8.03 g, 77.5 mmol), 2,2′-azobisisobutyronitrile (0.06 g, 0.4 mmol) was placed in a 100 mL beaker. To this macro-RAFT solution mixture, 2-Amino-2-methyl-1-propanol solution (2-Amino-2-methyl-1-propanol [AMP-95], 0.35 g, 3.92 mmol and 3.01 g of water) was added while the solution was stirred at 1000 rpm using an overhead mixer (Labortechnik, IKA) producing a viscous yellowish white emulsion. The dispersion was left to stir for 30 minutes. To this dispersion under constant stirring, 8.00 g of water was then pipette quickly into beaker while the stirring was maintained at 1000 rpm to produce a less viscous white emulsion. The dispersion was left to stir for 30 min before the final 9.50 g of water was pipette in. After the final water was pipette in, the dispersion was left to stir at 1000 rpm for another 30 minutes. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetic stirring. Transmission electron microscopy showed that the final latex contains polymeric hollow particles.

Part 8.39: Preparation of poly{[(butyl acrylate)ₘ-co-(acrylic acid)ₙ]-block-(styrene)ₜ} macro-RAFT agent with respective degrees of polymerization m≈120, n z 60 and t≈80, in PEG200

Dibenzyl trithiocarbonate (0.26, 0.9 mmol), 2,2′-azobisisobutyronitrile (0.03 g, 0.2 mmol), acrylic acid (3.85 g, 53.5 mmol), butyl acrylate (13.58 g, 105.9 mmol) in PEG200 from Huntsman Corporation (36.02 g) was prepared in a 100 mL round bottom flask. This was stirred magnetically and sparged with nitrogen for 10 minutes. The flask was then heated at 70° C. for 3 hours under constant stirring. At the end of the heating, styrene (7.37 g, 70.7 mmol) and 2,2′-azobisisobutyronitrile (0.03 g, 0.2 mmol) was added to the polymer solution. The flask was sealed, deoxygenated with nitrogen for 10 minutes and then heated at 70° C. for another 12 hours under constant stirring. The final copolymer solution had 41.6% solids.

Part 8.40: Polystyrene Hollow Particle Synthesis Using macro-RAFT Agent from Part (8.39)

Macro-RAFT solution from part (8.21) (2.99 g, 0.04 mmol); styrene (8.20 g, 78.7 mmol), 2,2′-azobisisobutyronitrile (0.06 g, 0.4 mmol) was placed in a 100 mL beaker. To this macro-RAFT solution mixture, sodium hydroxide solution (sodium hydroxide (0.21 g, 5.27 mmol) and 3.0 g of water) was added while the solution was stirred at 1000 rpm using an overhead mixer (Labortechnik, IKA) producing a viscous yellowish white emulsion. The dispersion was left to stir for 30 minutes. To this dispersion under constant stirring, 8.0 g of water was then pipette quickly into beaker while the stirring was maintained at 1000 rpm to produce a less viscous white emulsion. The dispersion was left to stir for 30 min before the final 9.5 g of water was pipette in. After the final water was pipette in, the dispersion was left to stir at 1000 rpm for another 30 minutes. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetic stirring. The final latex was white and stable, containing particles about 274 nm in diameter (HPPS, Malvern Instruments Ltd). It had 33.0% solids. Transmission electron microscopy showed that the latex contains polymeric hollow particles.

Part 8.41: Polystyrene Hollow Particle Synthesis Using macro-RAFT Agent from Part (8.39).

Macro-RAFT solution from Part 8.39 (3.01 g, 0.04 mmol); styrene (8.19 g, 78.6 mmol), 2,2′-azobisisobutyronitrile (0.13 g, 0.78 mmol) was placed in a 100 mL beaker. To this macro-RAFT solution mixture, sodium hydroxide solution (sodium hydroxide (0.21 g, 5.24 mmol) and 3.09 g of water) was added while the solution was stirred at 1000 rpm using an overhead mixer (Labortechnik, IKA) producing a viscous yellowish white emulsion. The dispersion was left to stir for 30 minutes. To this dispersion under constant stirring, 8.03 g of water was then pipette quickly into beaker while the stirring was maintained at 1000 rpm to produce a less viscous white emulsion. The dispersion was left to stir for 30 min before the final 10.11 g of water was pipette in. After the final water was pipette in, the dispersion was left to stir at 1000 rpm for another 30 minutes. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetic stirring. The final latex was white and stable, containing particles about 404 nm in diameter (HPPS, Malvern Instruments Ltd). Transmission electron microscopy showed that the latex contains polymeric hollow particles.

Part 8.42: Preparation of poly{[(butyl acrylate)ₘ-co-(acrylic acid)ₙ-block-[(styrene)ₜ-co-(butyl acrylate)_{q}]} macro-RAFT Agent with Respective Degrees of Polymerization m≈100, n≈50, t≈50 and q≈25, in Butanone

Dibenzyl trithiocarbonate (0.24 g, 0.8 mmol), 2,2′-azobisisobutyronitrile (0.03 g, 0.2 mmol), acrylic acid (2.92 g, 40.5 mmol), butyl acrylate (10.02 g, 78.2 mmol) in butanone (30.27 g) was prepared in a 100 mL round bottom flask. This was stirred magnetically and sparged with nitrogen for 10 minutes. The flask was then heated at 70° C. for 2 hours 30 minutes under constant stirring. At the end of the heating, styrene (2.06 g, 19.8 mmol), butyl acrylate (5.03 g, 39.2 mmol) and 2,2′-azobisisobutyronitrile (0.03 g, 0.2 mmol) was added to the polymer solution. The flask was sealed, deoxygenated with nitrogen for 15 minutes and then heated at 70° C. for another 12 hours under constant stirring. The final copolymer solution had 26.7% solids.

Part 8.43: Polystyrene Hollow Particle Synthesis Using macro-RAFT Agent from Part (8.42)

Macro-RAFT solution from Part 8.42 (5.22 g, 0.08 mmol) was placed in a 100 mL beaker. To this macro-RAFT solution, 4.06 g of water was added while the solution was stirred at 1000 rpm using an overhead mixer (Labortechnik, IKA) producing a cloudy yellow emulsion. To this mixture of macro-RAFT and water, ammonium hydroxide (1.54 g, 28%) was added in drop wise while the solution was stirred at 1000 rpm using an overhead mixer (Labortechnik, IKA) producing a yellow cloudy dispersion. A solution of styrene (11.21 g, 107.6 mmol), 2,2′-azobisisobutyronitrile (0.15 g, 0.9 mmol) was added to this dispersion under constant stirring. 40.27 g of water was then added drop wise into beaker while the stirring was maintained at 1000 rpm to produce a viscous white emulsion. The emulsion was transferred to a 100 mL round bottom flask which was sealed and subsequently purged with nitrogen for 15 min. The whole flask was immersed in an oil bath with a temperature setting of 80° C. and the heating was carried out for 3 hours under constant magnetic stirring. The final latex had 20.6% solids and formed white chips after drying. Transmission electron microscopy showed that the latex contains polymeric hollow particles.

Part 8.44: Preparation of poly{[(butyl acrylate)ₘ-co-(acrylic acid)ₙ]-block-[(methyl methacrylate)_{q}-co-(butyl acrylate)ₜ]} macro-RAFT agent with respective degrees of polymerization m≈120, n≈60, q≈74 and t≈7, in Dioxane.

Dibenzyl trithiocarbonate (0.10 g, 0.35 mmol), 2,2′-azobisisobutyronitrile (0.01 g, 0.07 mmol), acrylic acid (1.49 g, 20.68 mmol), butyl acrylate (5.30 g, 41.34 mmol) in dioxane (10.40 g) was prepared in a 100 mL round bottom flask. This was stirred magnetically and sparged with nitrogen for 10 minutes. The flask was then heated at 70° C. for 3 hours under constant stirring. At the end of the heating, methyl methacrylate (2.59 g, 25.87 mmol), butyl acrylate (0.29 g, 2.24 mmol) and 2,2′-azobisisobutyronitrile (0.02 g, 0.1 mmol) was added to the polymer solution. The flask was sealed, deoxygenated with nitrogen for 15 minutes and then heated at 70° C. for another 12 hours under constant stirring. The final copolymer solution had 41.4% solids.

Part 8.45: Polystyrene Hollow Particle Synthesis Using macro-RAFT Agent from Part (8.44)

Macro-RAFT solution from part (8.44) (2.51 g, 0.04 mmol), styrene (6.40 g, 61.48 mmol) and 2,2′-azobisisobutyronitrile (0.05 g, 0.31 mmol) was placed in a 100 mL beaker. To this macro-RAFT solution, 0.09 g (2.24 mmol) of NaOH dissolved in 2.64 g of water was added while the solution was stirred at 1000 rpm using an overhead mixer (Labortechnik, IKA) producing a yellowish white emulsion. After 30 minutes of stirring, 6.45 g of water was added using a pippette while the solution was being stirred at 1000 rpm. After a further 5 minutes of stirring, 6.93 g of water was poured into the while the stirring was maintained at 1000 rpm to produce a white emulsion. The emulsion was transferred to a 50 mL round bottom flask which was sealed and subsequently purged with nitrogen for 15 min. The whole flask was immersed in an oil bath with a temperature setting of 80° C. and the heating was carried out for 3 hours under constant magnetic stirring. The final latex had 30.1% solids and formed white chips after drying. Transmission electron microscopy showed that the latex contains polymeric hollow particles.

Part 8.46: Preparation of poly{[(butyl acrylate)ₘ-co-(acrylic acid)ₙ]-block-(styrene)ₜ} macro-RAFT Agent with Respective Degrees of Polymerization m≈100, n≈40 and t≈60, in Dioxane

Dibenzyl trithiocarbonate (0.33 g, 1.1 mmol), 2,2′-azobisisobutyronitrile (0.04 g, 0.2 mmol), acrylic acid (3.24 g, 45.0 mmol), butyl acrylate (14.4 g, 112.4 mmol) in dioxane (36.06 g) was prepared in a 100 mL round bottom flask. This was stirred magnetically and sparged with nitrogen for 10 minutes. The flask was then heated at 70° C. for 3 hours under constant stirring. At the end of the heating, styrene (7.03 g, 67.5 mmol) and 2,2′-azobisisobutyronitrile (0.04 g, 0.2 mmol) was added to the polymer solution. The flask was sealed, deoxygenated with nitrogen for 10 minutes and then heated at 70° C. for another 12 hours under constant stirring. The final copolymer solution had 35.7% solids.

Part 8.47: Polystyrene Hollow Particle Synthesis Using macro-RAFT Agent from Part (8.46), Without Initiator

Macro-RAFT solution from part (8.46) (3.00 g, 0.06 mmol); inhibited styrene (10.5 g, 101.2 mmol), was placed in a 100 mL beaker. To this macro-RAFT solution mixture, sodium hydroxide solution (sodium hydroxide (0.16 g, 4.1 mmol) and 4.7 g of water) was added while the solution was stirred at 1000 rpm using an overhead mixer (Labortechnik, IKA) producing a viscous yellowish white emulsion. The dispersion was left to stir for 30 minutes. To this dispersion under constant stirring, 8.17 g of water was then pipette quickly into beaker while the stirring was maintained at 1000 rpm to produce a less viscous white emulsion. The dispersion was left to stir for 30 min before the final 14.04 g of water was pipette in. After the final water was pipette in, the dispersion was left to stir at 1000 rpm for another 30 minutes. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetic stirring. The final latex had 22.1%. Transmission electron microscopy showed that the latex contains polymeric hollow particles.

### Example 9

### Synthesis of Solid Polystyrene Particles Using Non-Living Diblock poly{[(butyl acrylate)ₘ-co-(acrylic acid)ₙ]-block-(styrene)ₜ} of 2-{[(butylsulfanyl)carbonothioyl]sulfanyl}propanoic Acid RAFT Agent

Part 9.1: Preparation of a Non-Living poly{[(butyl acrylate)ₘ-co-(acrylic acid)ₙ]-block-(styrene)ₜ} macro-RAFT Agent with Respective Degrees of Polymerization m≈100, n≈50 and t≈50, in Dioxane

A solution of 2-{[(butylsulfanyl)carbonothioyl]sulfanyl}propanoic acid (0.22 g, 0.91 mmol), 2,2′-azobisisobutyronitrile (0.04 g, 0.24 mmol), acrylic acid (3.49 g, 48.48 mmol), butyl acrylate (11.73 g, 91.53 mmol) in dioxane (30.81 g) was prepared in a 100 mL round bottom flask. This was stirred magnetically and sparged with nitrogen for 10 minutes. The flask was then immerged in a 70° C. oil bath for 2 hours 30 minutes with constant stirring. At the end of this period, styrene (4.79 g, 46.00 mmol) and 2,2′-azobisisobutyronitrile (0.05 g, 0.18 mmol) was added to the polymer solution. The flask was sealed, sparged with nitrogen for 10 minutes and then maintained at 70° C. for another 12 hours under constant stirring.

To 3.46 g of the above macro-RAFT agent solution, water (12.80 g) and ammonia solution (28%, around 3-4 g) were mixed together in a 50 ml round bottom flask to obtain a clear yellow macro-RAFT solution, with pH≈11. To this solution, 70 wt % tert-butyl hydroperoxide in water solution (1.2 g) was added. The flask was sealed and purged with nitrogen for 10 minutes, and immersed in a 80° C. oil bath for overnight, to obtain a grey purple solution. 1M HCl solution was then used to decrease the pH to 3, to obtain a precipitate of the copolymer. The supernatant was removed from the flask. Dioxane (6.19 g) and water (10.63 g) were then added, pH adjusted to 10. A clear diblock solution was obtained, with 7.57% solids

Part 9.2: Investigate the Formation of Polystyrene Hollow Particles Using the macro-RAFT Agent Prepared in Part (9.1)

The diblock solution from part (9.1) (8.06 g, 0.03 mmol) was added in drop wise to a 25 ml round bottom flask containing styrene (3.53 g, 33.86 mmol) and 2,2′-azobisisobutyronitrile (0.04 g, 0.22 mmol) while it was stirred on a magnetic stirrer at a speed setting of 0.6 (IKA model RCT, 1.5 cm spin bar) to produce a viscous white emulsion. To this emulsion, extra water (2.22 g) was added drop wise with constant stirring to yield a white emulsion, with targeted final solids of 30.15%. The flask was sealed and subsequently deoxygenated by nitrogen sparging for 10 minutes. The whole flask was immersed in an oil bath with a temperature setting of 80° C. for 2 hours under constant magnetic stirring. Transmission electron microscopy showed that the final latex did NOT contain polymeric hollow particles.

### Example 10

### Preparation and Evaluation of Low Gloss Paint Coating Compositions

### Part 10.1: Pigment Dispersion

Water (152 g), Calgon T (Albright and Wilson, 3.3 g) and Acrysol™ RM-8W (Rohm and Haas, 19.9 g) were mixed in a 500 mL steel can with a Dispermat™ AE Disperser until dissolved. Retaining low speed mixing, Proxel GXL (Arch Chemicals, 2.5 g), Teric N40L (Huntsman, 29.61 g) and Rhodoline DF60 (Rhodia, 2.9 g) were added. CR-813 (Tronox, 240.22 g) and DP1000 (Imerys Minerals, 29.61 g) were added gradually, then the sides and shaft cleaned with water (13.4 g). The slurry was dispersed at 1800 rpm for 20 minutes. Water (72.4 g) was added and mixed slowly into the dispersion.

### Part 10.2: Low Gloss Paint Composition

New Generation Spindrift™ (Orica Coatings multivesiculated polystyrene bead slurry, 240.0 g), water (121.1 g) and Optima T (Orica Coatings styrene acrylic polymer emulsion MFFT 15° C., 107.9 g) were added to a 1 L can with continuous stirring at about 200 rpm. Rhodoline DF60 (1.37 g) and 25% ammonium hydroxide (2.85 g) were added. 225.98 g of the dispersion from Part 10.1 was added. Texanol (13.69 g) and Rhodoline DF60 (3.42 g) were added slowly under stirring. Ten minutes later, Acrysol TT615 (11.32 g) was added and stirring continued for a further 50 minutes.

Part 10.3: Low Gloss Paint Composition with the Latex from Part 8.22.

Water (34.59 g) and 3.93 g of the latex from Example Part 8.22 were added to 72.76 g of the low gloss paint composition from Part 10.2 and mixed for one hour. The paint composition was allowed to equilibrate overnight. The paint was drawn down on PET film with a 100 micron doctor blade and dried for 24 hours at 25° C., followed by 24 hours at 50° C. Regions of at least 30 mm×30 mm free of visual defects were selected for Kubelka-Munk Scattering coefficient measurements. The Kubelka-Munk Scattering coefficient (S per mm wet paint), based on reflectance measurements at 560 nm and calculated according to ASTM D2805-96a, was 61±4 mm⁻¹. A further region free of visual defects was coloured with a single pass with a brown Mr Sketch™ marker. The film was placed on a white tile, and a seal formed between tile and PET with a drop of water. The reflectance at 560 nm was 29%.

Part 10.4: Low Gloss Paint Composition with the Latex from Example Part 7.4.

Water (33.79 g) and 4.5 g of the latex from Example Part 8.22 were added to 72.76 g of the low gloss paint composition from Part 10.2 and mixed for one hour. The paint composition was allowed to equilibrate overnight. The paint was drawn down on PET film with a 100 micron doctor blade and dried for 24 hours at 25° C., followed by 24 hours at 50° C. A region of at least 30 mm×30 mm free of visual defects was selected and coloured by a single pass with a brown Mr Sketch™ marker. The film was placed on a white tile, and a seal formed between tile and PET with a drop of water. The reflectance at 560 nm was 33%. The Kubelka-Munk Scattering coefficient (S per mm wet paint) at 560 nm was 67 mm⁻¹.

Part 10.5: Low Gloss Paint Composition with the Latex from Part 8.10.

Water (34.21 g) and 4.32 g of the latex from Example Part 8.22 were added to 72.77 g of the low gloss paint composition from Part 10.2 and mixed for one hour. The paint composition was allowed to equilibrate overnight. The paint was drawn down on PET film with a 100 micron doctor blade and dried for 24 hours at 25° C., followed by 24 hours at 50° C. A region of at least 30 mm×30 mm free of visual defects was selected and coloured by a single pass with a brown Mr Sketch™ marker. The film was placed on a white tile, and a seal formed between tile and PET with a drop of water. The reflectance at 560 nm was 34%. The Kubelka-Munk Scattering coefficient (S per mm of wet paint) at 560 nm was 61±4 mm⁻¹.

Part 10.6: Low Gloss Paint Composition with the Latex from Part 8.10.

Water (15.8 g) and 23.33 g of the latex from Example Part 8.22 were added to 72.76 g of the low gloss paint composition from Part 10.2 and mixed for one hour. The paint composition was allowed to equilibrate overnight. The paint was drawn down on PET film with a 100 micron doctor blade and dried for 24 hours at 25° C., followed by 24 hours at 50° C. A region of at least 30 mm×30 mm free of visual defects was selected and coloured by a single pass with a brown Mr Sketch™ marker. The film was placed on a white tile, and a seal formed between tile and PET with a drop of water. The reflectance at 560 nm was 43%. The Kubelka-Munk Scattering coefficient (S per mm of wet paint) at 560 nm was 108±6 mm⁻¹.

### Part 10.7: Low Gloss Paint Composition.

Water (151.36 g), Calgon T (Albright and Wilson, 3.3 g) and Acrysol™ RM-8W (Rohm and Haas, 19.9 g) were mixed in a 500 mL steel can with a Dispermat™ AE Disperser until dissolved. Retaining low speed mixing, Proxel GXL (Arch Chemicals, 2.6 g), Teric N40L (Huntsman, 29.61 g) and Rhodoline DF60 (Rhodia, 2.9 g) were added. CR-813 (Tronox, 240.22 g) and DP1000 (Imerys Minerals, 29.61 g) were added gradually, then the sides and shaft cleaned with water (13.15 g). The slurry was dispersed at 1800 rpm for 20 minutes. Water (72.7 g) was added and mixed slowly into the dispersion.

New Generation Spindrift™ (Orica Coatings, 24.0 g), water (50.2 g) and Optima T (Orica Coatings Polymer emulsion, 10.8 g) were added to a 250 mL can with continuous stirring at about 200 rpm. Rhodoline DF60 (0.14 g) and 25% ammonium hydroxide (0.42 g) were added. 22.6 g of the pigment dispersion was added. Texanol (1.37 g) and Rhodoline DF60 (0.34 g) were added slowly under stirring. Ten minutes later, Acrysol TT615 (2.32 g) was added and stirring continued for a further 50 minutes.

The paint was drawn down on PET film with a 100 micron doctor blade and dried for 24 hours at 25° C., followed by 24 hours at 50° C. A region of at least 30 mm×30 mm free of visual defects was selected and coloured by a single pass with a brown Mr Sketch™ marker. The film was placed on a white tile, and a seal formed between tile and PET with a drop of water. The reflectance at 560 nm was 29%. The Kubelka-Munk Scattering coefficient (S per mm of wet paint) at 560 nm was 48 mm⁻¹.

### Example 11

### Colloid Stabilization and Redox Initiation

Part 11.1: Preparation of a poly{[(butyl acrylate)ₘ-co-(acrylic acid)n]-block-(styrene)t} macro-Raft Agent with Respective Degrees of Polymerization m≈120, n≈60 Using and t≈80.

A solution of dibenzyl trithiocarbonate (1.86 g, 6.4 mmol) and Vazo 67 (0.24 g, 1.25 mmol) and dioxane (186 g) were mixed in a 1 L round bottom flask. Acrylic acid (3.73 g, 372 mmol) and butyl acrylate (94.6 g, 746 mmol) were added in 4 parts over 2 hours while the flask was maintained at 80° C. The flask was then maintained at 80° C. for 1 hour under constant stirring. At the end of the heating, styrene (51.8 g, 497 mmol), Vazo 67 (0.24 g, 1.25 mmol) and dioxane (74 g) was added to the copolymer solution. The flask was sealed, deoxygenated with nitrogen for 10 minutes and then maintained at 80° C. for ten hours under constant stirring. The final copolymer solution had 32.7% solids.

Part 11.2: Synthesis of Polystyrene Hollow Particles Using the macro-RAFT Agent Prepared in Part 11.1 as Stabilizer with Colloid Co-Stabilizer.

A solution of styrene (47.1 g), Vazo 67 (0.32 g) and macro-RAFT solution from Part 11.1 (19 g) was prepared in a 500 mL beaker and mixed for 5 minutes. To this solution, sodium hydroxide solution (0.66 g NaOH in 21.0 g water) was added while the solution was stirred at 1000 rpm. To this emulsion, further 40.7 g water was slowly added into the beaker while the stirring was maintained. An aqueous solution was prepared by mixing 26.3 g of water, 22.7 g of a 1.5% aqueous solution of Natrosol 250HR (Aqualon Company) and 7.0 g of a 7.5% solution of PVA BP24 (Chung Chan Petrochemicals, Taiwan) and added to the emulsion under stirring. The emulsion was stirred at 1000 rpm for 1 hour. It was transferred to a 500 mL round bottom flask which was sealed, deoxygenated for 10 minutes and then immersed in a water bath and the temperature maintained at 80° C. for 3 hours with constant stirring. Divinyl benzene (4.4 g) and 10 g of water were added and the temperature maintained at 80° C. for a further 3 hours. Transmission electron microscopy showed that the final latex contained polymeric hollow particles.

Part 11.3: Synthesis of Polystyrene Hollow Particles Using the macro-RAFT Agent Prepared in Part 11.1 as Stabilizer with Redox Initiation.

A solution of styrene (47.1 g), benzoyl peroxide (2.14 g), dilauryl peroxide (0.98 g) and macro-RAFT solution from Part 11.1 (19 g) was prepared in a 500 mL beaker and mixed for 5 minutes. To this solution, sodium hydroxide solution (0.66 g NaOH in 21.0 g water) was added while the solution was stirred at 1000 rpm. To this emulsion, further 40.7 g water was slowly added into the beaker while the stirring was maintained. An aqueous solution was prepared by mixing 26.3 g of water, 22.7 g of a 1.5% aqueous solution of Natrosol 250HR (Aqualon Company) and 7.0 g of a 7.5% solution of PVA BP24 (Chung Chan Petrochemicals, Taiwan) and added to the emulsion under stirring. The emulsion was stirred at 1000 rpm for 1 hour. It was transferred to a 500 mL round bottom flask which was sealed, deoxygenated for 10 minutes and then immersed in a water bath with the temperature at 40° C. with constant stirring. 25% N,N-dihydroxy ethyl-p-toluidine solution in propylene glycol (1.78 g) was mixed with water (2.48 g) and added to the flask. Following the peak exotherm, the temperature was maintained at 80° C. for 3 hours. Transmission electron microscopy showed that the final latex contained polymeric hollow particles.

Part 11.4: Synthesis of Polystyrene Hollow Particles Using the macro-RAFT Agent Prepared in Part 11.1 as Stabilizer with 25% Butyl Acrylate.

A solution of styrene (35.3 g), butyl acrylate (11.8 g), Vazo 67 (0.32 g) and macro-RAFT solution from Part 11.1 (19 g) was prepared in a 500 mL beaker and mixed for 5 minutes. To this solution, sodium hydroxide solution (0.66 g NaOH in 21.0 g water) was added while the solution was stirred at 1000 rpm. To this emulsion, further 40.7 g water was slowly added into the beaker while the stirring was maintained. An aqueous solution was prepared by mixing 26.3 g of water, 22.7 g of a 1.5% aqueous solution of Natrosol 250HR (Aqualon Company) and 7.0 g of a 7.5% solution of PVA BP24 (Chung Chan Petrochemicals, Taiwan) and added to the emulsion under stirring. The emulsion was stirred at 1000 rpm for 1 hour. It was transferred to a 500 mL round bottom flask which was sealed, deoxygenated for 10 minutes and then immersed in a water bath and the temperature maintained at 80° C. for 3 hours with constant stirring. Divinyl benzene (4.4 g) and 10 g of water were added and the temperature maintained at 80° C. for a further 3 hours.

### Part 12: Film Formation

### Part 12.1

17.8 g of the latex from Part 11.2, 31.27% nv, was mixed with 5.0 g of Primal AC2235 (Rohm and Haas Company) in a glass bottle. The mixture was applied to a Minimum Film Forming Temperature Bar (Sheen Instruments Model SS-3000) on the 33°-60° C. temperature range with a 100 micron doctor blade and allowed to dry for 1 hour. No cracks were visible in the film.

### Part 12.2

21.3 g of filtered latex from Part 11.4, 26.25% nv, was mixed with 5.0 g of Primal AC2235 (Rohm and Haas Company) in a glass bottle. The mixture was applied to a Minimum Film Forming Temperature Bar (Sheen Instruments Model SS-3000) on the 33°-60° C. temperature range with a 100 micron doctor blade and allowed to dry for 1 hour. No cracks were visible in the film.

### Part 12.3

9.43 g of the latex from Part 8.10 was mixed with 2.5 g of Primal AC2235 (Rohm and Haas Company) in a glass bottle. The mixture was applied to a Minimum Film Forming Temperature Bar (Sheen Instruments Model SS-3000) on the 33°-60° C. temperature range with a 100 micron doctor blade and allowed to dry for 1 hour. Cracks were visible throughout the film.

Part 12.4 Poly(styrene-co-butyl acrylate) Hollow Particle Synthesis Using macro-RAFT Agent from Part (8.36)

Macro-RAFT solution from part (8.36) (5.00 g, 0.07 mmol); styrene (10.80 g, 103.7 mmol), Butyl Acrylate (3.60 g, 28.1 mmol); 2,2′-azobisisobutyronitrile (0.09 g, 0.54 mmol) was placed in a 100 mL beaker. To this macro-RAFT solution mixture, sodium hydroxide solution (sodium hydroxide (0.27 g, 6.8 mmol) and 5.03 g of water) was added while the solution was stirred at 1000 rpm using an overhead mixer (Labortechnik, IKA) producing a viscous yellowish white emulsion. The dispersion was left to stir for 30 minutes. To this dispersion under constant stirring, 12.98 g of water was then pipette quickly into beaker while the stirring was maintained at 1000 rpm to produce a less viscous white emulsion. The dispersion was left to stir for 30 min before the final 18.01 g of water was pipette in. After the final water was pipette in, the dispersion was left to stir at 1000 rpm for another 30 minutes. The emulsion was transferred to a 100 mL round bottom flask which was sealed and subsequently purged with nitrogen for 10 min. The whole flask was immersed in an oil bath with a temperature setting of 80° C. and the heating was carried out for 3 hours under constant magnetically stirring. The final latex was white and stable. Transmission electron microscopy showed that the latex contains polymeric hollow particles.

To the above latex, 2 g water was added. The round bottom flask was sealed again and purged with nitrogen for 10 min, and then immersed in an oil bath at 80° C. under constant magnetic stirring. Divinylbenzene (1.44 g, 10 weight % relative to the poly(styrene-co-butyl acrylate)) was added to the flask via a syringe pump over a course of 1 hour. The reaction was maintained overnight. The final latex had 30.8% solids. Transmission electron microscopy showed that the latex contains polymeric hollow particles.

### Part 12.5

17.1 g of Part 12.4, filtered through 90 micron silk) was mixed with 5.0 g of Primal AC2235 (Rohm and Haas Company) in a glass bottle. The mixture was applied to a Minimum Film Forming Temperature Bar (Sheen Instruments Model SS-3000) on a 33°-60° C. temperature range with a 100 micron doctor blade and allowed to dry for 1 hour. Cracks were visible in the film only below 54.5° C.

Part 12.5 was filtered through 90 micron silk and applied to a Minimum Film Forming Temperature Bar (Sheen Instruments Model SS-3000) on a 33°-60° C. temperature range with a 100 micron doctor blade and allowed to dry for 1 hour. Cracks were visible in the film only below 39° C.

### Example 13

### Opacity with Encapsulated Pigment

### Part 13.1

A solution of styrene (47.1 g), Vazo 67 (0.32 g) and macro-RAFT solution from Part 11.1 (19 g) was prepared in a 500 mL beaker and mixed for 5 minutes. To this solution, sodium hydroxide solution (0.66 g NaOH in 21.0 g water) was added while the solution was stirred at 1000 rpm. To this emulsion, further 40.7 g water was slowly added into the beaker while the stirring was maintained. An aqueous solution was prepared by mixing 26.3 g of water, 22.7 g of a 1.5% aqueous solution of Natrosol 250HR (Aqualon Company) and 7.0 g of a 7.5% solution of PVA BP24 (Chung Chan Petrochemicals, Taiwan) and added to the emulsion under stirring. The emulsion was stirred at 1000 rpm for 1 hour. It was transferred to a 500 mL round bottom flask which was sealed, deoxygenated for 10 minutes and then immersed in a water bath and the temperature maintained at 80° C. for 3 hours with constant stirring. Divinyl benzene (4.4 g) and 10 g of water were added and the temperature maintained at 80° C. for a further 3 hours.

### Part 13.2

Dibenzyl trithiocarbonate (296.8 g), PEG200 (Huntsman Corporation) (2500 g), Vazo 67 (9.82 g), acrylic acid (220.9 g) and butyl acrylate (327.4 g) were mixed in a 5 L glass vessel and purged with nitrogen for 20 minutes before heating to 80° C. After the exotherm the vessel was allowed to cool back to 80° C. A mixture of acrylic acid (662.8 g) and butyl acrylate (982.3 g) was fed into the reaction vessel over a 1 hour period. The temperature was maintained at 80° C. for an additional 1.5 hours, then a further 2.0 g of Vazo 67 was added. The temperature was maintained at 80° C. for a further hour.

### Part 13.3

Deionised water (88.45 g), 25% ammonia solution (2.32 g), and the macroRAFT reagent solution from Part 13.2 (14.89 g) was mixed in a steel can until it formed a single transparent phase. The pH was adjusted to 7 with ammonia. Foamaster III from Cognis (1.07 g) was added and mixed into the solution. Tiona 595 (445.7 g) was added slowly and the stirrer speed increased as necessary to maintain a vortex, then turned up to 1800 rpm for 40 minutes. The particle diameter of the dispersion was x and polydispersity y by dynamic light scattering (Malvern NanoSizer). Deionised water, Foamaster III, ammonium hydroxide and the macroRAFT solution from Example P4b were mixed until dissolved and then added to the dispersion with slow mixing.

The dispersion was transferred to a 1 L round bottomed flask and a vortex maintained with a stirrer blade. The vessel was heated to 80° C. then ammonium persulfate, 25% ammonia solution and deionized water were added and the temperature maintained at 80° C. 15 minutes later, butyl acrylate (27.1 g) and methyl methacrylate (52.5 g) were fed into the reaction vessel over 2.5 hours. Subsequently, deionized water (4.45 g) was fed into the reaction vessel through the feed lines and 12.5% ammonia solution (6.7 g), was added. A solution of ammonium persulfate (1.0 g) in deionized water (15.6 g) was fed into the reaction vessel over 45 minutes, followed by a solution of sodium erythorbate (0.48 g) in deionized water (15.6 g) fed over 30 minutes. After the sodium erythorbate feed the vessel temperature was reduced to room temperature. Foamaster III (0.2 g) was added, washed in with 0.13 g of water. 5 minutes later a mixture of Acticide BW20 (Thor Chemicals, 2.0 g) and deionized water (2.0 g) were added and washed in with 0.25 g of water. 5 minutes later Acrysol ASE-60 (10.0 g) and deionized water 13.3 g were added and stirring maintained for a further 20 minutes. The dispersion was filtered through 40 micron silk. The final dispersion had 56.6% solids and 51.9% PVC.

### Part 13.4

66.79 g of the dispersion from Part 13.3 and 15.56 g of the dispersion from Part 13.1 were mixed in a 250 mL can equipped with a small impeller. Propylene glycol (1.88 g), amino methyl propanol (0.23 g), Proxel GXL (0.01 g), Tego Foamex 825 (0.11 g) and Teric N40LP (0.49 g) were added with mixing. Texanol (Eastman, 1.18 g) was added dropwise and mixing continued for 20 minutes before addition of Acrysol RM-8W (3.4 g) and water (10.83 g). Mixing was maintained for a further hour. The following day the sample was drawn down on Melanex with a 50 micron doctor blade and dried at 25° C. for 24 hours, then overnight at 50° C. The Kubelka-Munk scattering coefficient at 560 nm was 119±9 mm⁻¹.

### Part 13.5

66.39 g of the dispersion from Part 13.3 and water (15.72 g) were mixed in a 250 mL can equipped with a small impeller. Propylene glycol (1.91 g), amino methyl propanol (0.23 g), Proxel GXL (0.01 g), Tego Foamex 825 (0.06 g) and Teric N40LP (0.49 g) were added with mixing. Texanol (Eastman, 1.17 g) was added dropwise and mixing continued for 20 minutes before addition of Acrysol RM-8W (3.39 g) and water (10.71 g). Mixing was maintained for a further hour. The following day the sample was drawn down on Melanex with a 50 micron doctor blade and dried at 25° C. for 24 hours, then overnight at 50° C. The Kubelka-Munk scattering coefficient at 560 nm was 81±3 mm⁻¹.

### Example 14

### Nonionic Monomers in the macroRAFT

Part 14.1. Preparation of a poly{(styrene)-block-[(AcrylPEG)-co (butyl acrylate]} macro-RAFT Dibent Agent Containing an Average of 160 Monomer Units Per Chain in a Molar Ratio of 1:1:2 Using Dibenzyl Trithiocarbonate:

Dibenzyl trithiocarbonate (0.10, 0.35 mmol), 2,2′-azobisisobutyronitrile (0.01 g, 0.07 mmol), Acryl-PEG (6.27 g, 13.8 mmol), butyl acrylate (3.54 g, 27.6 mmol) in Dioxane (18.03 g) was prepared in a 100 mL round bottom flask. This was stirred magnetically and sparged with nitrogen for 10 minutes. The flask was then heated at 70° C. for 3 hours under constant stirring. At the end of the heating, styrene (1.44 g, 13.8 mmol) and 2,2′-azobisisobutyronitrile (0.01 g, 0.07 mmol) was added to the polymer solution. The flask was sealed, deoxygenated with nitrogen for 10 minutes and then heated at 70° C. for another 12 hours under constant stirring. The final copolymer solution had 35.0% solids.

Part 14.2. Polystyrene Hollow Particle Synthesis Using macro-RAFT Agent from Part 14.1.

Macro-RAFT solution from part (14.1) (5.00 g, 0.06 mmol); styrene (9.38 g, 90.1 mmol), 2,2′-azobisisobutyronitrile (0.03 g, 0.19 mmol) was placed in a 100 mL beaker. To this macro-RAFT solution mixture, 5.04 g of water was added while the solution was stirred at 1000 rpm using an overhead mixer (Labortechnik, IKA) producing a viscous yellowish white emulsion. The dispersion was left to stir for 30 minutes. To this dispersion under constant stirring, 9.01 g of water was then pipette quickly into beaker while the stirring was maintained at 1000 rpm to produce a less viscous white emulsion. The dispersion was left to stir for 30 min before the final 9.00 g of water was pipette in. After the final water was pipette in, the dispersion was left to stir at 1000 rpm for another 30 minutes. The emulsion was transferred to a 100 mL round bottom flask, which was sealed and subsequently purged with nitrogen for 10 min. The whole flask was immersed in an oil bath with a temperature setting of 80° C. and the heating was carried out for 3 hours under constant magnetic stirring. The final latex was white solid latex. The solid latex was dispersed in acetone overnight with a magnetic stir bar. Transmission electron microscopy showed that the latex dispersed in acetone contains polymeric hollow particles.

### Example 15

### Further Monomer Addition after Divinyl Benzene Polymerisation

Part 15.1: Preparation of a poly{(styrene)-block-[(acrylic acid)-co-(butyl acrylate)]} macro-RAFT Agent Containing an Average of 260 Monomer Units Per Chain in a Molar Ratio of 4:3:6 Using Dibenzyl Trithiocarbonate:

Dibenzyl trithiocarbonate (0.5 g, 1.72 mmol), 2,2′-azobisisobutyronitrile (0.058 g, 0.351 mmol), acrylic acid (7.47 g, 103.60 mmol), butyl acrylate (26.52 g, 206.91 mmol) in dioxane (52.10 g) was prepared in a 250 mL round bottom flask. This was stirred magnetically and sparged with nitrogen for 10 minutes. The flask was then heated at 70° C. for 3 hours under constant stirring. At the end of the heating, styrene (14.35 g, 137.78 mmol), 2,2′-azobisisobutyronitrile (0.085 g, 0.528 mmol) and dioxane (20.04 g) was added to the polymer solution. The flask was sealed, deoxygenated with nitrogen for 15 minutes and then heated at 70° C. for another 12 hours under constant stirring. The final copolymer solution had 34.6% solids.

Part 15.2. Polystyrene Hollow Particle Synthesis Using macro-RAFT Agent from Part 15.1

Macro-RAFT solution from part 15.1 (15.03 g, 0.21 mmol), styrene (38.03 g, 363.93 mmol), and 2,2′-azobisisobutyronitrile (0.30 g, 1.82 mmol) was placed in a 400 mL beaker. To this macro-RAFT solution, 0.52 g (12.85 mmol) of NaOH dissolved in 15.06 g of water was added while the solution was stirred at 1000 rpm using an overhead mixer (Labortechnik, IKA) producing a viscous yellow emulsion. After 30 minutes of stirring, 35.17 g of water was added using a pippette while the solution was being stirred at 1000 rpm. After a further 5 minutes of stirring, 45.04 g of water was poured into the while the stirring was maintained at 1000 rpm to produce a thick bright white emulsion. The emulsion was transferred to a 250 mL round bottom flask which was sealed and subsequently purged with nitrogen for 15 min. The whole flask was immersed in an oil bath with a temperature setting of 80° C. and the heating was carried out for 3 hours under constant magnetically stirring.

To 91.85 g of the latex obtained above, under constant magnetically stirring, at 80° C., 1.46 g of divinyl benzene (5 weight % to polystyrene) was fed in over the course of 1 hour. The reaction was then left overnight, with temperature maintained at 80° C. The final latex had 30.4% solids.

### Part 15.3. Addition of MMA/BA Monomers to Hollow Particles Produced in Part 15.2

60.07 g latex from part 15.2, methyl methacrylate (0.77 g, 7.73 mmol), butyl acrylate (0.77 g, 6.04 mmol) and 2,2′-azobisisobutyronitrile (0.015 g, 0.09 mmol) were placed in a 100 ml round bottom flask which was sealed and magnetically stirred overnight at room temperature.

The next day, the flask was purged with nitrogen for 15 min. The whole flask was immersed in an oil bath with a temperature setting of 70° C. and the heating was carried out for 5 hours under constant magnetically stirring. The final latex had 31.8% solids. TEM showed that the final latex contained hollow particles

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method of preparing an aqueous dispersion of vesiculated polymer particles, the method comprising:
preparing a dispersion of polymerisable particles within a continuous aqueous phase, the polymerisable particles having a structure that is defined by an outer organic phase that comprises one or more ethylenically unsaturated monomers and surrounds an inner aqueous phase, said inner aqueous phase defining a single void within the polymerisable particle, wherein a RAFT agent functions as a stabiliser for the outer organic phase within the continuous aqueous phase, and wherein a RAFT agent functions as a stabiliser for the inner aqueous phase within the outer organic phase; and
polymerising the one or more ethylenically unsaturated monomers under the control of a RAFT agent functioning as said stabiliser to form the aqueous dispersion of vesiculated polymer particles.

2. The method according to claim 1, wherein the dispersion of polymerisable particles is prepared by (a) dispersing a selected RAFT agent in an aqueous medium such that it assembles to form an aqueous dispersion of vesicles, and (b) introducing an organic medium comprising the one or more ethylenically unsaturated monomers to the aqueous medium such that it combines with the vesicles to form the dispersion of polymerisable particles.

3. The method according to claim 2, wherein the RAFT agent is of general formula (4): 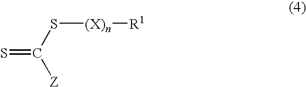
where each X is a polymerised residue of a hydrophilic or hydrophobic ethylenically unsaturated monomer such that —(X)ₙ— represents a block copolymer where the portion of block copolymer closest to the R¹ group is the polymerised residue of hydrophilic monomer and the portion of block copolymer closest to the thiocarbonylthio group is the polymerised residue of hydrophobic monomer; the R¹ and Z groups provide hydrophilic and hydrophobic properties, respectively, and are independently selected such that the agent can function as a RAFT agent in the polymerisation of the one or more ethylenically unsaturated monomers; and n ranges from 6 to 100.

4. The method according to claim 2, wherein the RAFT agent is of general formula (5): 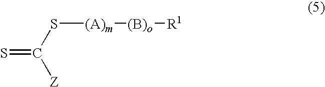
wherein each A and B is independently a polymerised residue of an ethylenically unsaturated monomer such that -(A)ₘ- provides hydrophobic properties, -(B)ₒ— provides hydrophilic properties and overall -(A)ₘ-(B)ₒ— represents a block copolymer; m and o each independently range from 3 to 50; and R¹ and Z provide hydrophilic and hydrophobic properties, respectively, and are each independently selected such that the agent can function as a RAFT agent in the polymerisation of the one or more ethylenically unsaturated monomers.

5. The method according to claim 4, wherein the magnitude of integers m and o are about the same.

6. The method according to claim 1, wherein the dispersion of polymerisable particles is prepared by (a) forming a dispersion comprising a continuous aqueous phase, a selected RAFT agent and a dispersed organic phase comprising the one or more ethylenically unsaturated monomers, and (b) polymerising at least a portion of the one or more ethylenically unsaturated monomers under the control of the RAFT agent such that the resulting polymerised RAFT agent assembles to form the dispersion of polymerisable particles.

7. The method according to claim 6, wherein the dispersion comprising the continuous aqueous phase, the selected RAFT agent and the dispersed organic phase is prepared by combining the RAFT agent with an aqueous medium and then combining this composition with an organic medium comprising the one or more ethylenically unsaturated monomers.

8. The method according to claim 6, wherein the dispersion comprising the continuous aqueous phase, the selected RAFT agent and the dispersed organic phase is prepared by combining the RAFT agent with an organic medium comprising the one or more ethylenically unsaturated monomers, and then combining this composition with an aqueous medium.

9. The method according to claim 6, wherein the weight percentage of the dispersed organic phase in the continuous aqueous phase ranges from about 15 to about 45 wt. %.

10. The method according to claim 6, wherein the mole ratio of the selected RAFT agent to the one or more ethylenically unsaturated monomers present ranges from about 1:50 to about 1:4000.

11. The method according to claim 6, wherein the RAFT agent is of general formula (4): 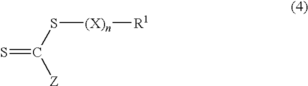
where each X is a polymerised residue of a hydrophilic or hydrophobic ethylenically unsaturated monomer such that —(X)ₙ— represents a random, alternating or tapered copolymer comprising the polymerised residue of hydrophilic and hydrophobic monomer; R¹ and Z provide either hydrophobic or hydrophilic properties and are independently selected such that the agent can function as a RAFT agent in the polymerisation of the one or more ethylenically unsaturated monomers; and n ranges from 10 to 2000.

12. The method according to claim 6, wherein the RAFT agent is of general formula (5a): 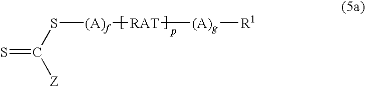
where each A is independently a polymerised residue of an ethylenically unsaturated monomer such that A provides hydrophobic properties; f and g independently range from 0 to 100; RAT is the polymerised residue of a mixture of hydrophilic and hydrophobic ethylenically unsaturated monomers and represents a random, alternating or tapered copolymer comprising the polymerised residue of hydrophilic and hydrophobic monomer; R¹ and Z provide either hydrophobic or hydrophilic properties and are selected such that the agent can function as a RAFT agent in the polymerisation of the one or more ethylenically unsaturated monomers; p ranges from 10 to 2000 and represents the number of monomer repeat units that make up the RAT copolymer; with the proviso that the sum of f, p and g is no greater than about 2000.

13. A vesiculated polymer particle that is 100 microns or less in size, the particle being defined by a substantially uniform and continuous polymer layer around a single aqueous or air filled void, wherein the polymer layer has at least in part been formed under the control of a RAFT agent.

14. A method of preparing a paint, filler, adhesive, liquid ink, primer, sealant, diagnostic product or therapeutic product comprising preparing an aqueous dispersion of vesiculated polymer particles according to claim 1, and combing the dispersion with one or more formulation components.

15. A paint, filler, adhesive, primer, sealant, diagnostic product or therapeutic product comprising an aqueous dispersion of vesiculated polymer particles prepared according to claim 1.
